(19) United States
(12) Patent Application Publication
(10) Pub. No.: US 2025/0391227 A1
(43) Pub. Date: Dec. 25, 2025

(54) SELECTIVE DICE TYPE TILE ACCUMULATION SEQUENCES AND RELATED SELECTIVE ACCUMULATED DICE TYPE TILE USE SEQUENCES

(71) Applicant: IGT, Las Vegas, NV (US)

(72) Inventors: Sean O'Donnell, Reno, NV (US); Janner Redera, Sparks, NV (US); Aaron P. Taylor, Reno, NV (US); Dwayne R. Nelson, Las Vegas, NV (US)

(21) Appl. No.: 18/748,985

(22) Filed: Jun. 20, 2024

(51) Int. Cl. G07F 17/32

(52) U.S. Cl. CPC G07F 17/3211; G07F 17/323; G07F 17/3267

(57) ABSTRACT

Gaming systems and methods that provide tile accumulation sequences and related accumulated dice type tile use sequences, wherein the accumulation sequence includes an accumulation of dice type tiles during one or more plays of one or more games during, and wherein the use sequences include the use of the accumulated dice type tiles to complete runs of a hand and the hand.

### CROSS-REFERENCE TO RELATED APPLICATIONS

This application is related to the following commonly owned co-pending patent applications: U.S. application Ser. No. ______, entitled “SELECTIVE TILE ACCUMULATION SEQUENCES AND RELATED SELECTIVE ACCUMULATED TILE USE SEQUENCES,” Attorney Docket No. 027438-3169/P002947-001; U.S. application Ser. No. ______, entitled “SELECTIVE TILE ACCUMULATION SEQUENCES AND RELATED SELECTIVE ACCUMULATED TILE USE SEQUENCES WITH BYPASS FEATURES,” Attorney Docket No. 027438-3246/P003039-001; U.S. application Ser. No. ______, entitled: “HAND AND/OR RUN SELECTION SEQUENCES FOR SELECTIVE TILE ACCUMULATION SEQUENCES AND RELATED SELECTIVE ACCUMULATED TILE USE SEQUENCES,” Attorney Docket No. 027438-3247/P003040-001; U.S. application Ser. No. ______, entitled: “DISPLAY SCREEN OR PORTION THEREOF WITH A GRAPHICAL USER INTERFACE,” Attorney Docket No. 027438-3244/P002947-002; and U.S. application Ser. No. ______, entitled: “DISPLAY SCREEN OR PORTION THEREOF WITH A GRAPHICAL USER INTERFACE,” Attorney Docket No. 027438-3245/P002947-003.

### BACKGROUND

The present disclosure relates to selective dice type tile accumulation sequences and related selective accumulated dice type tile use sequences for gaming environments.

Gaming machines may require a player to place a wager to activate a play of the primary game. Gaming machines may provide one or more awards in a play of a primary game. Gaming machines may determine such awards based on a winning symbol or a winning symbol combination. Gaming machines may provide higher awards for winning symbols or winning symbol combinations that are less likely to occur in a play of a primary game. Gaming machines may provide a play of a secondary game responsive to an occurrence of a triggering event in a play of a primary game. Gaming machines may provide one or more additional awards in a play of a secondary game. Gaming machines my provide primary games or secondary games with the accumulation of symbols and the use of accumulated symbols.

### BRIEF SUMMARY

In various embodiments, the present disclosure relates to gaming system including a processor and a memory device that stores a plurality of instructions that, when executed by the processor, cause the processor to: cause a display, by a display device, of an indication of a hand; cause a display, by the display device, of indications of different runs of the hand, and for each run, a tile application area associated with that run and an indication of dice tiles required to complete the run; cause a display, by the display device, of a tile accumulation area; cause a display, by the display device, of symbol display elements; cause a display, by the display device, of activations of the symbol display elements; cause a display, by the display device, of dice tiles associated with the activations of the symbol display elements, each dice tile have an indicated number of that dice tile; and cause a display, by the display device, for each of the displayed dice tiles, of an indication of whether the dice tile is accumulated in the tile accumulation area or the dice tile is discarded. The plurality of instructions, when executed by the processor further cause the processor to: cause a display, by the display device, of one the displayed dice tiles accumulated in the tile accumulation area, a change of the indicated number of that dice tile; cause a display, by the display device, for the displayed dice tiles in the tile accumulation area, of placements of the dice tiles into the tile application areas associated with the runs; cause a display, by the display device, for each of the runs, an indication of a completion of the run based on the dice tiles placed in the tile application area associated with the run and that are required to complete the run; and cause a display, by the display device, of an indication of a completion of the hand after all of the indications of the completions of all of the runs.

In various other embodiments, the present disclosure relates to gaming system including a processor and a memory device that stores a plurality of instructions that, when executed by the processor, cause the processor to: cause a display, by a display device, of an indication of a hand comprising different runs, and for each run an indication of any dice tiles required to complete the run; cause a display, by the display device, of symbol display elements; cause a display, by the display device, of activations of the symbol display elements; cause a sequential display, by the display device, of dice tiles associated with the activations of the symbol display elements, each dice tile have an indicated number of that dice tile; and cause a display, by the display device, for each of the displayed dice tiles, of an indication of whether the tile is accumulated or the tile is discarded. The plurality of instructions, when executed by the processor further cause the processor to: cause a display, by the display device, for the accumulated dice tiles, of placements of the tiles in association with the runs, where for one of the runs, the accumulated dice tiles can only be placed in association with that run if the order of accumulation of the dice tiles is the same as the order of the dice tiles for that run; cause a display, by the display device, for each of the runs, an indication of a completion of the run based on the dice tiles associated with the run and that are required to complete the run; and cause a display, by the display device, of an indication of a completion of the hand after all of the indications of the completions of all of the runs.

In various other embodiments, the present disclosure relates to gaming system including a processor and a memory device that stores a plurality of instructions that, when executed by the processor, cause the processor to: cause a display, by a display device, of an indication of a hand comprising different runs, and for each run an indication of any dice tiles required to complete the run, wherein for one of the runs, the run can be completed by different quantities of dice tiles; cause a display, by the display device, of symbol display elements; cause a sequential display, by the display device, of each of a plurality of different dice tiles, each dice tile have an indicated number of that dice tile; and cause a display, by the display device, for each of the displayed dice tiles, of an indication of whether the dice tile is accumulated or the dice tile is discarded, wherein a limited quantity of the dice tiles can be accumulated at any one time. The plurality of instructions, when executed by the processor further cause the processor to: cause a display, by the display device, for the accumulated dice tiles, of placements of the dice tiles in association with the runs, wherein for each placement of a dice tile in association with one of the runs, the quantity of accumulated dice tiles is reduced; cause a display, by the display device, for each of the runs, an indication of a completion of the run based on the dice tiles associated with the run and that are required to complete the run; and cause a display, by the display device, of an indication of a completion of the hand after all of the indications of the completions of all of the runs.

Additional features and advantages are described in, and will be apparent from, the following Detailed Description and the figures.

### BRIEF DESCRIPTION OF THE SEVERAL VIEWS OF THE DRAWINGS

FIG. 1 is a flow chart of an example process for operating a gaming system that provides selective tile accumulation sequences and related selective accumulated tile use sequences in accordance with one example embodiment of the present disclosure.

FIG. 1A is a table showing example mahjong tiles employed by a gaming system in accordance with example embodiments of the present disclosure.

FIG. 1B is a table showing quantities of example mahjong tiles employed by a gaming system in accordance with example embodiments of the present disclosure.

FIGS. 2A, 2B, 2C, 2D, 2E, 2F, 2G, 2H, 2I, 2J, and 2K are example screen shots displayed by a gaming system and illustrating parts of a plurality of plays of a primary wagering game providing selective tile accumulation sequences and related selective accumulated tile use sequences in accordance with example embodiments of the present disclosure.

FIGS. 3A, 3B, 3C, 3D, and 3E are example screen shots displayed by a gaming system and illustrating parts of a plurality of plays of a primary wagering game providing selective tile accumulation sequences and related selective accumulated tile use sequences with a bypass feature in accordance with example embodiments of the present disclosure.

FIGS. 4A, 4B, 4C, 4D, 4E, 4F, 4G, and 4H are example screen shots displayed by a gaming system and illustrating parts of example hand and/or run selection sequences in accordance with example embodiments of the present disclosure.

FIGS. 5A and 5B are example screen shots displayed by a gaming system and illustrating parts of a plurality of plays of a primary wagering game providing selective dice type tile accumulation sequences and related selective accumulated dice type tile use sequences in accordance with example embodiments of the present disclosure.

FIG. 6 is a schematic block diagram of one example embodiment of an electronic configuration of a gaming system of the present disclosure.

FIGS. 7A and 7B are perspective views of example alternative embodiments of the gaming system of the present disclosure.

FIG. 7C is a front view of an example personal gaming device of the gaming system of the present disclosure.

### DETAILED DESCRIPTION

In various embodiments, the present disclosure relates to gaming systems and methods that provide selective tile accumulation sequences and related selective accumulated tile use sequences.

In various embodiments, the present disclosure relates to gaming systems and methods that provide selective tile accumulation sequences and related selective accumulated tile use sequences with bypass features.

In various embodiments, the present disclosure relates to gaming systems and methods that provide hand and/or run selection sequences for selective tile accumulation sequences and related selective accumulated tile use sequences.

In various embodiments, the present disclosure relates to gaming systems and methods that provide selective mahjong type tile accumulation sequences and related selective accumulated mahjong type tile use sequences.

In various embodiments, the present disclosure relates to gaming systems and methods that provide selective dice type tile accumulation sequences and related selective accumulated dice type tile use sequences.

In various embodiments, the present disclosure relates to gaming systems and methods that provide selective playing card type tile accumulation sequences and related selective accumulated playing card type tile use sequences.

In various embodiments, the present disclosure relates to gaming systems and methods that provide selective domino type tile accumulation sequences and related selective accumulated domino type tile use sequences.

In various embodiments, the gaming system employs a plurality of other type tile accumulation sequences and related selective accumulated tile use sequences.

In various embodiments, the gaming system employs a plurality of different tiles, and for each such different tile, can employ one or more instances of that tile.

In various embodiments, each tile includes only one of a plurality of different symbols.

In various embodiments, one or more of the tiles includes only one of a plurality of different symbols, and one or more of the tiles includes multiple symbols of a plurality of different symbols.

In various embodiments, each of the tiles includes multiple symbols of a plurality of different symbols. In various embodiments, the plurality of different symbols are all of the same types of symbols. In various embodiments, the plurality of different symbols are of two or more different types of symbols. Thus, in various embodiments, one or more of the tiles (e.g., a single tile) can include one or a plurality of one or more different symbols and or different types of symbols.

In various embodiments, the present disclosure relates to gaming systems and methods that provide selective tile accumulation sequences and related selective accumulated tile use sequences that are based on or that result from plays of a primary game (such as primary wagering game) and that includes symbol display elements (such as but not limited to reels, cards, etc.).

In various embodiments, the present disclosure relates to gaming systems and methods that provide selective tile accumulation sequences and related selective accumulated tile use sequences that are based on or that result from plays of a second game (such as secondary game triggered from a primary wagering game) and that includes symbol display elements (such as but not limited to reels, cards, etc.).

For various example embodiments described herein, the present disclosure employs mahjong tiles as the accumulated and used tiles to explain the present disclosure. For various other embodiments described herein, the present disclosure employs dice type tiles as the accumulated and used tiles to explain the present disclosure. In various other embodiments, the present disclosure employs playing card type tiles as the accumulated and used tiles to explain the present disclosure. The present disclosure contemplates that any suitable set(s) or type(s) of tiles can be employed, and thus the use of mahjong tiles, dice type tiles, and playing card type tiles as example tiles herein are not meant to limit the present disclosure.

In various embodiments, the selective tile accumulation sequences generally include selective accumulation of a quantity of (such as one or more) tiles during or otherwise associated with each of a quantity of (such as one or more) plays of a quantity of (such as one or more) games (such as one or more plays of a primary wagering game) that includes symbol display elements. In various such embodiments, for each said play of the game, the gaming system determines whether any tiles are generated and available for accumulation, and if any tiles are available for accumulation, the gaming system determines and displays such tiles. In various such embodiments, the tiles generated are based on the symbol display elements. In various such embodiments, the tiles generated are not based on the symbol display elements, and are thus separate and independent from the symbol display elements. In various embodiments, when the gaming system determines that one or more tiles are available for accumulation, the gaming system enables the player to select zero, one, or more of such available tiles to be accumulated in the tile accumulation sequence. In various other embodiments, when the gaming system determines that one or more tiles are available for accumulation, the gaming system selects which available tiles are accumulated in the tile accumulation sequences. The selective tile accumulation sequences are sometimes referred to herein as an accumulation sequence or as a first sequence for brevity. In various embodiments, after a tile is selected for accumulation, the gaming system displays such tile in one or more tile accumulation areas until that tile is used, removed, or discarded such as described herein. Thus, the tile accumulation areas function to temporarily to hold and display the tiles available for the player to use. In various embodiments, the tile accumulation areas can be considered racks that hold tiles for subsequent use or for being discarded.

In various embodiments, the gaming system does not require any additional wager to accumulate tiles. In various embodiments, the gaming system requires an additional wager such as a side wager to accumulate tiles. In various embodiments, the gaming system requires a specific wager level or higher (such as a maximum wager amount) to accumulate tiles.

In various embodiments, the gaming system displays: (1) an indication of one or more tile accumulation areas in which selected accumulated tiles are displayed; and (2) an indication of a maximum quantity of tiles that can be accumulated in each such tile accumulation area at any given point. For brevity, one tile accumulation area is employed to explain the present disclosure; however, such use of one tile accumulation area is not meant to limit the present disclosure.

In various embodiments, the selective tile use sequences generally include the selective use of one or a plurality of the accumulated tiles in the tile accumulation area(s) for application to one or more runs of one or more hands. In various embodiments, the gaming system enables the player to select which accumulated tile(s) from the tile accumulation area(s) is/are used in the tile use sequences with respect to one or more of the runs of one or more of the hands. In various other embodiments, the gaming system selects which accumulated tile(s) in the tile accumulation area(s) is/are used in the tile use sequences with respect to one or more of the runs of one or more of the hands. The selective accumulated tile use sequences are sometimes referred to herein as a use sequence or as a second sequence for brevity.

In various embodiments, the gaming system displays: (1) an indication of each of one or more runs of each of the one or more hands and respective associated tile application area for each of the runs and each of the hand(s) in which accumulated tiles can be applied for each of the respective runs; (2) for each such run of each such hand, an indication of the one or more tiles that need to be applied to (e.g., such as placed in) the tile application area for that run to properly complete that the run of that hand; (3) for each run of each hand, an indication of an award associated with the proper completion of that run of that hand; and (4) for each hand, an indication of an award associated with the completion of that hand. For brevity, the present disclosure is primarily described with respect to one hand including a plurality of different runs. However, such descriptions are not meant to limit the present disclosure, and any of the sequences described herein can be related to one or more hands, each having one or more runs in accordance with the present disclosure.

In various embodiments, the selective tile use sequences include the selective use by a player of one or more of the one or more accumulated tiles in the tile accumulation area to apply to or to complete one or more or each displayed run of the displayed hand. In various embodiments, for each properly completed run of the hand, the gaming system provides the player the award associated with that run. In various other embodiments, for each properly completed run of the hand, the gaming system unlocks the award associated with that run such that the player can subsequently win that award (such as in a subsequent play of the primary game or a play of a secondary game). In various embodiments, when all of the runs of a hand are properly completed, the gaming system provides the player an award associated with that hand. In various other embodiments, when all of the runs of a hand are properly completed, the gaming system unlocks the award associated with that hand such that the player can subsequently win that award (such as in a subsequent play of the primary game or a play of a secondary game). Thus, in various embodiments, the player tries to complete the runs of the hand to obtain the awards or opportunities to win awards associated with the runs of the hand and to obtain the award associated with the hand or the opportunity to win the award associated with the hand. For brevity, the present disclosure is primarily described herein as directly providing the awards associated with the runs and the hand to the player when the runs of a hand and the hand are properly completed; however, such examples are not meant to limit the present disclosure.

In various embodiments, after a hand is completed and the gaming system provides the player an award associated with that hand, the gaming system clears that hand, determines, and displays a new hand with its respective runs. In various such embodiments, the gaming system also clears any remaining accumulated tiles in the accumulated tile area. In other embodiments, the gaming system can leave one or more accumulated tiles in the tile accumulation area for use with the new hand and its respective runs.

In various embodiments, the gaming system provides only one tile accumulation area. In various other embodiments, the gaming system provides multiple tile accumulations areas. In various embodiments, the quantity of tile accumulation areas is based on player wager amount level, but can be based on other determinations. As indicated above, for brevity, only one tile accumulation area is described in the example provided herein; but such examples are not meant to limit the present disclosure.

In various embodiments, the gaming system selects the hand and the runs of that hand for the sequences from a plurality of different hands and a plurality of different runs. In various embodiments, the selected hand is associated with an award and thus the selected hand determines the available award for that hand in the use sequences. In other words, the selection of the hand determines the award available to be provided to the player for that hand via the use sequences. In various embodiments, the runs associated with each of the hands available for selection are predetermined. Thus, selecting the hand also determines the available run related awards for the use sequences.

In various embodiments, the gaming system enables the player to select one or more of the available hands from a plurality of different hands. In various embodiments, each different selectable hand is associated with an award and thus the selected hand determines the available hand related award in the use sequences. In various embodiments, each different run of the selected hand is associated with an award and thus the player selected hand determines the available run related awards in the use sequences. In other words, the player selection of the hand determines the awards available to be provided to the player via the use sequences. In various embodiments, runs associated with each of the hands available for selection by the player are predetermined. Thus, by selecting the hand, the player selects the runs for the sequences.

In various embodiments, the gaming system enables the player to select one or more of the available runs for a hand from a plurality of different available runs for that hand. In various embodiments, each different selectable run is associated with an award and thus the selected runs determine the available run related awards in the use sequences. In other words, the player selection of each run for a hand determines the awards available to be provided to the player via the use sequences. In various embodiments, runs associated with each of the hands available for selection by the player are predetermined. Thus, by selecting the runs for a hand, the player selects the runs and the hand for the sequences.

In various embodiments, the gaming system enables the player to select one or more of the awards for the runs and/or the hand. In various embodiments, based on the player selected awards, the gaming system selects the runs of the hand. Thus, by selecting the awards for the runs for a hand, the player enables selection of the runs and the hand for the sequences.

In various embodiments, during the tile accumulation sequences, the gaming system enables the player to accumulate tiles in the tile accumulation area that the player can later use to apply to and to complete each of the displayed runs of the displayed hand and thus that hand.

In various embodiments, during the tile use sequences, the gaming system enables the player to apply each of one or more of the accumulated tiles in the tile accumulation area to respective ones of the displayed runs of the displayed hand and thus the hand.

In various embodiments, during the tile use sequences, the gaming system requires the player to apply all of the needed tiles to complete a displayed run of the displayed hand. In other words, in such embodiments, the gaming system does not enable the player to partially complete a run with less than all of the tiles needed for that run.

In various embodiments, during the tile use sequences, the gaming system enables the player to apply one or more (but not all) of the total quantity of the needed tiles to complete a displayed run of the displayed hand. In other words, in such embodiments, the gaming system enables the player to partially complete a run with less than all of the tiles needed for that run. In these embodiments, the gaming system enables the player to reduce the quantity of tiles in the tile accumulation area (by using and applying such tiles), and thus enables the player to accumulate additional tiles in the tile accumulation area without discarding tiles from the tile accumulation area. While this is positive for the player, the negative for the player is when the player applies one or more tiles from the tile accumulation area to a run that only partially completes that run, the player does not know whether or when the player will subsequently obtain the one or more additional tiles that are needed to complete that partially completed run.

In various embodiments, during the tile use sequences, the gaming system requires the player to complete all of the displayed runs of the displayed hand to complete the hand.

In various embodiments, during the tile use sequences, the gaming system enables the player to bypass completion of one or more of the displayed runs of the displayed hand to complete the hand. In such cases, for each run that is bypassed, the gaming system does not provide the player the award associated with that bypassed run (or does not unlock that award). In such cases, if the player bypasses one or more of runs, the gaming system can also vary the award associated with the hand (such as by reducing the award associated with the hand).

In various embodiments, the runs of a hand each require a same quantity of tiles to complete those runs. For example, each run of a hand can require three tiles.

In various embodiments, two or more of the runs of a hand each require different quantities of tiles to complete those runs. For example, two runs of a hand can require three tiles and two runs of a hand can require four tiles.

In various embodiments, the respective awards associated with runs are at least partly based on the quantities of tiles needed to complete that run.

In various embodiments, the quantity of tiles needed to complete each run of the hand increases. For example, the first run can require 1 tile, the next run can require two 2 tiles, the next run can require 3 tiles, and the last run can require 4 tiles. This makes the runs of the hand increasingly more difficult to complete.

In various embodiments, the gaming system enables the player to compete the runs of a hand in any order.

In various embodiments, the gaming system requires the player to compete the runs of a hand in a specific order (such as bottom run to top run, such as top run to bottom run, such as the run with the least quantity of tiles to the run with the most quantities of tiles).

In various embodiments, the awards associated with the runs and the hand can be based on one or more of the following: (1) the overall game paytable and configuration; (2) the wager amounts or level; (3) the denominations; (4) one or more random determinations; and/or (5) player loyalty tracking account status.

In various embodiments, the hand displayed by a gaming system persist with the gaming system (and not with the player) such that if a player leaves the gaming system after: (1) collecting but not using one or more accumulated tiles in the tile accumulation area; (2) applying one or more accumulated tiles to a run; and/or (3) completing one or more runs, another player can play that gaming system and use such accumulated times, applied tiles, and completed runs. In other words, the hand does not persist with the player. However, when a run is completed by the first player, the gaming system provides the award associated with that completed run to the first player, and thus does not provide the award to the next player.

In various embodiments, each hand is associated with a specific player and persist with the player such as via a player loyalty tracking account for that player such that when the player leaves a first gaming system and returns to a second gaming system (which can be the first gaming system or another gaming system), the second gaming system displays the same hand and player can further progress in completing the runs of that hand. In other words, the hand persists with the player.

In various embodiments, one or more of the runs can have more than one award associated with that run. In various such embodiments, one of the awards is provided to the player when the player completes the run and one of the awards is unlocked for the primary wagering game when the player completes that run.

In various embodiments, the gaming system provides the player an unlimited period (of play and/or of time) to complete all of the runs of a hand and thus the hand.

In various embodiments, the gaming system provides the player a limited period (of play and/or of time) to complete all of the runs of a hand and thus the hand. Thus, in various embodiments, the player has a limited period to accumulate tiles to complete the runs of a hand to complete the hand. In various embodiments, the gaming system suitably displays one or more indications of the period for the hand and when the period will end.

In various embodiments, if the period for completing the hand is approaching, the player can bypass one or more runs of the hand before the period expires so that the player can achieve the award associated with the hand even though the player is bypassing one or more awards associated with the runs of the hand.

In various embodiments, for one or more accumulated tiles in the tile accumulation area, the accumulated tile can be used for a hand during an unlimited period (of play and/or of time).

In various embodiments, for one or more accumulated tiles in the tile accumulation area, the accumulated tile can be used for a hand during a limited period (of play and/or of time). In various embodiments, the gaming system suitably displays one or more indications of the period for the tile and when the period will end.

In various embodiments, the gaming system can end the accumulation of tiles for a hand and the completion of runs for a hand based on an occurrence of a hand termination condition. In various embodiments, the hand termination condition can be any suitable condition such a but not limited to: (1) a random determination; (2) an event in a game or other suitable event; (2) a predetermined quantity of game plays; (4) a predetermined time period; (5) a change (such as a lowering) of wager amount level or denomination; (6) when one of the runs is completed; and/or (7) when the player cashes out of the gaming system or runs out of credits.

In various embodiments, as indicated above, the gaming system can remove one or more accumulated tiles in the tile accumulation area based on an occurrence of a tile removal condition. In various embodiments, the tile removal condition can be any suitable condition such a but not limited to: (1) a randomly determination; (2) an event in a game or other suitable event; (2) a predetermined quantity of game play; (4) a predetermined time period; (5) a change (such as a lowering) of wager amount level or denomination; and/or (6) automatically if a certain tile is generated or accumulated such as a bad tile.

In various embodiments, the gaming system can use automatic rules to accumulate tiles in the tile accumulation area and/or apply the accumulated tiles in the tile accumulated area to minimize the player required actions during the plays of the game. This embodiment simplifies and can speed up the game play. Various examples of such are further explained below.

While the above describes the general embodiment of the present disclosure, various different alternative embodiments are also further explained below.

In various embodiments of the present disclosure, for each play of a game (such as primary wagering game), the gaming system: (1) randomly determines a plurality of symbols using the symbol display elements; (2) displays the randomly determined symbols at a plurality of symbols display positions; (3) displays any determined outcomes based on the displayed symbols; (4) determines any awards based on those displayed symbols and outcomes; (5) displays any determined awards; and (6) determines whether one or more tile generation events occurred in connection with the play of the game.

In various embodiments, one or more of the tile generation events can occur based on one or more of the displayed symbols, one or more of the displayed outcomes, and/or one or more of the displayed awards.

In various such embodiments, a plurality of the symbols of the game are associated with one or more of the tiles, and when such symbols are displayed in a play of the game, the gaming system provides such tiles for the player to keep or discard such as discussed herein.

In various such embodiments, a plurality of the symbol combinations (such as winning symbol combinations or losing symbol combinations) of the game are associated with one or more of the tiles, and when each such combinations is displayed in a play of the game, the gaming system provides such tiles for the player to keep or discard such as discussed herein. For example, a winning symbol combination can result in the player getting to keep or discard one or more of the tiles (such as the 1 dot, 2 dot, or 3 dot tiles). In another example, a certain payline win can result in the player getting to keep or discard one or more of the tiles. In another example, a certain type of symbol combination (such as a pair in a card game) can result in the player getting to keep or discard one or more of the tiles.

In various embodiments, a certain win amount level of a minimum win amount (such as a 100 credit win or a $5.00 win) can result in the player getting to keep or discard one or more of the tiles.

In various such embodiments, a plurality of the symbols of the game are the tiles, and when such symbols are displayed in a play of the game, the gaming system provides such tiles for the player to keep or discard such as discussed herein.

In various embodiments, one or more of the tile generation events can additionally or alternatively occur be based on one or more determinations independent of the displayed symbols, the displayed outcomes, and/or the displayed awards. In various such embodiments, the one or more of the tile generation events can occur based on one or more separate random determinations. In other words, in various embodiments, one or more of the tile generation events can occur based on one or more random events associated with the play of the game or separate from the play of the game.

In various embodiments, one or more of the tile generation events can occur for each play of the game if at least a predetermined wager amount is made for that play of the game-such that for each such play of the game that includes at least that predetermined wager amount, the gaming system provides one or more tile generation events.

In various embodiments, one or more of the tile generation events can additionally or alternatively occur be based on one or more predetermined events. In various such embodiments, one or more of the tile generation events can occur for each play of the game-such that for each play of the game, the gaming system provides one or more tile generation events.

In various embodiments, the gaming system determines: (1) when each tile generation event occurs; (2) how many tile(s) is/are generated for such tile generation event; and/or (3) which tile(s) is/are generated and displayed for such tile generation event, based on one or more determinations. These determinations can be based on one or more random determinations or can be otherwise determined (such as based on a predetermined order or arrangement of tiles).

In various embodiments, the gaming system determines: (1) when each tile generation event occurs; (2) how many tile(s) is/are generated for such tile generation event; and/or (3) which tile(s) is/are generated and displayed for such tile generation event, in another suitable manner.

Thus, in various embodiments, responsive to each tile generation event, the gaming system determines: (1) determines one or more tiles to display for a tile accumulation sequence; (2) for each determined tile, enables the player to make an input to keep or discard the displayed tile; (3) for each determined tile, discards the displayed tile if the player makes an input to discard the tile; and (4) for each determined tile, accumulates the tile in the tile accumulation area if the player makes an input to accumulate the tile. For each determined tile, if the player accumulates the tile and the tile accumulation area has less than the maximum quantity of tiles that can be in the tile accumulation area at any given point, the gaming system displays the tile in the tile accumulation area. For each determined tile, if the player keeps the tile and the tile accumulation area has the maximum quantity of tiles that can be in the tile accumulation area at any given point, the gaming system enables the player to make an input to discard one of the tiles in the tile accumulation area such that the discarded tile can be replaced in the tile accumulation area by the tile the player determined decided to accumulate.

In various embodiments, each accumulated tile use sequence can be provided responsive to an accumulated tile use triggering conditions occurs (such as when a determined condition occurs, when there are a sufficient quantity of accumulated tiles in the tile accumulation area, on a player determined basis, or based on another suitable condition). In various embodiments, the gaming system provides the player control over when an accumulated tile use triggering conditions occurs. In other words, in various embodiments, the gaming system provides the player control over when one or more or each accumulated tile use sequences occur(s).

In various embodiments, for each accumulated tile use triggering condition, the gaming system provides an accumulated tile use sequence in which the gaming system: (1) enables the player to place one or more of the accumulated tiles from the tile accumulation area into association with one of the runs of the hand for use in that hand; (2) for each placed tile, remove the display of that tile in the tile accumulation area and cause the display of the that tile in a run tile application area for that run; (3) for each run, determine if the run is completed; (4) for each run, display an indication if the run is completed; (5) for each completed run, display an indication of any award won (or unlocked) associated with the completed run; (6) determine if all of the runs are completed and thus the hand is completed; (7) display an indication if the hand is completed; and (8) display an indication of the award associated with the completed hand.

While certain embodiments described herein are directed to a plurality of plays of a primary game (such as a primary wagering game), it should be appreciated that such embodiments may additionally or alternatively be employed in association with secondary games (such as a plurality of free plays of a secondary game).

While the player's credit balance, the player's wager, and any awards are displayed amounts of monetary credits or currency in certain of the example embodiments described herein, one or more of such player's credit balance, such player's wager, and any awards provided to such a player may be for non-monetary credits, promotional credits, and/or player tracking points or credits.

While the present disclosure is primarily described with respect to reel gaming systems, the present disclosure can be employed with other slot gaming systems, card gaming systems (such as video poker gaming systems), bingo gaming systems, keno gaming systems, skill related gaming systems, and/or social gaming systems. The present invention can work on electronic gaming machines (“EGMs”), video lottery terminals (“VLTs”), website based gaming system, and/or mobile application gaming systems.

### Flowchart for Various Example Embodiments

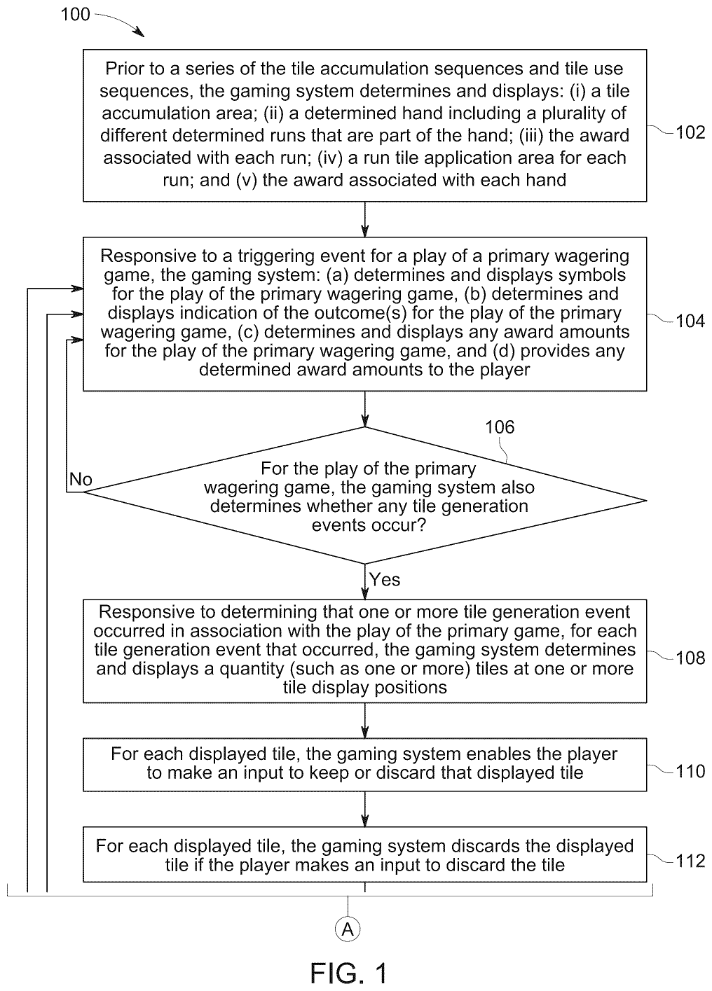

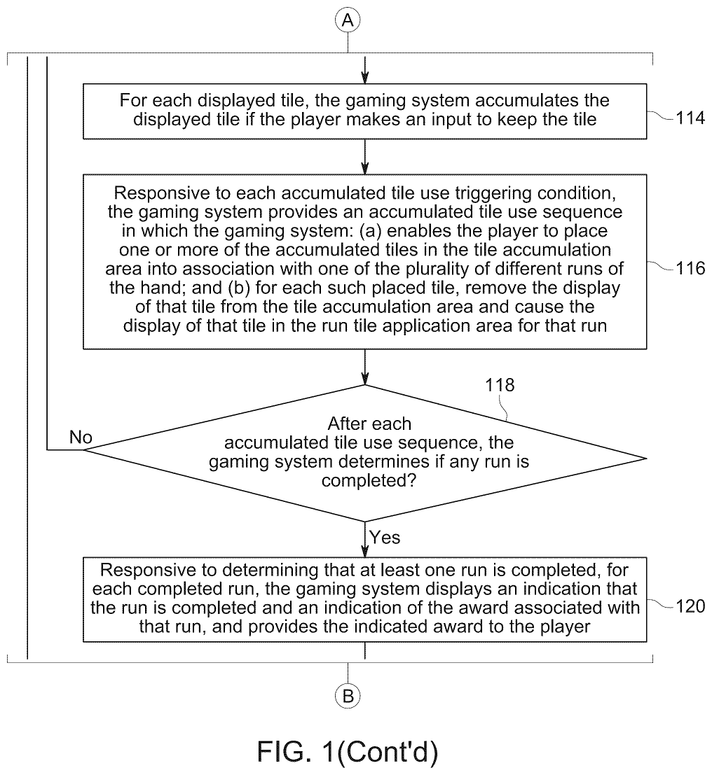

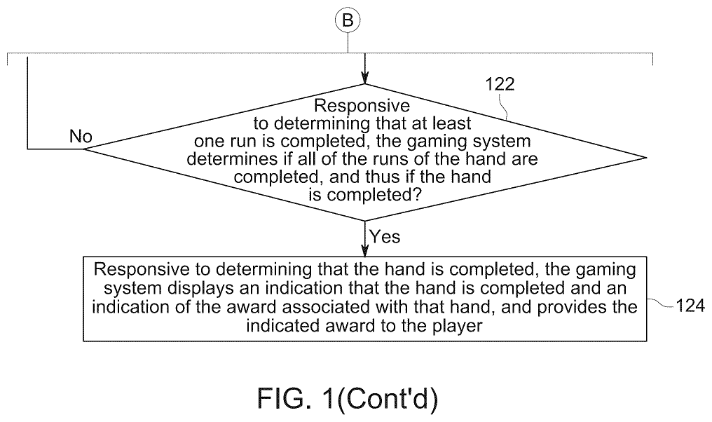

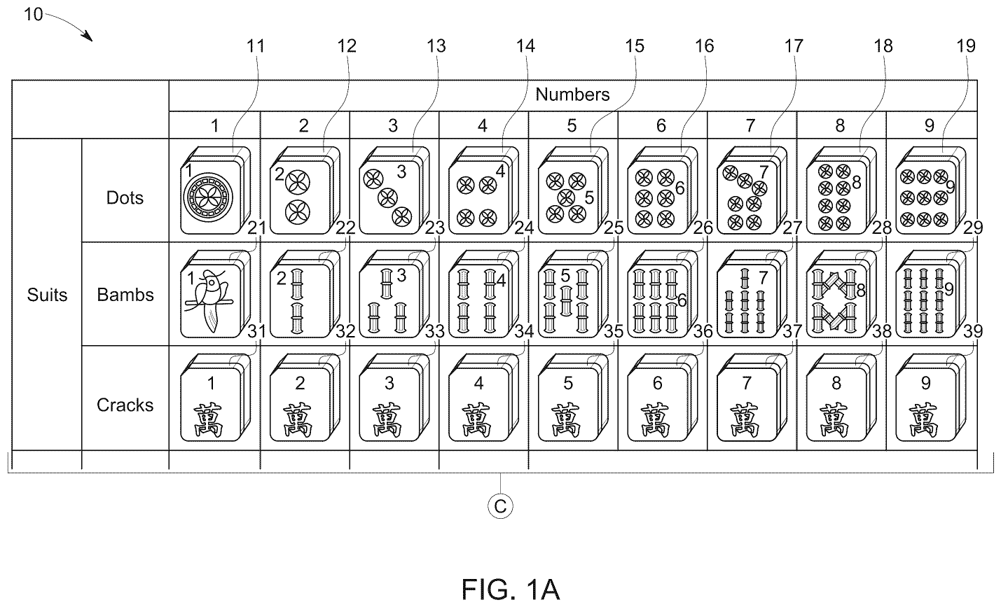

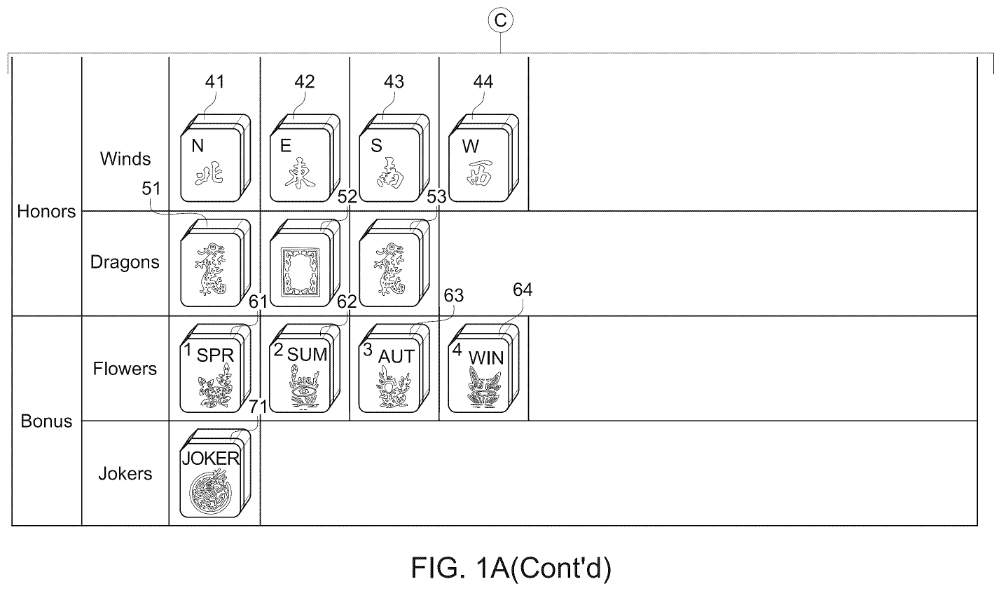

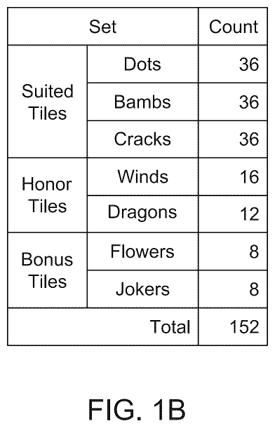

FIG. 1 is a flowchart of an example method 100 of operating a gaming system of the present disclosure. In various embodiments, the method is represented by a set of instructions stored in one or more memories and executed by one or more processors. Although the method is described with reference to the flowchart shown in FIG. 1, many other processes of performing the acts associated with this illustrated method can be employed. For example, the order of certain of the illustrated blocks can be changed, certain of the illustrated blocks may be optional, or certain of the illustrated blocks may not be employed.

Prior to a series of the tile accumulation sequences and tile use sequences, the gaming system determines and displays: (i) a tile accumulation area; (ii) a determined hand including a plurality of different determined runs that are part of the hand; (iii) the award associated with each run; (iv) a run tile application area for each run; and (v) the award associated with each hand, as indicated by block 102.

In various embodiments, the gaming system does not place or display any initial tiles in the tile accumulation area. In various other embodiments, the gaming system determines, places, and displays one or more initial tiles in the tile accumulation area. In various embodiments, the gaming system maintains and displays one or more previously accumulated tiles in the tile accumulation area.

Responsive to a triggering event for a play of a primary wagering game, the gaming system: (a) determines and displays symbols for the play of the primary wagering game, (b) determines and displays indication of the outcome(s) for the play of the primary wagering game, (c) determines and displays any award amounts for the play of the primary wagering game, and (d) provides any determined award amounts to the player, as indicated by block 104.

For the play of the primary wagering game, the gaming system also determines whether any tile generation events occur, as indicated by diamond 106.

Responsive to determining that no tile generation event occurred in association with the play of the primary game, the gaming system returns to block 104.

Responsive to determining that one or more tile generation event occurred in association with the play of the primary game, for each tile generation event that occurred, the gaming system determines and displays a quantity (such as one or more) tiles at one or more tile display positions, as indicated by block 108.

For each displayed tile, the gaming system enables the player to make an input to keep or discard that displayed tile, as indicated by block 110.

For each displayed tile, the gaming system discards the displayed tile if the player makes an input to discard the tile, as indicated by block 112.

For each displayed tile, the gaming system accumulates the displayed tile if the player makes an input to keep the tile, as indicated by block 114. For each accumulated tile, if the tile accumulation area has less than the maximum quantity of tiles that can be in the tile accumulation area at any given point, the gaming system displays the accumulated tile in the tile accumulation area. For each accumulated tile, if the tile accumulation area the maximum quantity of tiles that can be in the tile accumulation area at any given point, the gaming system enables the player to select to discard one of the tiles in the tile accumulation area, and the gaming system discards that previously accumulated tile. Thus, for each accumulated tile, the gaming system displays the tile in the tile accumulation area any may or may not replace one of the tiles in the tile accumulation area.

Responsive to each accumulated tile use triggering condition, the gaming system provides an accumulated tile use sequence in which the gaming system: (a) enables the player to place one or more of the accumulated tiles in the tile accumulation area into association with one of the plurality of different runs of the hand; and (b) for each such placed tile, remove the display of that tile from the tile accumulation area and cause the display of that tile in the run tile application area for that run, as indicated by block 116.

After each accumulated tile use sequence, the gaming system determines if any run is completed, as indicated by diamond 118.

Responsive to determining that no run is completed, the gaming system determines returns to block 104.

Responsive to determining that at least one run is completed, for each completed run, the gaming system displays an indication that the run is completed and an indication of the award associated with that run, and provides the indicated award to the player, as indicated by block 120.

Responsive to determining that at least one run is completed, the gaming system determines if all of the runs of the hand are completed, and thus if the hand is completed, as indicated by diamond 122.

Responsive to determining that the hand is not completed, the gaming system determines returns to block 104.

Responsive to determining that the hand is completed, the gaming system displays an indication that the hand is completed and an indication of the award associated with that hand, and provides the indicated award to the player, as indicated by block 124.

### First Set of Example Embodiments

This first example embodiment employs one example set of mahjong tiles from of various different possible sets of mahjong tiles. This example set of mahjong tiles is generally shown in FIG. 1A and indicated by numeral 10. This set of mahjong tiles 10 include three categories of tiles as also indicated in the table of FIG. 1B, and specifically: (1) suited tiles; (2) honor tiles; and (3) bonus tiles.

The suited tiles include 36 dot tiles including: (1) four 1 dot tiles such as 1 dot tile 11; (2) four 2 dot tiles such as 2 dot tile 12; (3) four 3 dot tiles such as 3 dot tile 13; (4) four 4 dot tiles such as 4 dot tile 14; (5) four 5 dot tiles such as 5 dot tile 15; (6) four 6 dot tiles such as 6 dot tile 16; (7) four 7 dot tiles such as 7 dot tile 17; (8) four 8 dot tiles such as 8 dot tile 18; and (9) four 9 dot tiles such as 9 dot tile 19.

The suited tiles also include 36 bam tiles including: (1) four 1 bam tiles such as 1 bam tile 21; (2) four 2 bam tiles such as 2 bam tile 22; (3) four 3 bam tiles such as 3 bam tile 23; (4) four 4 bam tiles such as 4 bam tile 24; (5) four 5 bam tiles such as 5 bam tile 25; (6) four 6 bam tiles such as 6 bam tile 26; (7) four 7 bam tiles such as 7 bam tile 27; (8) four 8 bam tiles such as 8 bam tile 28; and (9) four 9 bam tiles such as 9 bam tile 29.

The suited tiles also include 36 crack tiles including: (1) four 1 crack tiles such as 1 crack tile 31; (2) four 2 crack tiles such as 2 crack tile 32; (3) four 3 crack tiles such as 3 crack tile 33; (4) four 4 crack tiles such as 4 crack tile 34; (5) four 5 crack tiles such as 5 crack tile 35; (6) four 6 crack tiles such as 6 crack tile 36; (7) four 7 crack tiles such as 7 crack tile 37; (8) four 8 crack tiles such as 8 crack tile 38; and (9) four 9 crack tiles such as 9 crack tile 39.

As indicated above, each of these suited tiles includes a specific symbol and a specific number and thus each tile has two different types of symbols. These symbols can vary in accordance with the present disclosure.

The honor tiles include 16 wind tiles including: (1) four north tiles such as north tile 41; (2) four east tiles such as east tile 42; (3) four south tiles such as south tile 43; and (4) four west tiles such as west tile 44.

As indicated above, these wind honor tiles are not numbered, but are of different types. These symbols can vary in accordance with the present disclosure.

The honor tiles include 12 dragon tiles including: (1) four red (crack related) dragon tiles such as red tile 51; (2) four black (dot related) dragon tiles such as dragon tile 52; and (3) four green (bam related) dragon tiles such as green dragon tile 53.

As indicated above, these honor tiles are not numbered, but are of different types, have different colors (not shown), and are related to different suited tiles. These symbols can vary in accordance with the present disclosure.

The bonus tiles include 8 flower tiles including: (1) 2 flower tiles such as flower tile 61; (2) 2 flower tiles such as flower tile 62; (3) 2 flower tiles such as flower tile 63; and (4) 2 flower tiles such as flower tile 64.

As indicated above, these flower tiles are numbered but do not need to be numbered, and have different symbols but do not need to have different symbols. In other words, even though they have different symbols thereon, they all function in the same manner in this example embodiment. These symbols can vary in accordance with the present disclosure.

The bonus tiles include 8 joker tiles including such as joker tile 71. The joker tiles function as wild tiles and can function as certain tiles in accordance with the present disclosure.

Thus, as indicated in FIG. 1B, this example set of mahjong tiles includes 152 tiles. It should be appreciated that other sets of mahjong tiles can be employed in accordance with the present disclosure.

The present disclosure employs the mahjong tiles, the runs, and the hands based partly on how such tiles, runs, and hands are employed in various mahjong games. Since mahjong games and the use of tiles, runs, and hands in such mahjong games are widely known and played, the present disclosure does not describe such mahjong games in any detail (and thus presumes a general knowledge of such mahjong games even though different people play mahjong games according to different rules). The present disclosure provides new and different ways to employ such mahjong tiles, the runs, and the hands in gaming environments and particularly in wagering gaming environments and for gaming systems such as described herein.

In various embodiments, the gaming system employs the set of mahjong tiles without weighting-such that when the gaming system makes random determinations of such tiles, such random determinations are based solely on the quantities of the 152 tiles remaining in the set of tiles (i.e., the tiles that have not been previously employed in the sequences).

In various embodiments, the gaming system employs the set of mahjong tiles with weighting-such that when the gaming system makes random determinations of such tiles, such random determinations are based on such weighting and on the quantities of the 152 tiles remaining in the set of tiles (i.e., the tiles that have not been previously employed in the sequences).

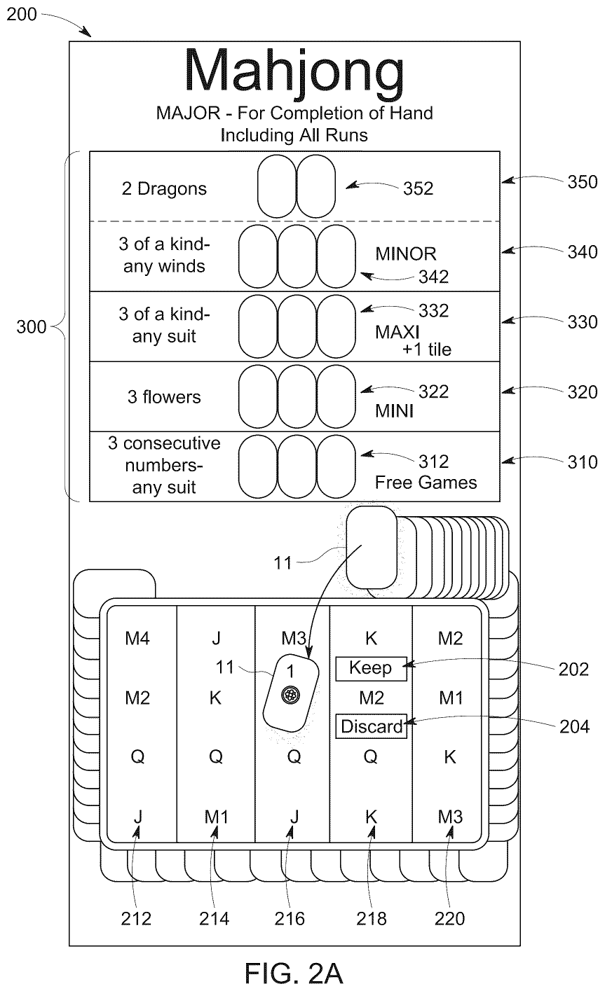

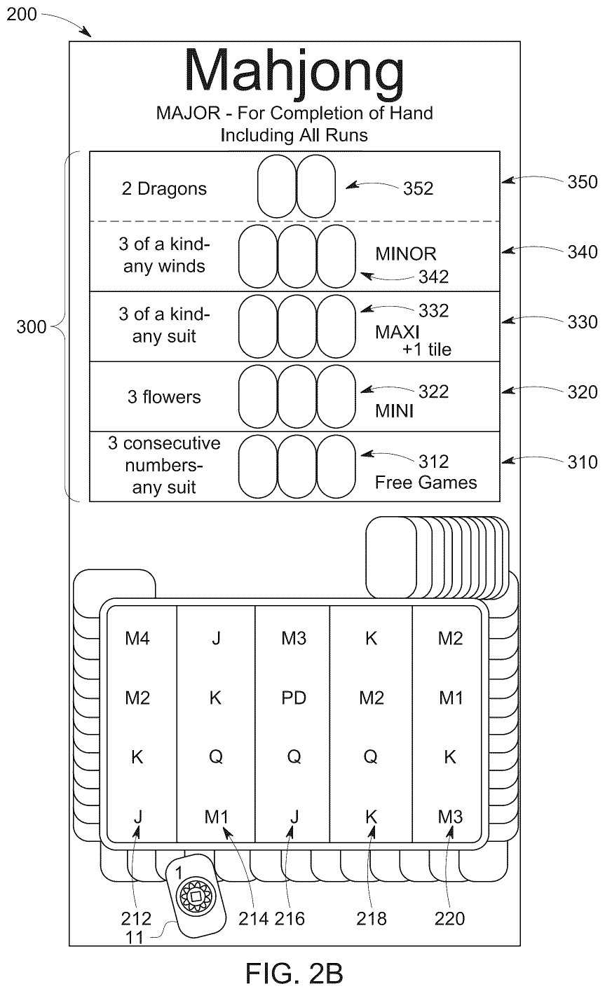

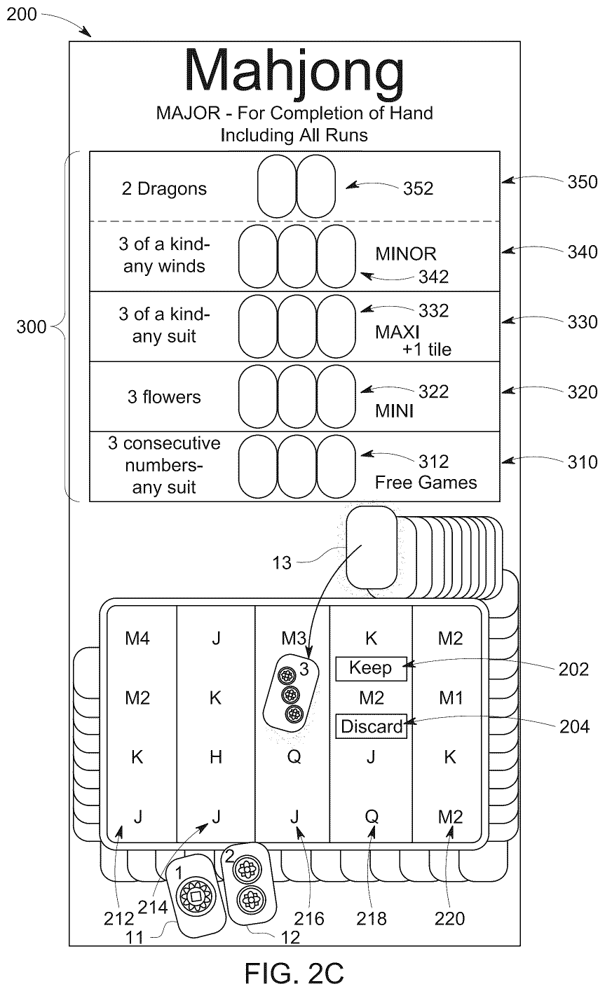

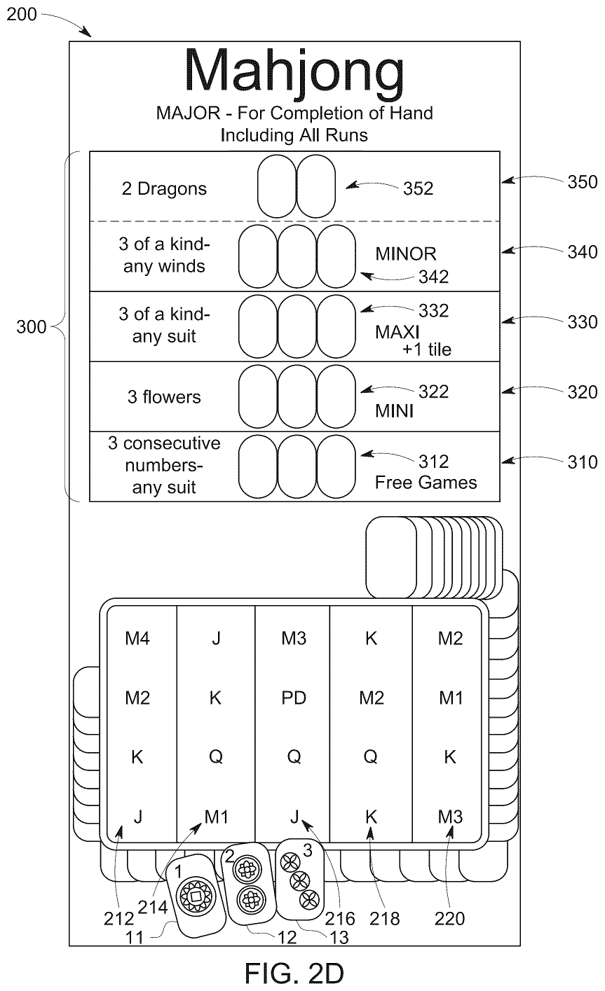

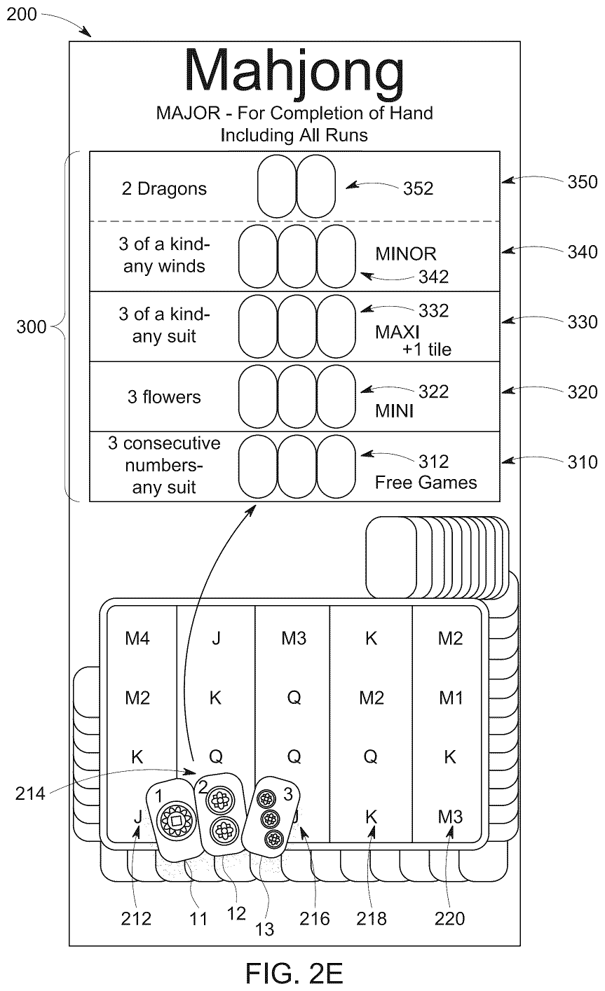

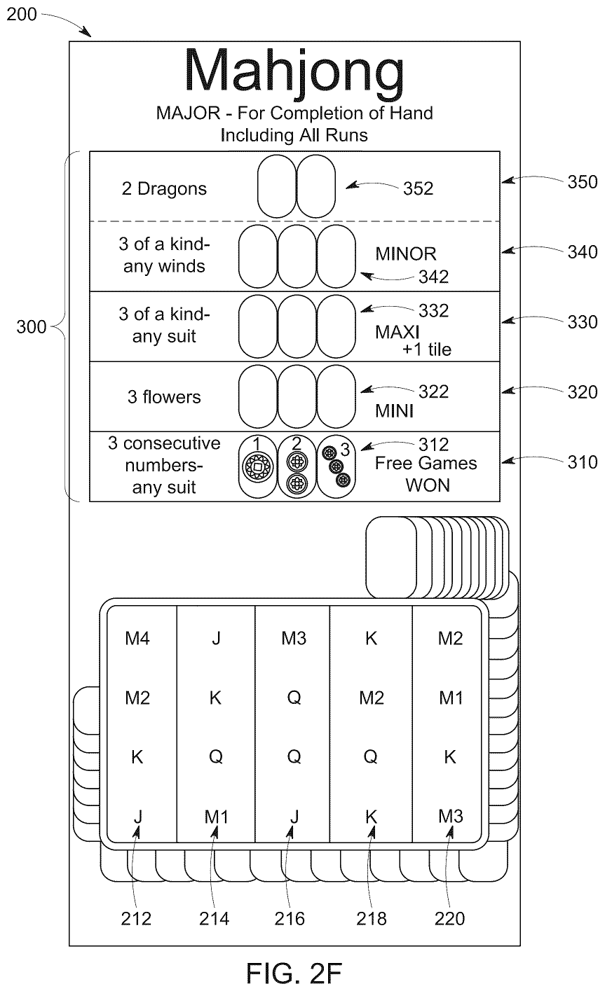

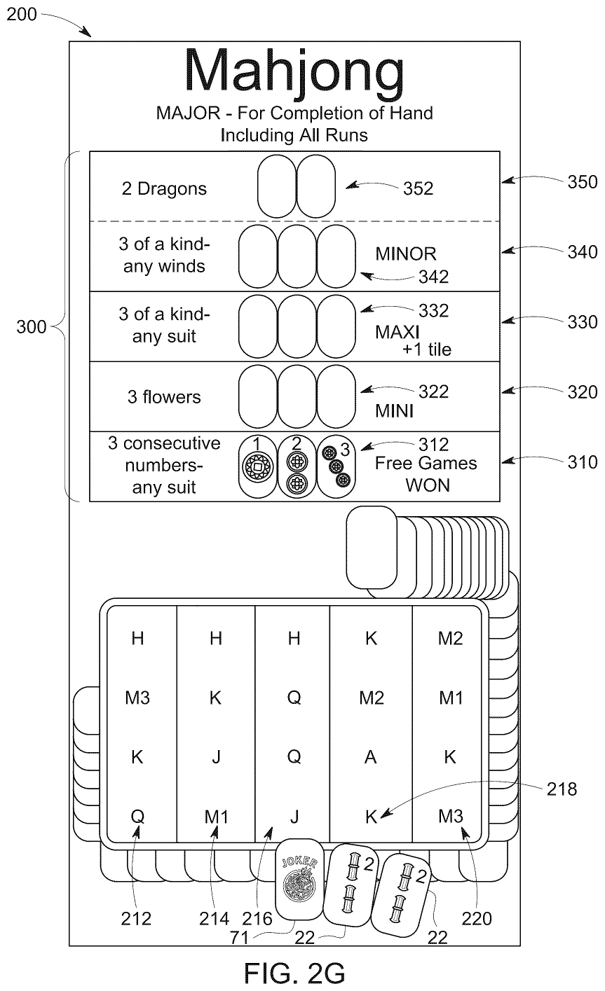

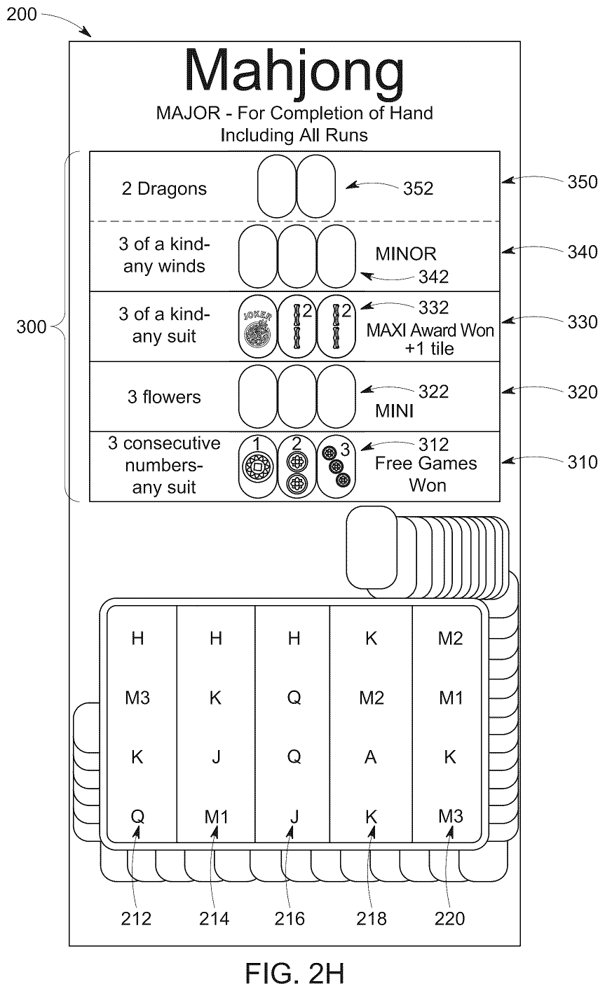

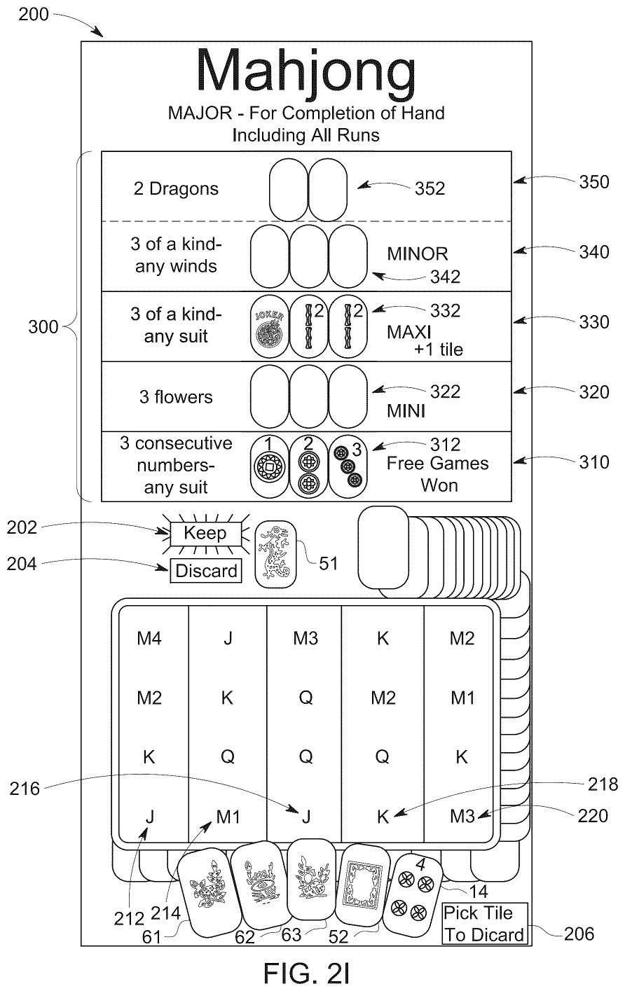

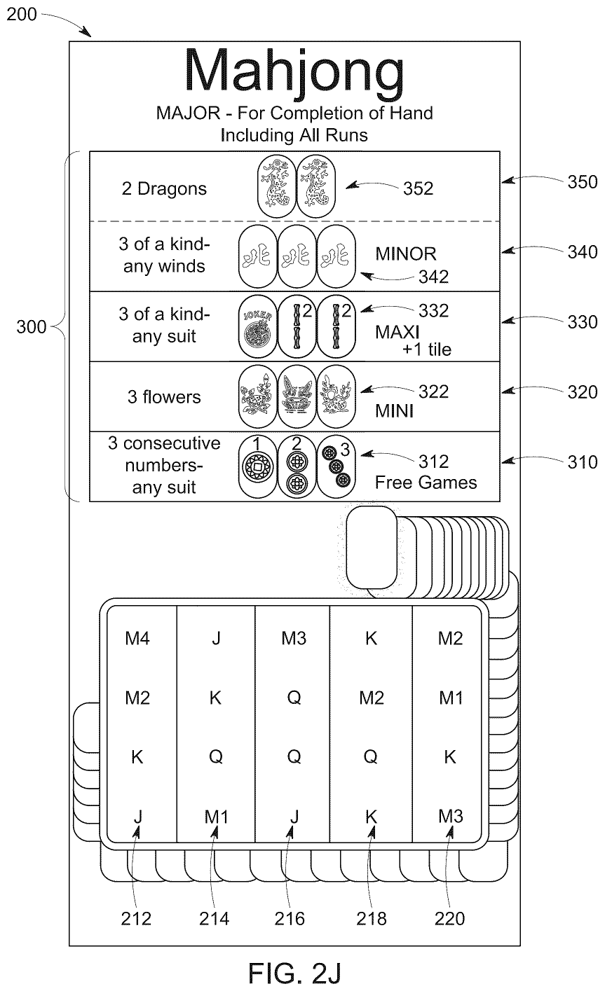

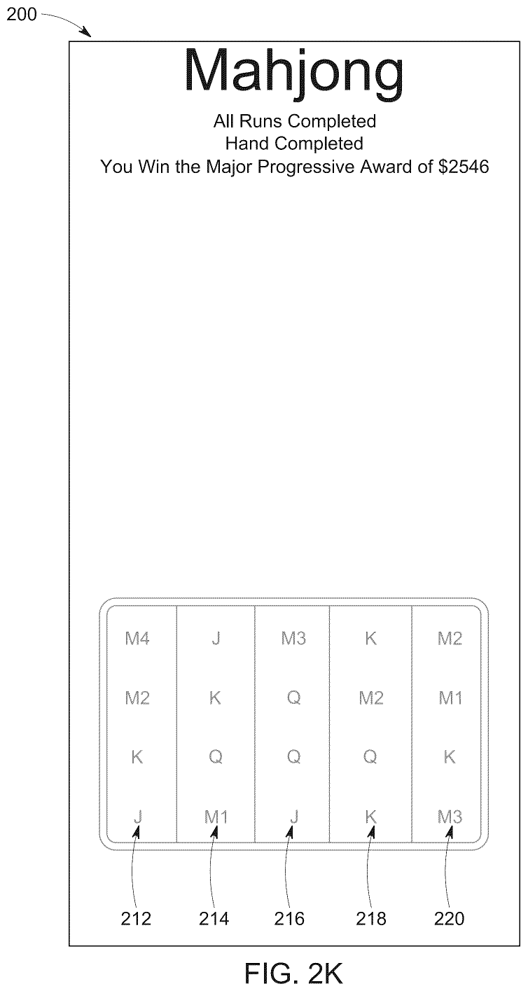

In various embodiments, the gaming system determines the order of the mahjong tiles that the gaming system will display for the accumulation sequences prior to all of the accumulation sequences. In certain such embodiments, the gaming system can display such tiles (face down) such as shown in FIG. 2A or in any other suitable manner. In other such embodiments, the gaming system does not display such tiles prior to revealing each such tile in the respective accumulation sequence.

In various embodiments, the gaming system determines each mahjong tile for each accumulation sequence when the gaming system needs to display that tile for that accumulation sequence.

In various embodiments, the gaming system enables the player to accumulate an unlimited quantity of different tiles for use in the tile accumulation sequences. For such embodiments, the gaming system enables the player to use all of such accumulated tiles in the accumulated tile use sequences.

In various embodiments, the gaming system enables the player to keep and thus accumulate only a certain quantity of tiles in the accumulation sequences. For such embodiments, the gaming system enables the player to use all of such accumulated tiles in the accumulated tile use sequences, but the quantity of such accumulated tiles is limited.

In these various embodiments, the gaming system enables the player to use the accumulated tiles to form the different runs of the hand to complete those runs and to complete the hand that includes such runs. For each such run completed, the gaming system provides the award associated with such run to the player. When the hand is completed, the gaming system provides the award associated with the hand to the player.

In various embodiments, the gaming system provides the player a limited quantity of plays of the primary wagering game to complete the runs of the hand and thus the hand.

In various embodiments, the gaming system provides the player a limited quantity of accumulated tiles to complete the runs of the hand and thus the hand.

In various embodiments, the gaming system provides the player a limited quantity of replacements of the accumulated tiles in the tile accumulation area to complete the runs of the hand and thus the hand.

In various embodiments, the gaming system provides the player a limited quantity of time to complete the runs of the hand and thus the hand.

In various embodiments, the gaming system provides the award associated with a run if the tiles of the underlying game exactly match the tiles in the run. In such case, runs with less tiles generally increase the chance of winning the award associated with the run.

In various embodiments, a run can be completed with any suitable respective tiles that meet the requirement of the run.

In various embodiments, the tiles used to complete a run do not affect the award associated with the run. For example, if either of: (1) a 1 dot tile, a 2 dot tile, and a 3 dot tile; or (2) a 7 dot tile, an 8 dot tile, and a 9 dot tile, are used to complete a run, the award associated with that run is not affected.

In various embodiments, the tiles used to complete a run can affect the award associated with the run. For example, if: (1) a 1 dot tile, a 2 dot tile, and a 3 dot tile are used to complete a run, the award can be a first amount, and if (2) a 7 dot tile, an 8 dot tile, and a 9 dot tile, are used to complete the run, the award associated with that run can be a higher second amount. In another example, if: (1) a 1 dot tile, a 2 dot tile, and a 3 dot tile are used to complete a run, the award can be a first quantity of free plays of a game, and if (2) a 7 dot tile, a 8 dot tile, and a 9 dot tile, are used to complete the run, the award associated with that run can be a higher quantity of free plays of the game.

In various embodiments, the actual numbers (i.e., symbols) of the tiles that are used to complete a run can be taken into account in partly determining the award for that run. For example, if: (1) a 1 dot tile, a 2 dot tile, and a 3 dot tile are used to complete a run, the award can be three free plays of a game, and if (2) a 7 dot tile, a 8 dot tile, and a 9 dot tile are used to complete the run, the award associated with that run can be 9 free plays of the game. In this embodiment, the highest number tiles are employed to determine the quantity of free plays. In other embodiment, the numbers of the tiles (such as the sum of the numbers of the tiles) are employed to determine the quantity of free plays. Thus, in various embodiments, the award associated with a run can vary based on one type of the symbols on the tiles (such as the numbers or other symbols on the tiles) used to complete that run.

In various embodiments, the award associated with a run can vary based on one or more other the characteristics of the symbols on the tiles (such as the colors of the symbols or the suits on the tiles) used to complete that run. For example, the award for a run can be five free plays if tiles of the dot suit are used to complete that run, can be ten free plays if tiles of the bam suit are used to complete that run, and can be 15 free plays if tiles of the crack suit are used to complete that run.

FIGS. 2A, 2B, 2C, 2D, 2E, 2F, 2G, 2H, 2I, 2J, and 2K illustrate parts of a plurality of plays of a primary wagering game that includes symbol display elements in the form of reels, and wherein tiles can be determined and displayed, the determined and displayed tiles can be accumulated by the player in accumulation sequences, and the accumulated tiles can be employed by the player in use sequences, all in accordance with example embodiments of the gaming system of the present disclosure.

In these examples, the display device 200 of the gaming system displays plays of a primary reel wagering game including five symbol display elements in the form of reels 212, 214, 216, 218, and 220 and a plurality of different symbols (not labeled) on each reel 212, 214, 216, 218, and 220. It should also be appreciated that any suitable quantity of reels and any suitable symbols can be employed in accordance with the present disclosure. It should be appreciated that any suitable other primary games (such as but not limited to other reels games, card games, keno games, or bingo games) can be employed in accordance with the present disclosure.

As shown in FIG. 2A, the gaming system causes the display device 200 to display: (1) a determined hand 300 that includes a plurality of different determined runs including in this example different runs 310, 320, 330, 340, and 350 and indications of each such run; (2) tile application areas 312, 322, 332, 342, and 352 respectively associated with and for each of the respective runs 310, 320, 330, 340, and 350; (3) indications of different determined awards (not labeled) respectively associated with the runs 310, 320, 330, 340, and 350; and (4) an indication of a determined award (not labeled) associated with the hand 300.

In these examples, the hand 300, the runs 310, 320, 330, 340, and 350, and the associated awards are all determined by the gaming system prior to beginning the sequences.

In other embodiments such as discussed below, one or more of the hand 300, the runs 310, 320, 330, 340, and 350, and the associated awards are selected by the player prior to beginning the sequences. In such embodiments, the gaming system enables the player to select such features from a plurality of different features such as different hands (with respective different runs and respective different awards). In other words, in various such embodiments, the gaming system enables the player to select the specific hand (and thus the associated runs of that hand) form a plurality of different hands that the player wants to accumulate tiles toward completing prior to accumulating tiles.

In this example: (a) the run 310 is 3 consecutive numbers of any suit and is associated with the award of Free Games; (b) the run 320 is 3 flower tiles and is associated with the Mini progressive award; (c) the run 330 is 3 of any kind of any suited tiles and is associated with the Maxi progressive award and one extra accumulated tile; (d) the run 340 is 3 of a kind any wind tiles and is associated with the Minor progressive award; and (e) the run 350 is 2 dragon tiles and is also associated with the Minor progressive award.

In this example, while the runs are individually associated with free games and different progressive awards, it should be appreciated that the runs can be associated with any suitable awards, award opportunities, or can unlock awards that can be subsequently won by the player. In this example, runs 310, 320, and 330 are each associated with a separate award. Thus, when each such run is obtained, the gaming system provides that respective award associated with that run to the player. In this example, runs 340 and 350 are both associated with the Minor progressive award, and both runs 340 and 350 thus need to be obtained for the gaming system to provide that award to the player. In this example, all of the runs must be obtained for the gaming system to provide the player the Major progressive award that is associated with the hand 300. In this example, while the hand 300 is associated with the Major progressive award, it should be appreciated that the hand 300 can be associated with any suitable award or award opportunity such as one or more plays of a secondary game.

In this example embodiment, when a run is completed the gaming system provides the player the award associated with the run that is completed.

In various other embodiments, when a run is completed, the award associated with that completed run is unlocked for the player such that the player is the subsequently able to win that award from one or more further plays of the primary wagering game.

As indicated in FIG. 2A, the hand 300, the runs 310, 320, 330, 340, and 350, and the associated awards are all displayed to the player prior to beginning the sequences in this example. Additionally, as indicated by FIG. 2A, the order of the tiles (not labeled) is also indicated with tile 11 being the first tile that will be revealed. While these tiles are shown substantially surrounding the reels 212, 214, 216, 218, and 220, these tiles can be displayed or otherwise indicated in any suitable manner in accordance with the present disclosure.

FIG. 2A illustrates the reels 212, 214, 216, 218, and 220 stopped after the reels are spun, and the reels 212, 214, 216, 218, and 220 displaying randomly determined symbols (not labeled) at a plurality of symbol display positions (not labeled) for a play of the wagering game (after the player has made a wager for this play of the wagering game). The gaming system determines any awards based on those displayed symbols, and displays any determined awards. In this example, the gaming system determines the award of 1000 credits based on the occurrence of the four Q symbols.

In this example, a tile generation event occurs for each play of the primary wagering game. As indicated above, the tile generation event can occur in various different manners in accordance with the present disclosure.

In this example, for the tile generation event for this play of the primary wagering game, the gaming system determines and displays a 1 Dot tile 11 and asks the player whether the player wants to keep or discard this tile 11 (via the displayed Keep and Discard input buttons 202 and 204 that are displayed by the display device 200 which is associated with a touch screen for receiving the player input). In this example, since the player has not accumulated any tiles yet, the player makes the keep input and the gaming system displays the tile 11 in the tile accumulation area such as shown in FIG. 2B. In other embodiments, since the tile accumulation area is not full, the gaming system can automatically keep the tile and only provide such keep or discard decisions for the player when the tile accumulation area is full.

In this example embodiment, the tile accumulation area enables the player to accumulate five tiles. This quantity can vary in accordance with the present disclosure. If there are five accumulated tiles in the tile accumulation area, the player must discard one of the five accumulated tiles to accumulate another tile in that tile accumulation area. Thus, the player is limited to having five accumulated tiles at any one point in time. In various embodiments, the quantity of tiles that can be accumulated in the tile accumulation area is static. In various embodiments, the quantity of tiles that can be accumulated in the tile accumulation area is variable such as based on player wager amount levels. In various embodiments, the quantity of tiles that can be accumulated in the tile accumulation area is variable such as based on player wager denomination levels. In various embodiments, the quantity of tiles that can be accumulated in the tile accumulation area is variable such as based on player selection or choice, and in certain such embodiments, can affect the award amounts. In various embodiments, the quantity of tiles that can be accumulated in the tile accumulation area is variable based on one or more events that occur such as events that occur in the plays of the primary wagering game.

Turning back to the illustrated example, in a subsequent play of the wagering game (after the player has made a wager for this play of the wagering game) that is not shown herein, the player has accumulated the 2 dot tile 12 as indicated in FIG. 2C.

FIG. 2C illustrates the reels 212, 214, 216, 218, and 220 stopped after the reels are spun, and the reels 212, 214, 216, 218, and 220 displaying randomly determined symbols (not labeled) at a plurality of symbol display positions (not labeled) for a further subsequent play of the wagering game (after the player has made a wager for this play of the wagering game). The gaming system determines any awards based on those displayed symbols, and displays any determined awards. In this example, the gaming system determines the award of 200 credits based on the occurrence of the three J symbols. In this example, for the tile generation event for this play of the primary wagering game, the gaming system determines and displays a 3 Dot tile 13 and asks the player whether the player wants to keep or discard this tile 13 (via the displayed Keep and Discard input buttons 202 and 204). In this example, the player makes the keep input and the gaming system displays the tile 13 in the tile accumulation area such as shown in FIG. 2D.

As shown in FIGS. 2D and 2E, at this point, the player has accumulated the 1 Dot tile 11, the 2 Dot tile 12, and the 3 Dot tile 13 in the tile accumulation area. Since the run 310 is for 3 consecutive numbers of any suit, the player has accumulated the required tiles to complete the run 310. In this embodiment, the gaming system enables the player to move the accumulated tiles 11, 12, and 13 that complete the run 310 to the tile application area 312 for the run 310. This is partially shown in FIGS. 2E and 2F where the tiles 11, 12, and 13 are moving and have been moved into the tile application area 312 associated with run 310 and the gaming system has indicated that the player has won the free games award associated with run 310 such as shown in FIG. 2F.

The gaming system can provide the free games won at any suitable time in accordance with the present disclosure.

In various embodiments, the gaming system provides the free games wherein one or more additional tiles can be accumulated in accumulation sequences associated with the plays of those free games.

In various other embodiments, the gaming system provides the free games wherein no additional tiles can be accumulated in association with the plays of those free games.

In various embodiments, the gaming system enables the player to move one or more accumulated tiles that partially complete a run to the tile accumulation area for that run without having accumulated all of the tiles that completes the run. In such embodiments, the player is risking not accumulating the rest of the required tiles needed to complete that run.

FIG. 2G illustrates the reels 212, 214, 216, 218, and 220 stopped after the reels are spun, and the reels 212, 214, 216, 218, and 220 displaying randomly determined symbols (not labeled) at a plurality of symbol display positions (not labeled) for a further subsequent play of the wagering game (after the player has made a wager for this play of the wagering game). The gaming system determines any awards based on those displayed symbols, and displays any determined awards. In this example, the gaming system determines the award of 2000 credits based on the occurrence of the four K symbols. In this example, for the tile generation event for this play of the primary wagering game, the gaming system has determined and displayed a Joker tile 71, the player has kept that Joker tile 71, and that Joker tile has been added to the tile accumulation area. Thus, at this point, the tile accumulation area has the Joker tile 71 and two 2 bam tiles 22. Since the run 330 is for 3 of a kind any suit, the player has accumulated suitable tiles to complete the run 330. The gaming system enables the player to move the accumulated tiles 71, 22, and 22 that complete the run 330 to the tile application area 332 for the run 330. This is partially shown in FIG. 2H where the tiles 71, 22, and 22 have been moved into the tile application area 332 associated with run 320 and the gaming system has indicated that the player has won the Maxi progressive award associated with run 330 and has indicated that the player has also won an additional tile (which is not yet shown).

FIG. 2I illustrates the reels 212, 214, 216, 218, and 220 stopped after the reels are spun, and the reels 212, 214, 216, 218, and 220 displaying randomly determined symbols (not labeled) at a plurality of symbol display positions (not labeled) for a further subsequent play of the wagering game (after the player has made a wager for this play of the wagering game). The gaming system determines any awards based on those displayed symbols, and displays any determined awards. In this example, the gaming system there are no winning symbol combinations. In this example, for the tile generation event for this play of the primary wagering game, the gaming system has determined and displayed a dragon tile 51, and asks the player whether the player wants to keep or discard this tile 51 (via the displayed Keep and Discard input buttons 202 and 204). In this example, since the player makes the keep input and since the player has done so, and since the tile accumulation area is full, the gaming system displays an indication 206 asking the player to pick an accumulated tile in the tile accumulation area to discard such as shown in FIG. 2I. In this example, although not shown, the player picks then 4 dot tile 14 to discard, and the gaming system discards that tile and replaces that tile in the tile accumulation area with the dragon tile 51.

FIGS. 2J and 2K show subsequent points after several subsequent plays of the primary wagering game where the player has accumulated and used all of the tiles to complete each of the runs 310, 320, 330, 340, and 350 of the hand 300. The gaming system has determined that the player has also completed the hand 300 and displays an indication to the player that the player has won the mahjong hand and the Major progressive award associated with the hand 300.

It should be appreciated that the tiles can be generated in any suitable manner in accordance with the present disclosure. In various example embodiments, one or more or all of the tiles can be generated from or based on: (1) the symbols on the symbol display elements (such as the reels); (2) determinations separate from the symbols on the symbol display elements (such as the reels); and/or (3) one or more walls, stacks, or groups of tiles. In various embodiments, the gaming system does not regenerate discarded tiles. In various embodiments, the gaming system can regenerate one or more discarded tiles (such as tiles shuffled back into the group of tiles).

It should be appreciated from the above that various embodiments of the present disclosure provide a gaming system configured to display: an indication of a hand; indications of different runs of the hand, and for each run, a tile application area associated with that run and an indication of tiles required to complete the run; a tile accumulation area; symbol display elements; activations of the symbol display elements; tiles associated with the activations of the symbol display elements; for each of the displayed tiles, of an indication of whether the tile is accumulated and displayed in the tile accumulation area or the tile is discarded; for the displayed tiles in the tile accumulation area, of indications of tiles placed in the tile application areas associated with the runs; for each of the runs, an indication of a completion of the run based on the tiles placed in the tile application area associated with the run and that are required to complete the run; and an indication of a completion of the hand after all of the indications of the completions of all of the runs. In various such embodiments, the tiles are mahjong tiles. In various such embodiments, the runs are all different. In various such embodiments, the gaming system is configured to display, for each run, an indication of an award associated with that run. In various such embodiments, the gaming system is configured to display, for each run that is completed, of an indication that the award associated with that run is unlocked. In various such embodiments, the gaming system is configured to display, for each run that is completed, of an indication that the award associated with that run is provided to the player. In various embodiments, the gaming system is configured to display, an indication of an award associated with the hand. In various such embodiments, the gaming system is configured to display, the indications of whether the tiles are accumulated and displayed in the tile accumulation area or the tiles are discarded based on received player inputs. In various such embodiments, the gaming system is configured to display the indications of the tiles in the tile accumulation placed in the tile application areas associated with the runs based on received player inputs.

It should further be appreciated from the above that various embodiments of the present disclosure provide a gaming system configured to display: an indication of a hand comprising different runs, and for each run an indication of tiles required to complete the run; symbol display elements; activations of the symbol display elements; tiles associated with the activations of the symbol display elements; for each of the displayed tiles, of an indication of whether the tile is accumulated or the tile is discarded; for the accumulated tiles, of placements of the tiles in association with the runs; for each of the runs, an indication of a completion of the run based on the tiles associated with the run and that are required to complete the run; and an indication of a completion of the hand after all of the indications of the completions of all of the runs. In various such embodiments, the tiles are mahjong tiles. In various such embodiments, the gaming system is configured to display an indication that the award associated with that run that is provided to the player, and after completion of all of the runs of an indication of an award associated with the hand that is provided to the player. In various such embodiments, the gaming system is configured to display indications of whether the tiles are accumulated or the tiles are discarded based on received player inputs. In various such embodiments, the gaming system is configured to display indications of the tiles placed in the tile application areas associated with the runs based on received player inputs.

It should further be appreciated from the above that various embodiments of the present disclosure provide a gaming system configured to display: an indication of a hand comprising different runs, and for each run an indication of tiles required to complete the run; symbol display elements; sequentially each of a plurality of different tiles responsive to tile generation events associated with the symbol display elements; for each of the displayed tiles, of an indication of whether the tile is accumulated or the tile is discarded, wherein a limited quantity of tiles can be accumulated at any one time; for the accumulated tiles, of placements of the tiles in association with the runs, wherein for each placement of a tile in association with one of the runs, the quantity of accumulated tiles is reduced; for each of the runs, an indication of a completion of the run based on the tiles associated with the run and that are required to complete the run; and an indication of a completion of the hand after all of the indications of the completions of all of the runs. In various such embodiments, the tiles are mahjong tiles. In various such embodiments, the gaming system is configured to display indications of whether the tiles are accumulated or the tiles are discarded based on received player inputs. In various such embodiments, the gaming system is configured to display, one of the accumulated tiles being discarded based on a received player input. In various such embodiments, the gaming system is configured to display, the indications of the tiles placed in the tile application areas associated with the runs based on received player inputs. In various such embodiments, the gaming system is configured to display the indication of one of the accumulated tiles placed in the tile application area associated with one of the runs based on a received player input, wherein said tile only partially completes said run.

### Second Set of Example Embodiments

In various embodiments, the gaming system employs a run bypass feature in one or more of the accumulated tile use sequences.

In various embodiments, the gaming system enables the player to complete one or more of the runs of the hand without obtaining all of the tiles needed to complete that run. In other words, in various such embodiments, the gaming system enables a player to bypass or improperly complete one or more of the runs of the hand. Thus, the gaming system enables the player to place one or more non-matching tiles in each of one or more runs of the hand and thus bypass the award associated with that run.

In various embodiments, the gaming system does not provide the player with the award associated with that improperly completed and thus bypassed run. In various embodiments, the gaming system does not provide the player with all of the award associated with that improperly completed and thus bypassed run. In various embodiments, the gaming system only provides part of the award associated with the improperly completed and thus bypassed run.

In various embodiments, the gaming system enables the player to improperly complete and thus bypass one or more runs in an effort to complete the hand to try to achieve the award associated with the hand (while bypassing trying to achieve the awards associated with one or more of the runs).

In various embodiments, the gaming system provides the player with the total award associated with the hand if the player improperly completes and thus bypass one or more of the runs. In various embodiments, the gaming system does not provide the player with the total award associated with the hand if the player improperly completes and thus bypasses one or more of the runs. In various embodiments, the gaming system provides the player with part of the award associated with the hand if the player improperly completes and thus bypasses one or more runs of the hand.

In various embodiments, the gaming system determines and indicates the quantity of the runs of the hand that can be improperly completed and thus bypassed. In various embodiments, the gaming system determines and indicates which of the runs of the hand can be improperly completed and thus bypassed. In various embodiments, the gaming system randomly determines and indicates when one or more of the runs of the hand can be improperly completed and thus bypassed. In various embodiments, the gaming system determines and indicates when one or more of the runs of the hand can be improperly completed and thus bypassed in one or more other manners such as based on wager amount level or in a predetermined manner.

In various embodiments, only one run of the hand can be improperly completed and thus bypassed.

In various embodiments, more than one run of the hand, but not all of the runs of the hand can be improperly completed and thus bypassed.

In various embodiments, all of the runs of the hand can be improperly completed and thus bypassed.

In various embodiments, such configurations of the runs and the hand enables the player to make the decision to actually bypass trying for certain of the awards associated with the runs (such as by placing improper tiles in the tile areas for such hand) because the player wants to achieve the overarching award (such as a play of secondary game) or part thereof associated with hand instead of the awards (such as the smaller awards individually associated with the runs).

In various embodiments, this configuration can be helpful for the player in various situations. Such situations include but are not limited to: (1) if the player has discarded one or more tiles and there are no remaining tiles to complete a run based on the remaining tiles that can be accumulated and the currently accumulated tiles; (2) if the player is close to completing or has completed the other runs of the hand; (3) if the gaming system provides the player a limited period (such as a limited time period or a limited quantity of plays of the primary game) to complete the hand; (4) if the gaming system provides the player a limited quantity of accumulated tiles to complete the hand; or (5) if the player wants the experience and award or award opportunity provided by the completed the hand (such as awards from a play of a secondary game such as a spin of an award wheel to determine the award associated with the completion of the hand). Effectively, this configuration enables the player to race toward the award associated with the hand and give up on (and thus bypass) one or more of the awards associated with the runs. This configuration can also be employed to provide player selectable volatility (such as based on the increasing or decreasing volatility of the awards associated with the runs and the hand).

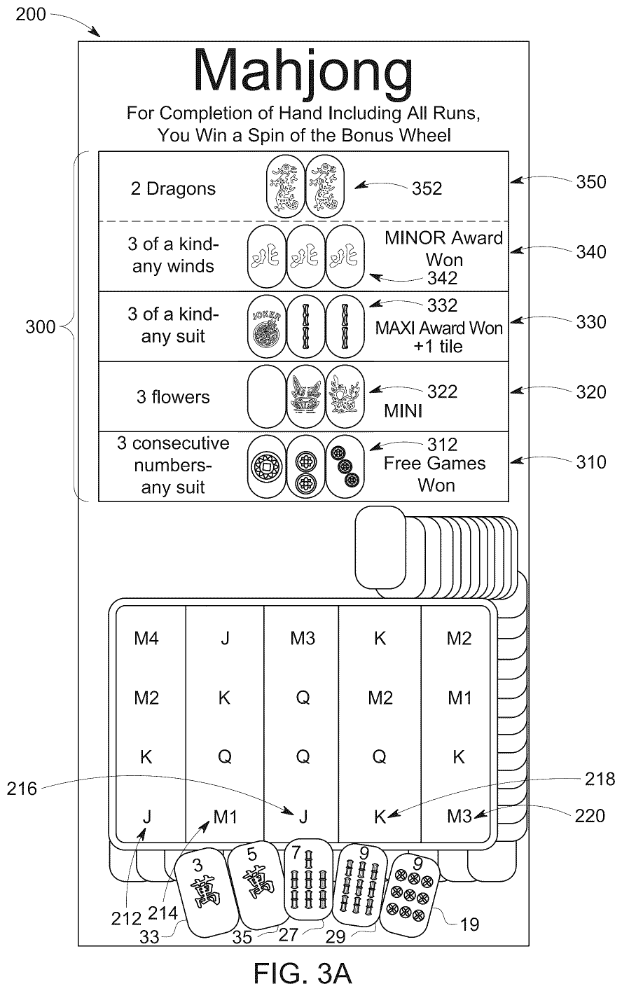

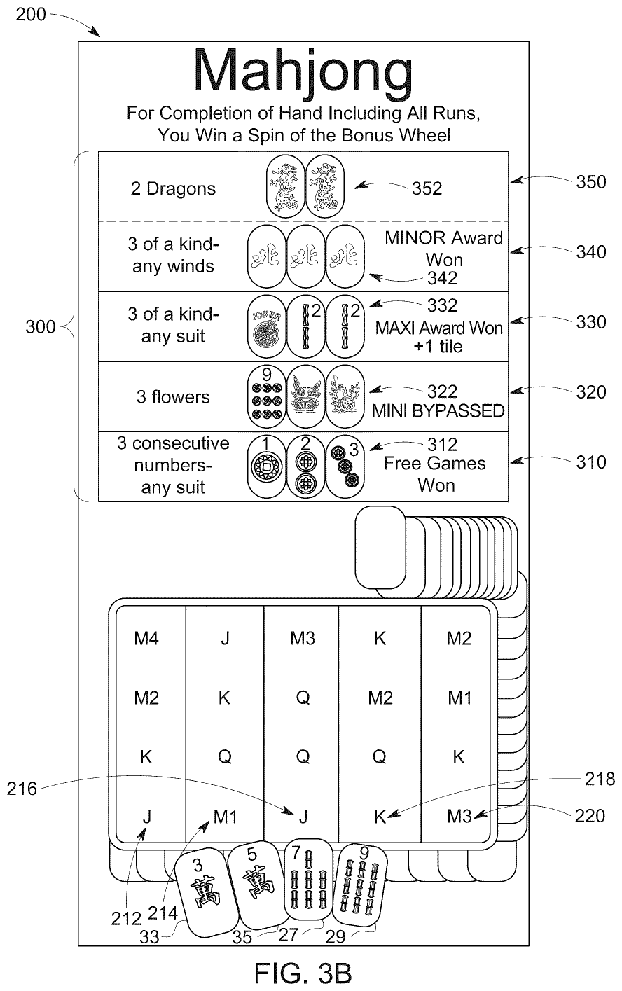

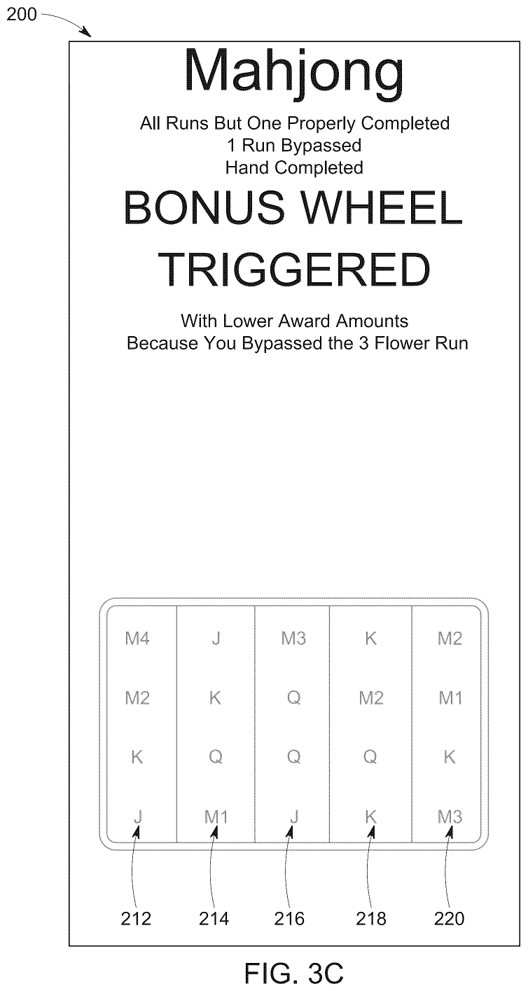

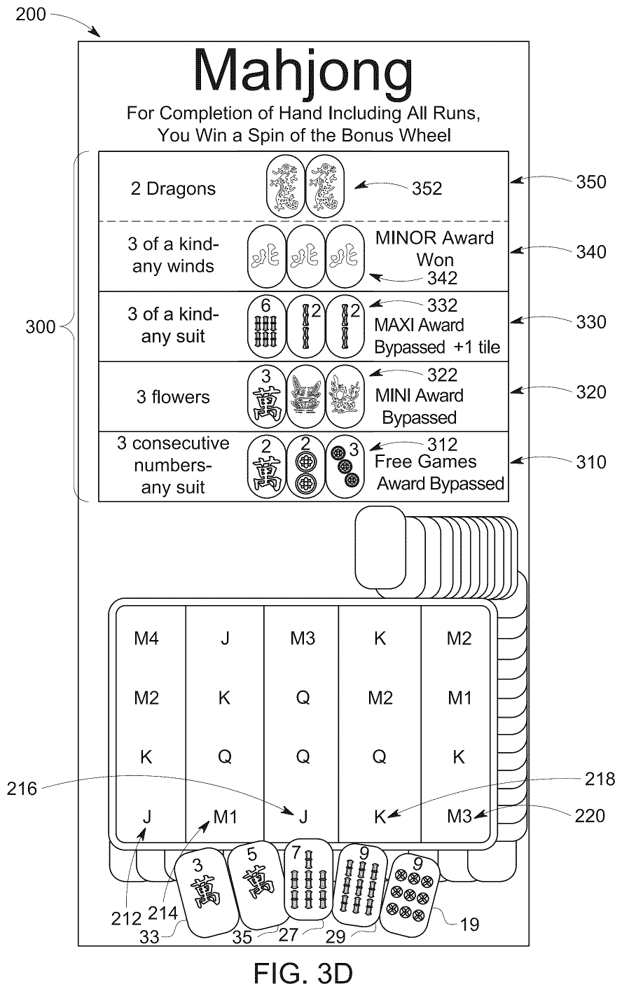

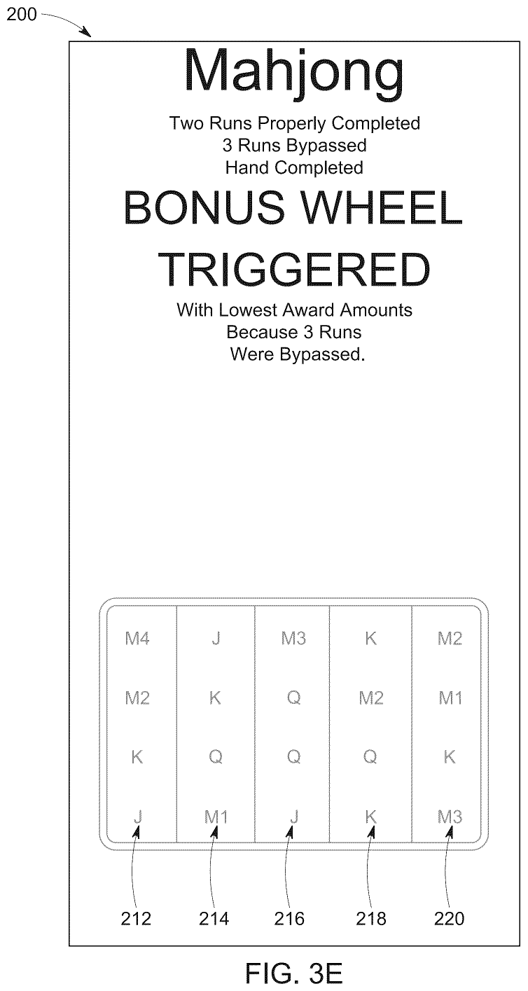

FIG. 3A illustrates a point after which the player has completed runs 310, 330, 340, and 350, but has not completed run 320. Specifically, the player has placed two flower tiles in the tile placement area 322 associated with run 320 but does not have any flower tiles in the tile accumulation area. Rather, the player has the following accumulated tiles in the tile accumulation area: (1) the 3 crack tile 33; (2) the 5 crack tile 35; (3) the 7 bam tile 27; and (4) the 9 bam tile 29; and (5) the 9 dot tile 19. So, the player cannot at this point complete the run 330.

FIG. 3A also illustrates the reels 212, 214, 216, 218, and 220 stopped after the reels are spun, and the reels 212, 214, 216, 218, and 220 displaying randomly determined symbols (not labeled) at a plurality of symbol display positions (not labeled) for a further subsequent play of the wagering game (after the player has made a wager for this play of the wagering game). In this example, since there are no winning symbol combinations, the gaming system has not provided any awards for this play of the primary game. In this example, for the tile generation event for this play of the primary wagering game, the gaming system has determined and displayed a dragon tile 51 (not shown), and has asked the player whether the player wants to keep or discard this tile 51. In this example, the player does not keep this tile because the player does not need this tile 51 to complete any run.

As illustrated in FIG. 3B, at this point, the player has decided to bypass the award associated with the run 320 and placed the 9 dot tile 19 in the tile application area 322 associated with run 320. This tile does not properly complete the run 320 and the gaming system does not provide the MINI award associated with the run 320 to the player. However, since all of the runs are now deemed completed (even though run 320 has been improperly completed and thus bypassed), the gaming system provides the award opportunity associated with the hand 300 to the player.

FIG. 3C illustrates that the gaming system indicates that the bonus wheel has been triggered because the runs and hand have been completed and the bonus wheel will be provided with lower award amounts because the run 320 was bypassed. Thus, in this example, bypassing the run 320 not only bypasses the award associated with the run 320 but also affects (lowers) the award amounts associated with the bonus wheel that is triggered from completing the hand 300. In other embodiments, the bypass of a run does not affect the award amounts associated with the bonus wheel or other award or award opportunity associated with the hand 300.

FIG. 3D illustrates another alternative embodiment in which the player can bypass more than one of the runs. As shown in FIG. 3D, the player has properly completed and thus not bypassed runs 340 and 350. As shown in FIG. 3D, the player has improperly completed and thus bypassed runs 310, 320, and 330. The gaming system has provided the Major progressive award associated with the completion of runs 340 and 350, but has not provided the player the awards associated with the completions of runs 310, 320, and 330. Since all of the runs are now deemed completed (even though certain run have been improperly completed and thus bypassed), the gaming system provides the award opportunity associated with the hand (which is the spin of the bonus wheel in this example).

FIG. 3E illustrates that the gaming system indicates that the bonus wheel has been triggered because the runs and hand have been completed and the bonus wheel will be provided with lowest award amounts because runs 310, 320, and 330 were bypassed. Thus, in this example, bypassing the runs 310, 320, and 330 not only bypasses the awards associated with the runs 310, 320, and 330, but also affects (lowers) the award amounts associated with the bonus wheel that is triggered from completing the hand 300.

In various embodiments, the gaming system enables the player to bypass all of the runs to complete the hand. In various embodiments, the gaming system only enables the player to bypass one of the runs to complete the hand. In various embodiments, the gaming system only enables the player to bypass one or more of the runs to complete the hand.

It should be appreciated from the above that various embodiments of the present disclosure provide a gaming system configured to display: an indication of a hand; different runs of the hand, and for each run, a tile application area associated with that run and an indication of the tiles required to complete the run; a tile accumulation area; symbol display elements; activations of the symbol display elements; tiles associated with the activations of the symbol display elements; for each of the displayed tiles, of an indication of whether the tile is accumulated in the tile accumulation area or the tile is discarded; for the displayed tiles in the tile accumulation area, of placements of the tiles into the tile application areas associated with the runs; for each of a plurality of the runs, an indication of a proper completion of the run based on the tiles placed in the tile application area associated with the run; for one of the runs, an indication of an improper completion of the run based on the tiles placed in the tile application area associated with the run; and of an indication of a completion of the hand after all of the indications of the completions of all of the runs. In various such embodiments, the tiles are mahjong tiles. In various such embodiments, the gaming system is configured to display, for each run, of an indication of an award associated with that run. In various such embodiments, the gaming system is configured to display, for each run that is properly completed, of an indication that the award associated with that run is unlocked. In various such embodiments, the gaming system is configured to display, for each run that is properly completed, of an indication that the award associated with that run is provided to the player. In various such embodiments, the gaming system is configured to display, for the run that is improperly completed, of an indication that the award associated with that run is not unlocked. In various such embodiments, the gaming system is configured to display, for the run that is improperly completed, of an indication that the award associated with that run is not provided to the player. In various such embodiments, the gaming system is configured to display an indication of a reduced award associated with the hand based on the improper completion of the run. In various such embodiments, the gaming system is configured to display an indication of an award associated with the hand regardless of the improper completion of the run.

It should be appreciated from the above that various embodiments of the present disclosure provide a gaming system configured to display: an indication of a hand comprising different runs, and for each run an indication of any tiles required to complete the run; symbol display elements; activations of the symbol display elements; tiles associated with the activations of the symbol display elements; for each of the displayed tiles, of an indication of whether the tile is accumulated or the tile is discarded; for the accumulated tiles, of placements of the tiles in association with the runs; for one or more of the runs, an indication of a completion of the run based on the tiles associated with the run; for one or more of the runs, an indication of a bypass of the run; and an indication of a completion of the hand after all of the indications of the completions and/or bypasses of all of the runs. In various such embodiments, the tiles are mahjong tiles. In various such embodiments, the gaming system is configured to display, for each completed run, of an indication of an award associated with that run, and for each bypassed run, an indication of no award provided based on the bypass of that run. In various such embodiments, the gaming system is configured to display, for each completed run, of an indication of an unlocked award associated with that run, and for each bypassed run, an indication of no unlocked award provided based on the bypass of that run. In various such embodiments, the gaming system is configured to display an indication of a reduced award associated with the hand based on the bypassed run.

It should be appreciated from the above that various embodiments of the present disclosure provide a gaming system configured to display: an indication of a hand comprising different runs, and for each run an indication of any tiles required to complete the run; symbol display elements; sequentially each of a plurality of different tiles; for each of the displayed tiles, of an indication of whether the tile is accumulated or the tile is discarded, wherein a limited quantity of tiles can be accumulated at any one time; for the accumulated tiles, of placements of the tiles in association with the runs, wherein for each placement of a tile in association with one of the runs, the quantity of accumulated tiles is reduced; and for each of the runs, either an indication of a completion of the run based on the tiles associated with the run and the required tiles for the run, or an indication of a bypass of the run based on the tiles associated with the run and the required tiles for the run; and an indication of a completion of the hand after all of the indications of the completions and/or bypasses of all of the runs. In various such embodiments, the tiles are mahjong tiles. In various such embodiments, the gaming system is configured to display, for each completed run, of an indication of an award associated with that run, and for each bypassed run, an indication of no award provided based on the bypass of that run. In various such embodiments, the gaming system is configured to display, for each completed run, of an indication of an unlocked award associated with that run, and for each bypassed run, an indication of no unlocked award provided based on the bypass of that run. In various such embodiments, the gaming system is configured to display an indication of a reduced award associated with the hand based on one or more of the bypassed run. In various such embodiments, the gaming system is configured to display an indication of a reduced award associated with the hand based all of the runs being bypassed.

### Third Set of Example Embodiments

In various embodiments, the gaming system enables the player to select one or more of: (1) the hand; (2) the quantity of runs in the hand; (3) one or more of the runs in the hand (including the quantity of tiles in one or more of the runs); (4) the award for a hand (that results in the gaming system selecting the one or more runs for the hand based on these selected award(s)); (5) one or more awards for a hand (that results in the gaming system selecting the hand that is associated with the selected award(s)); and/or (6) one or more awards for one or more runs (that results in the gaming system selecting one or more runs that are associated with those selected award(s)). Examples of certain of these embodiments are discussed herein.

More specifically, in various embodiments, the gaming system enables the player to select the hand from a plurality of different hands. In various such embodiments, each of the different hands have a same award associated with that hand. In various such embodiments, two or more or each of the different hands have different awards associated with those hands. In various such embodiments, each of the different hands have a same type of award associated with that hand. In various such embodiments, two or more or each of the different hands have different types of awards associated with those hands. In various such embodiments, the harder the hand is to achieve (such a via more runs and/or more difficult runs to achieve), the higher the award associated with that hand, the higher the average expected value of that hand is, and/or the more award opportunities are associated with that hand. In various embodiments, the higher the award associated with the hand is, the higher the quantity of runs are part of that hand that need to be completed. In various embodiments, the higher the award associated with the hand is, the harder one or more of the runs are to complete that are part of that hand.

In various embodiments, the gaming system enables the player to select the quantity of runs of a hand from a plurality of different quantities of runs of the hands. In various such embodiments, the more runs that are needed to complete the hand, the higher the award associated with that hand, the higher the average expected value of that hand is, and/or the more award opportunities are associated with that hand. For example, the awards associated with the hand can be higher if the player chooses 5 runs for a hand over 4 runs for a hand.

In various embodiments, the gaming system enables the player to select one or more of the runs of a hand from a plurality of different runs for the hands. In various such embodiments, the harder the selected runs are to complete, the higher the award associated with that run, the higher the average expected value of that run is, and/or the more award opportunities are associated with that run. For example, the award associated with a run of a hand can be higher if the player chooses a 5 tile run over a 3 tile run.

In various embodiments, the gaming system enables the player to select the award associated with the hand from a plurality of different awards. In various such embodiments, based on the player selected award for the hand, the gaming system selects the runs for the hand at least in part based on the amount of the award or expected average value of the award.

In various embodiments, the gaming system enables the player to select the award(s) associated with each of one or more of the runs of a hand from a plurality of different awards. In various such embodiments, based on the player selected award for each run, the gaming system selects the quantity of tiles needed to complete that run at least in part based on the amount of the award or expected average value of the award.

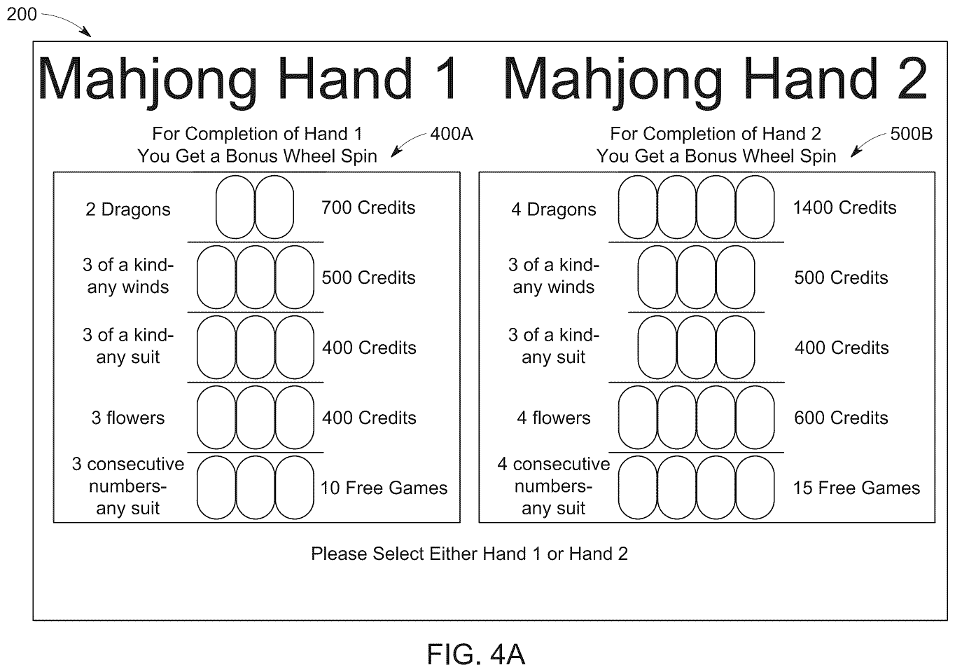

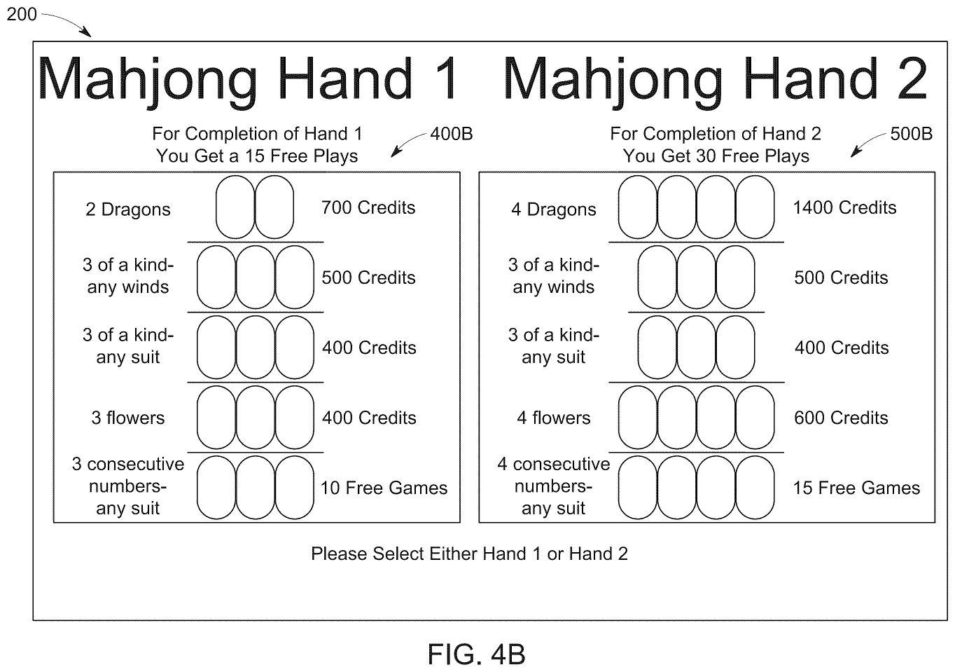

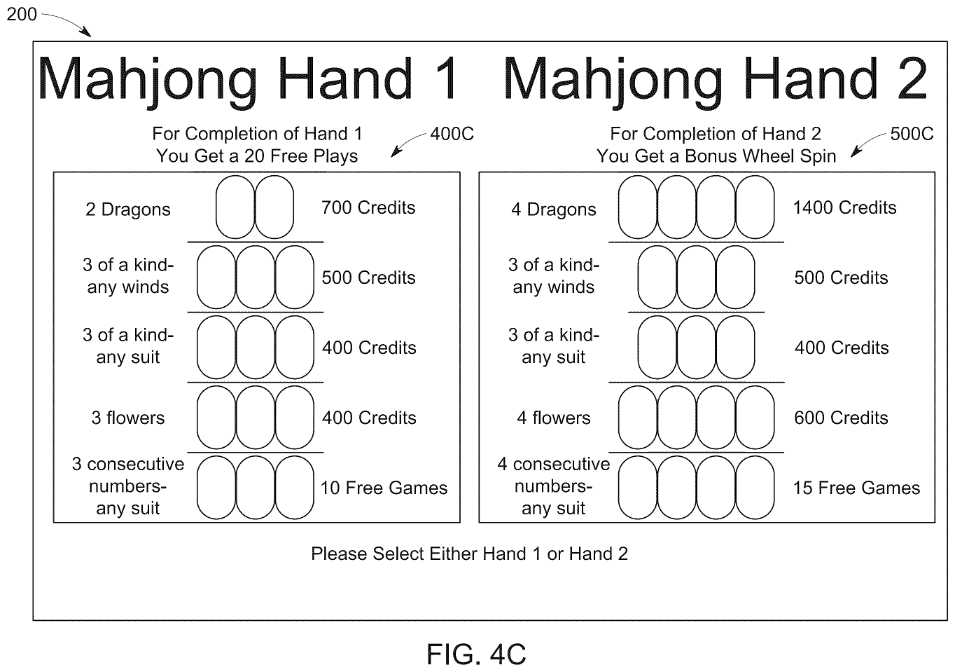

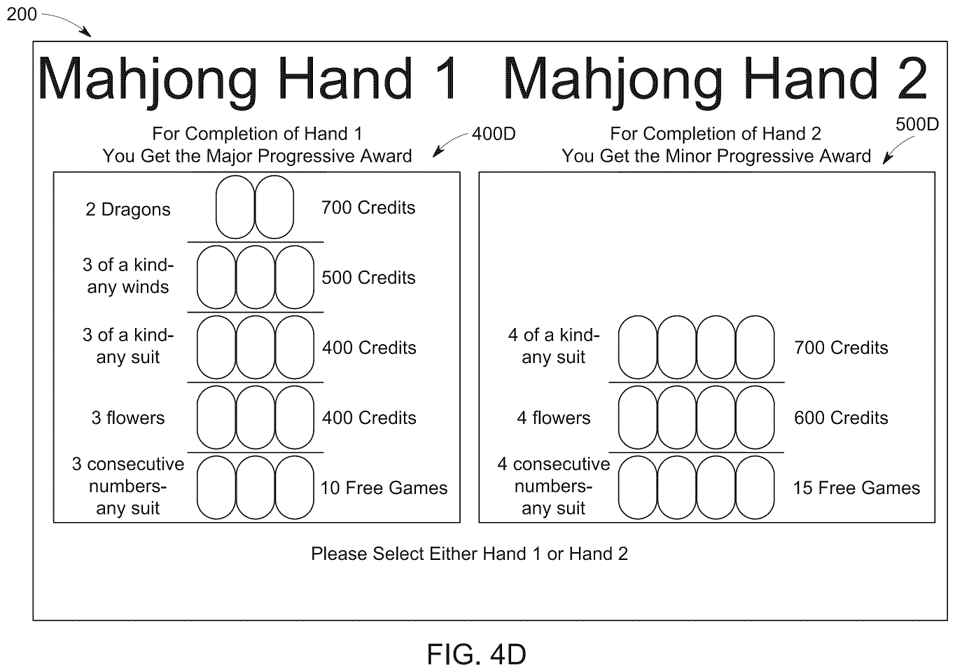

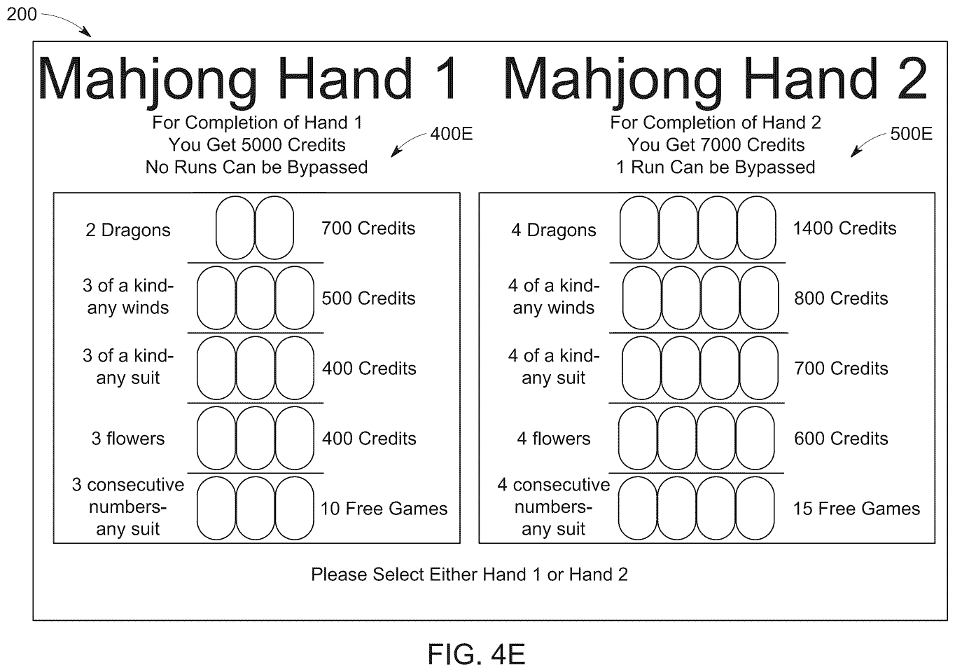

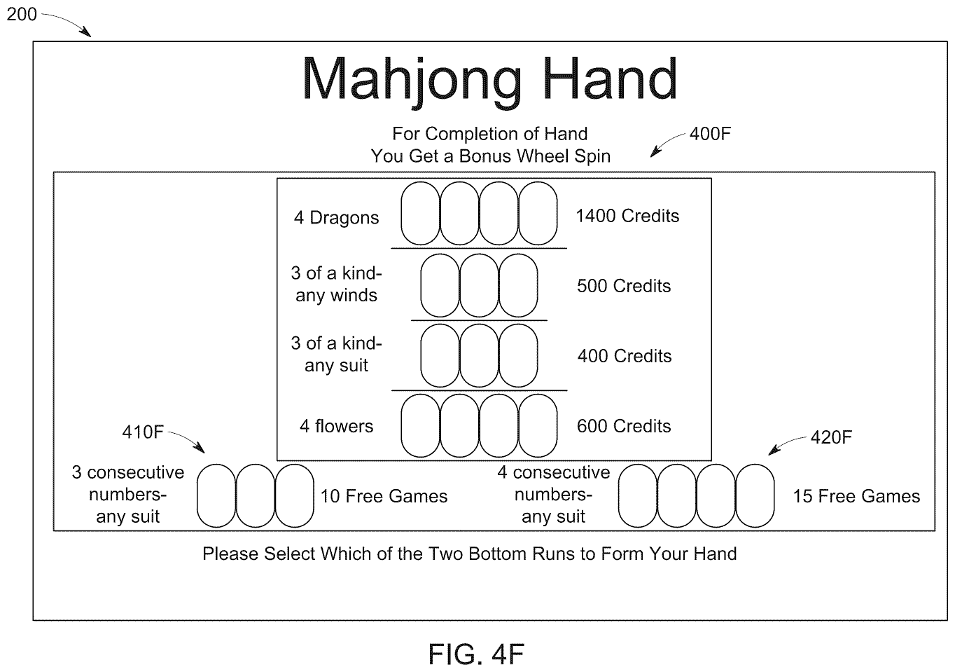

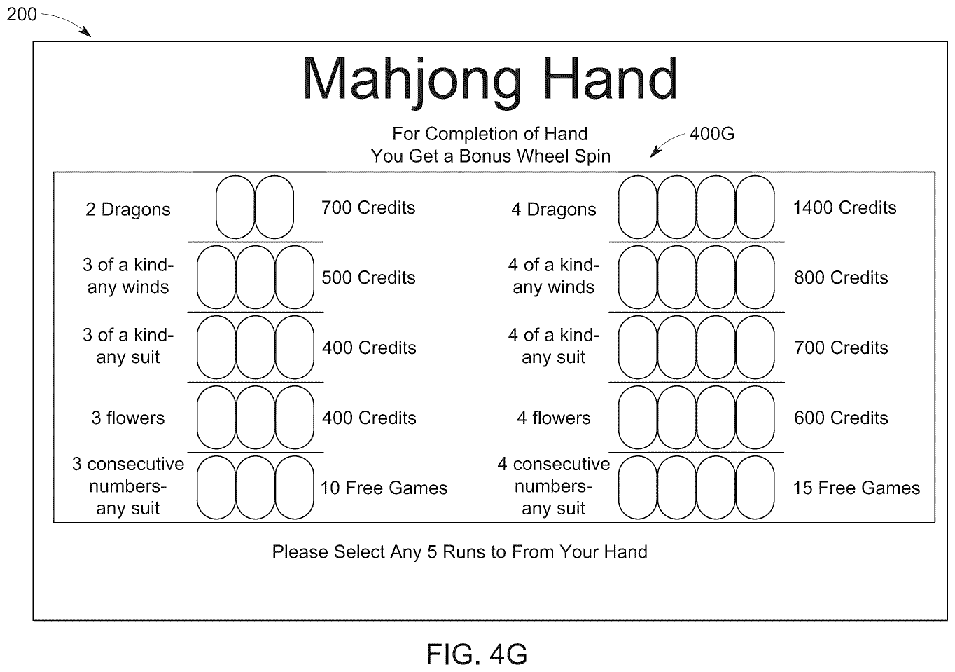

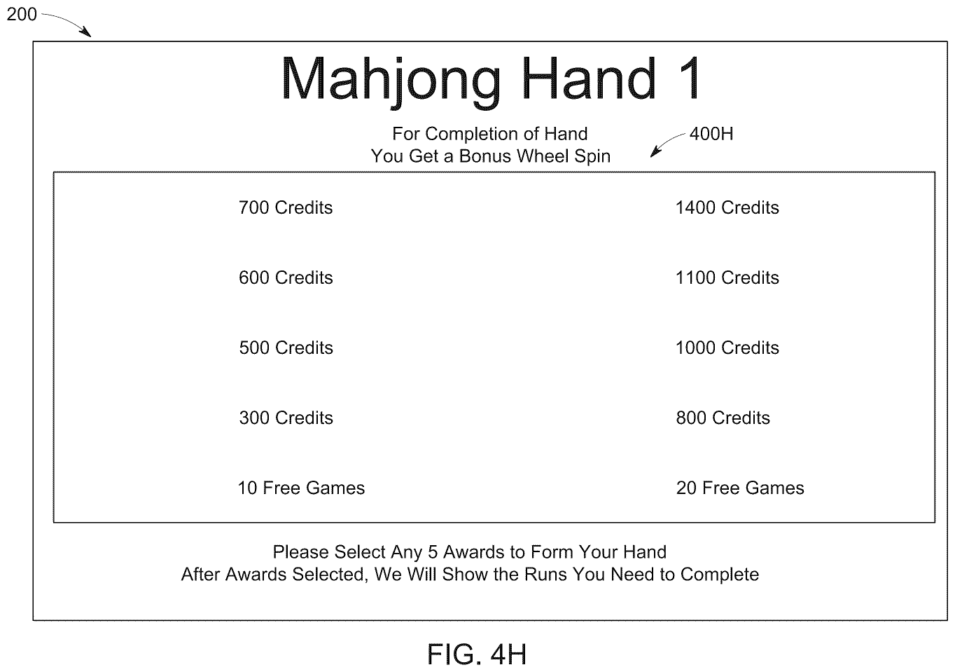

FIG. 4A partly illustrates an example hand selection sequence that the gaming system provides before the player begins the tile accumulation sequences and tile use sequences in accordance with one example embodiment of the present disclosure. In this example embodiment, the gaming system causes the display device 200 to display two example different hands 400A and 500A. In this example embodiment, hands 400A and 500A are associated with the same award that is a bonus wheel spin. In this example embodiment, hand 400A includes five runs (not labeled) with respective associated awards and hand 500A includes five runs (not labeled) with respective associated awards. In this example embodiment, the quantities of runs in each hand is the same. In this example embodiment, certain of the runs are the same, certain of the runs have the same required quantities of tiles, and certain of the runs have the same respective associated awards. In this example embodiment, certain of the runs are different, certain of the runs have different required quantities of tiles, and certain of the runs have different respective awards. In this example embodiment, certain higher awards are associated with harder runs to obtain (because such runs have higher quantities of required tiles to complete). In this example embodiment, the gaming system enables the player to select which hand they would like to try to complete (which includes the different runs and different available awards) and then employs that selected hand.

FIG. 4B partly illustrates another example hand selection sequence that the gaming system provides before the player begins the tile accumulation sequences and tile use sequences in accordance with one example embodiment of the present disclosure. In this example embodiment, the gaming system causes the display device 200 to display two example different hands 400B and 500B. In this example embodiment, hands 400B and 500B are associated with different awards (of the same type) that are different quantities of free plays of a game. In this example embodiment, hand 400B includes five runs (not labeled) with respective associated awards and hand 500B includes five runs (not labeled) with respective associated awards. In this example embodiment, the quantities of runs in each hand is the same. In this example embodiment, certain of the runs are the same, certain of the runs have the same required quantities of tiles, and certain of the runs have the same respective associated awards. In this example embodiment, certain of the runs are different, certain of the runs have different required quantities of tiles, and certain of the runs have different respective awards. In this example embodiment, certain higher awards are associated with harder runs to obtain (because such runs have higher quantities of required tiles to complete). In this example embodiment, the gaming system enables the player to select which hand they would like to try to complete (which includes the different runs and different available awards) and then employs that selected hand.

FIG. 4C partly illustrates another example hand selection sequence that the gaming system provides before the player begins the tile accumulation sequences and tile use sequences in accordance with one example embodiment of the present disclosure. In this example embodiment, the gaming system causes the display device 200 to display two example different hands 400C and 500C. In this example embodiment, hands 400C and 500C are associated with different awards that are also of different types (that are a quantity of free plays of a game and a bonus wheel spin). In this example embodiment, hand 400C includes five runs (not labeled) with respective associated awards and hand 500C includes five runs (not labeled) with respective associated awards. In this example embodiment, the quantities of runs in each hand is the same. In this example embodiment, certain of the runs are the same, certain of the runs have the same required quantities of tiles, and certain of the runs have the same respective associated awards. In this example embodiment, certain of the runs are different, certain of the runs have different required quantities of tiles, and certain of the runs have different respective awards. In this example embodiment, certain higher awards are associated with harder runs to obtain (because such runs have higher quantities of required tiles to complete). In this example embodiment, the gaming system enables the player to select which hand they would like to try to complete (which includes the different runs and different available awards) and then employs that selected hand.

FIG. 4D partly illustrates another example hand selection sequence that the gaming system provides before the player begins the tile accumulation sequences and tile use sequences in accordance with one example embodiment of the present disclosure. In this example embodiment, the gaming system causes the display device 200 to display two example different hands 400D and 500D. In this example embodiment, hands 400D and 500D are associated with different awards that are of the same type but different amounts. In this example embodiment, hand 400D includes five runs (not labeled) with respective associated awards and hand 500D includes three runs (not labeled) with respective associated awards. In this example embodiment, the quantities of runs in each hand is different. In this example embodiment, none of the runs are the same, none of the runs have the same required quantities of tiles, and none of the runs have the same respective associated awards. Thus, in this example embodiment, the runs are different, the runs have different required quantities of tiles, and the runs have different respective awards. In this example embodiment, certain higher awards are associated with harder runs to obtain (because such runs have higher quantities of required tiles to complete). In this example embodiment, the gaming system enables the player to select which hand they would like to try to complete (which includes the different runs and different available awards) and then employs that selected hand.

FIG. 4E partly illustrates another example hand selection sequence that the gaming system provides before the player begins the tile accumulation sequences and tile use sequences in accordance with one example embodiment of the present disclosure. In this example embodiment, hands 400E and 500E are associated with the same type of awards that are a quantity of credits. In this example embodiment, hand 400E includes five runs (not labeled) with respective associated awards and hand 500E includes five runs (not labeled) with respective associated awards. In this example embodiment, the quantities of runs in each hand is the same. In this example embodiment, the runs are different, the runs have different required quantities of tiles, and the runs have different respective awards. In this example embodiment, certain higher awards are associated with harder runs to obtain (because such runs have higher quantities of required tiles to complete). In this example embodiment, the gaming system enables the player to bypass different quantities of runs (e.g., zero for hand 400E and 1 run for hand 500E). In this example embodiment, the gaming system enables the player to select which hand they would like to try to complete (which includes the different runs and different available awards) and then employs that selected hand.

FIG. 4F partly illustrates an example run selection sequence that the gaming system provides before the player begins the tile accumulation sequences and tile use sequences in accordance with one example embodiment of the present disclosure. In this example embodiment, hand 400F is associated with a bonus wheel spin award. In this example embodiment, hand 400E includes four base runs (not labeled) with respective associated awards and a fifth run that is selectable by the player from two different example runs 410F and 510F. In this example embodiment, the runs 410F and 510F are different, the runs 410F and 510F have different required quantities of tiles, and the runs 410F and 510F have different respective awards. In this example embodiment, a higher award is associated with selectable harder run to obtain (because such run has a higher quantity of required tiles to complete). In this example embodiment, the gaming system enables the player to select one of the runs for the hand they would like to try to complete (which includes all of the different runs and different available awards) and then employs the hand with that selected run.

FIG. 4G partly illustrates an example run selection sequence that the gaming system provides before the player begins the tile accumulation sequences and tile use sequences in accordance with one example embodiment of the present disclosure. In this example embodiment, hand 400G is associated with a bonus wheel spin award. In this example embodiment, hand 400G includes 10 possible different runs (not labeled) with respective associated awards, and five of the runs are selectable by the player from different runs. In this example embodiment, the runs are all different, the runs have different required quantities of tiles, and the runs have different respective awards. In this example embodiment, higher awards are associated with selectable harder runs to obtain (because such runs have a higher quantity of required tiles to complete). In this example embodiment, the gaming system enables the player to select five of the runs for the hand they would like to try to complete (which includes the five selected different runs and different available awards) and then employs the hand with the selected runs.

FIG. 4H partly illustrates an example award selection sequence that the gaming system provides before the player begins the tile accumulation sequences and tile use sequences in accordance with one example embodiment of the present disclosure. In this example embodiment, hand 400H is associated with a bonus wheel spin award. In this example embodiment, hand 400H includes 10 possible different awards, and five of the awards are selectable by the player from different awards. In this example embodiment, the awards are all different and have different associated runs that are not displayed to the player in this example embodiment. In this example embodiment, higher awards are associated with selectable harder runs to obtain (because such runs have a higher quantity of required tiles to complete). In this example embodiment, the gaming system enables the player to select five of the awards for the hand they would like to try to complete (which includes the five selected different awards). After the player selects the awards, the gaming system determines the runs for the hand based on the player selected awards, and then employs that hand.

It should be appreciated from the above that various embodiments of the present disclosure provide a gaming system configured to display: indications of two different hands, and indications of runs of each of the two different hands, wherein for each of the two hands, one of the runs in that hand is not in the other of the two hands; an indication of a selection of one of the different hands, and indications of the runs of that selected hand; for each said runs of the selected hand, of an indication of tiles required to complete the run; activations of symbol display elements; tiles associated with the activations of the symbol display elements; for each of the displayed tiles, of an indication of whether the tile is accumulated or the tile is discarded; for the accumulated tiles, of placements of the tiles in association with the runs of the selected hand; for each of the runs of the selected hand, an indication of a completion of the run based on the tiles associated with the run and that are required to complete the run; and an indication of a completion of the selected hand after all of the indications of the completions of all of the runs of the selected hand. In various such embodiments, the tiles are mahjong tiles. In various such embodiments, for each of the two hands, a plurality of the runs in that hand are not in the other of the two hands. In various such embodiments, for each of the two hands, all of the runs in that hand are not in the other of the two hands. In various such embodiments, the gaming system is configured to display, for each run in each of the two hands, of an indication of an award associated with that run. In various such embodiments, the gaming system is configured to display, for each of the two hands, an indication of an award associated with that hand. In various such embodiments, the gaming system is configured to display, for each of the two hands, an indication of a same award associated with that hand. In various such embodiments, the gaming system is configured to display the indications of whether the tiles are accumulated or the tiles are discarded based on received player inputs. In various such embodiments, the gaming system is configured to display the indications of the accumulated tiles placed associated with the runs based on received player inputs.

It should be appreciated from the above that various embodiments of the present disclosure provide a gaming system configured to display: indications of two different runs for a hand; an indication of a selection of one of the different runs; an indication of a hand, the hand including a plurality of runs comprising the selected run; for each said run of the hand, of an indication of tiles required to complete the run; activations of symbol display elements; tiles associated with the activations of the symbol display elements; for each of the displayed tiles, of an indication of whether the tile is accumulated or the tile is discarded; for the accumulated tiles, of placements of the tiles in association with the runs of the hand; for each of the runs of the hand, an indication of a completion of the run based on the tiles associated with the run and that are required to complete the run; and an indication of a completion of the hand after all of the indications of the completions of all of the runs of the hand. In various such embodiments, the tiles are mahjong tiles. In various such embodiments, the gaming system is configured to display, for each of the two different run, of an indication of an award associated with that run. In various such embodiments, the gaming system is configured to display, for each of the two different runs, an indication of different awards associated with those runs. In various such embodiments, the gaming system is configured to display an indication of a same award associated with that hand regardless of which of the two runs is selected to be part of that hand.

It should be appreciated from the above that various embodiments of the present disclosure provide a gaming system configured to display: indications of a first quantity of different possible runs for a hand, the first quantity being more than three; an indication of a selection of a second quantity of the different possible runs, the second quantity being more than one and less than the first quantity; an indication of a hand, the hand including the selected second quantity of runs; for each said runs of the hand, of an indication of tiles required to complete the run; activations of symbol display elements; tiles associated with the activations of the symbol display elements; for each of the displayed tiles, of an indication of whether the tile is accumulated or the tile is discarded; for the accumulated tiles, of placements of the tiles in association with the runs of the hand; for each of the runs of the hand, an indication of a completion of the run based on the tiles associated with the run and the tiles required to complete the run; and an indication of a completion of the hand after all of the indications of the completions of all of the runs of the hand. In various such embodiments, the tiles are mahjong tiles. In various such embodiments, the second quantity of runs is predetermined. In various such embodiments, all of the possible runs are different and have different associated awards. In various such embodiments, the gaming system is configured to display an award associated with the hand, wherein the award is based on the selected runs for the hand. In various such embodiments, the gaming system is configured to display an award associated with the hand, wherein the award is based on the second quantity of selected runs for the hand.

### Fourth Set of Example Embodiments

In various embodiments, the gaming systems and methods employ dice type tiles instead of mahjong tiles. The dice type tiles are referred to herein as dice tiles. In various such embodiments, the gaming system provides different dice tiles and enables the player to accumulate a plurality of dice tiles such as described in any of the embodiments described above. In various embodiments, the accumulated dice tiles are used by the player to apply to runs of dice tiles to complete the hand including those runs.

In various embodiments, the values of the accumulated dice tiles are used as the symbols of these dice tiles that is somewhat different than the above described embodiments in part because each of the accumulated dice tiles can be potentially used in more than one or in each of the hands.

In various embodiments, all of the dice tiles are of a same type of dice (such as but not limited to six-sided dice each with the numbers 1, 2, 3, 4, 5, and 6 on the respective six sides represented by respective sets of dots). Other example dice tiles are twelve-sided dice each with the numbers 1, 2, 3, 4, 5, 6, 7, 8, 9, 10, 11, and 12 on the respective twelve sides represented by respective numerals. Other example dice tiles are twenty-sided dice each with the numbers 1, 2, 3, 4, 5, 6, 7, 8, 9, 10, 11, 12, 13, 14, 15, 16, 17, 18, 19, and 20 on the respective twenty sides represented by respective numerals. In various embodiments, at any point in time, each of the dice tiles has an indicated number from the different numbers of that tile.

In various embodiments, two or more of the dice tiles are of different types of dice (such as but not limited to six-sided dice, twelve-sided dice, and twenty-sided dice).

The present disclosure contemplates any suitable runs that each requires one or more of the dice tiles can be employed in accordance with the present disclosure. In various embodiments, the gaming system can employ any of the following example runs: (1) a run with a specific number (such as 15) regardless of the quantity of dice tiles employed to form that run; (2) a run with a specific number (such as 15) that includes a predetermined specific quantity of dice tiles employed to form that run; (3) a run with a specific number (such as 12) that includes one dice tile of a specific number (such as 6) and any additional quantity of dice tiles employed to form that run; (4) a run with a specific number (such as 15) that includes a predetermined specific quantity of dice tiles with specific numbers that are employed to form that run (such as 6, 6, and 3); (5) a run with a specific quantity of dice tiles each with a specific same number (such as 3 dice tiles each with the number 1 or with the number 5); (6) a run with a specific quantity of dice tiles with a specific different number (such as 3, 4, and 5); (7) a run based on one or more characteristics of the tile such as but not limited to a color (such as red, green, or blue), a size (such as small, medium, or large), or a picture (such as a clover or pot of gold).

In various embodiments, the dice tile related embodiments are different than the mahjong related embodiments in part because the runs can be completed with different quantities of accumulated dice tiles—as opposed to the static quantities of mahjong tiles as described above. For example, if a run requires a sum of 15, the run can be completed by any of the following example groups of dice tiles that all have the same quantity of dice tiles: (1) a 5 dot dice tile, a 5 dot dice tile, and a 5 dot dice tile; (2) a 6 dot dice tile, a 5 dot dice tile, and a 4 dot dice tile; and (3) a 6 dot dice tile, a 6 dot dice tile, and a 3 dot dice tile. In this same example, for the run that requires a sum of 15, the run can be completed by any of the following example groups of dice tiles that have different quantities of dice tiles: (1) five 3 dot dice tiles; (2) fifteen 1 dot dice tiles; (3) seven two 2 dot dice tiles, and a 1 dot dice tile; and (4) three 4 dot dice tiles and one 3 dot dice tiles. These example groups are not exclusive or meant to limit the group of dice tiles that can satisfy a run. Thus, certain of the dice embodiments are different than the mahjong embodiments described above at least in this manner.

In various embodiments, the dice tile related embodiments follow the example mahjong tile embodiments where the player is playing a game that causes tile generation events. In response to those tile generation events, the gaming system provides tiles in the form of dice tiles to the player and enables the player to accumulate such dice tiles. The gaming system enables the player to apply the accumulated dice tiles to the runs of the hand such as in the manners described above.

In various embodiments, after each dice tile is accumulated, it is static and does not change.

In various embodiments, after each dice tile is accumulated, it is changeable and thus can change.

In various embodiments, after one or more of the dice tiles is/are accumulated, it is static and does not change; and after one or more of the dice tiles is/are accumulated, it is changeable and thus can change.

In various embodiments, the gaming system can enable the player to cause one or more of the accumulated dice tiles to change. In various embodiments, the gaming system can change one or more of the accumulated dice tiles by causing that dice tile to rotate, spin, or roll and then stop on one of the sides of that dice tile (such as a randomly determined side). The side may be the same as the original side or may be a different side.

In various embodiments, the gaming system can change one or more of the accumulated dice tiles based on an occurrence of a tile change condition. In various embodiments, the tile change condition can be any suitable condition such as but not limited to: (1) a randomly determined condition; (2) an event in a game or other suitable event; (2) a predetermined quantity of game plays; (4) a predetermined time period; (5) a change (such as a lowering) of wager amount level or denomination; and/or (6) a gaming system event (such as progressive controller triggering an event). For this last example, a progressive controller can be configured for a bank of electronic gaming machines and when the progressive increments past a multiple of $5.00, it triggers an event that causes the gaming system to have the tile change event or tile removal event (or any of the other events disclosed herein).

In various embodiments, the gaming system can change one or more of the accumulated dice tiles by cause that dice tile to rotate, spin, or roll and then stop on a side of that dice tile (such as a randomly determined side).

In various embodiments, the gaming system can discard one or more accumulated dice tiles based on an occurrence of a tile discard condition. In various embodiments, the tile discard condition can be any suitable condition such a but not limited to: (1) a randomly determined condition; (2) an event in a game or other suitable event; (2) a predetermined quantity of game plays; (4) a predetermined time period; and/or (5) a change (such as a lowering) of wager amount level or denomination.

In various embodiments, one or more of the dice tiles have a characteristic that is in addition to the number, such as but not limited to a color or style. For example, one or more of the dots of the dice tile can be a color such as red—and one or more of such red dots can be required for one or more runs of a hand. In another example, instead of dots, one or more of the dice can have stars, and one or more of such stars can be required for one or mor of the runs of a hand.

In various embodiments, the gaming system enables the player to complete the runs of the hand with the accumulated dice tiles in any order.

In various embodiments, the gaming system enables the player to complete the runs of the hand with the accumulated dice tiles in a predetermined order. In various situations for such embodiments, this makes the completion of the last run or runs of a hand more difficult for the player based on the numerals of the last run(s) and the accumulated and/or previously applied dice tiles.

In various embodiments, the gaming system enables the player to complete the runs in an order regardless of the order that the dice tiles are accumulated. In various embodiments, the gaming system enables the player to complete the runs based partly on an order that the dice tiles are accumulated. In various embodiments, the gaming system enables the player to complete the runs based partly on combinations of orders that the dice tiles are accumulated.

In various embodiments, the gaming system can discard one or more accumulated dice tiles based on the accumulated dice tiles and the runs. For example, if the player accumulates dice tiles 6, 5, and 4 in that order, and a run requires dice tile in the order 4, 5, 6, the gaming system can discard these accumulated dice tiles.

In various embodiments, the gaming system can employ automatic rules to accumulate and/or apply the accumulated dice tiles to minimize the player required actions during the plays of the game. These embodiments simplify and can speed up the game play. For example, in various embodiments, the gaming system can automatically apply accumulated dice tiles that satisfy a run of the hand to that run to save the player time and speed up game play. For example, if a run has the value 15 and the player accumulates dice tiles having the numeral 6, then 5, and then 4, since these dice tiles equal 15, the gaming system can automatically apply these three dice tiles to the run of the hand to complete that run and to provide the award associated with that run. In various embodiments where the gaming system makes automatic decisions, if a generated dice tile or an accumulated dice tile cannot be used to satisfy any run or remaining run of a hand, the gaming system can automatically discard that dice tile. For example, if a remaining run of a hand requires three 2 dot dice tiles, and a generated or accumulated die tile is a 6 dot die tile, the gaming system can automatically discard that 6 dot dice tile. It should thus be appreciated that the present disclosure contemplates that the gaming system can employ any suitable automatic rules for handling the dice tiles.

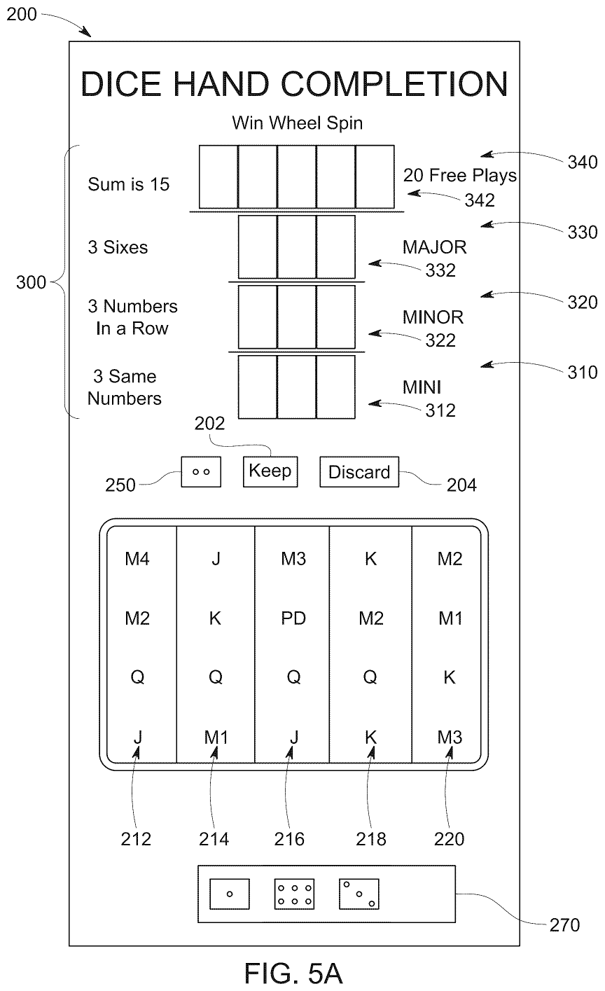

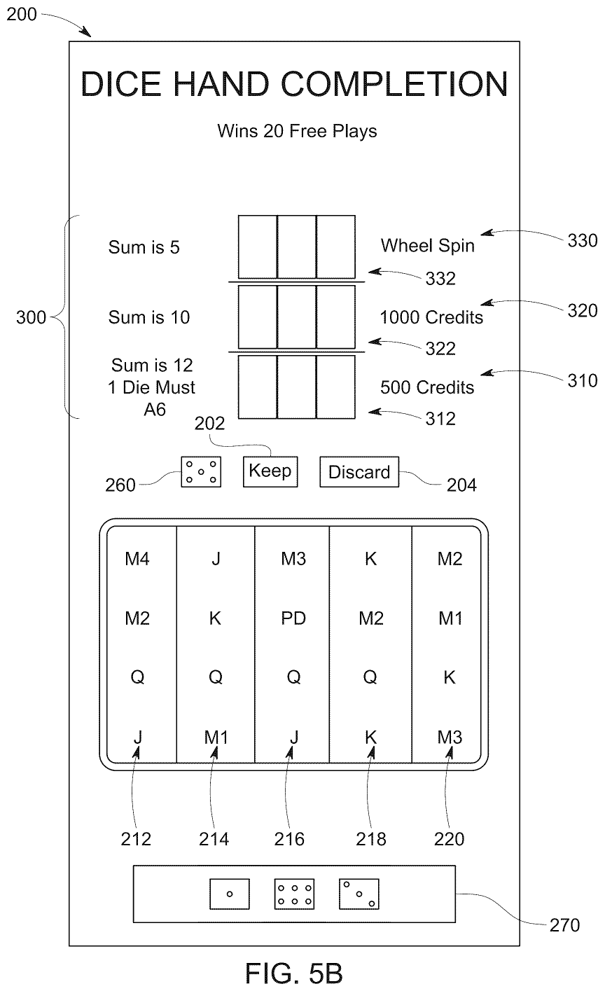

FIG. 5A illustrates a part of a play of a primary game, wherein the tiles that can be determined and displayed are different dice tiles. The determined and displayed dice tiles can be accumulated by the player in accumulation sequences, and the accumulated dice tiles can be employed by the player in use sequences. In this example embodiment, the display device 200 of the gaming system displays plays of a primary wagering game including five reels 212, 214, 216, 218, and 220 and a plurality of different symbols (not labeled) on each reel 212, 214, 216, 218, and 220. It should also be appreciated that any suitable quantity of reels and any suitable symbols can be employed in accordance with the present disclosure. It should be appreciated that any suitable other primary games (such as but not limited to other reels games, card games, keno games, or bingo games) can be employed in accordance with the present disclosure.

As shown in FIG. 5A, the gaming system causes the display device 200 to display: (1) a determined hand 300 that includes a plurality of different determined runs including in this example different runs 310, 320, 330, and 340 and indications of each such run; (2) tile application areas 312, 322, 332, and 342 respectively associated with and for each of the respective runs 310, 320, 330, and 340; (3) indications of different determined awards (not labeled) respectively associated with the runs 310, 320, 330, and 340; and (4) an indication of a determined award (not labeled) associated with the hand 300. In this example embodiment, the hand 300, the runs 310, 320, 330, and 340, and the associated awards are all determined by the gaming system prior to beginning the sequences. In other embodiments such as discussed herein, one or more of the hand 300, the runs 310, 320, 330, and 340, and the associated awards are selected by the player prior to beginning the sequences. In such embodiments, the gaming system enables the player to select such features from a plurality of different features such as different hands (with respective different runs and respective different awards). In other words, in various such embodiments, the gaming system enables the player to select the specific hand (and thus the associated runs of that hand) form a plurality of different hands that the player wants to accumulate dice tiles toward completing prior to accumulating dice tiles.

In this example: (a) the run 310 is 3 same numbers and is associated with the Mini progressive award; (b) the run 320 is 3 numbers in a row and is associated with the Minor progressive award; (c) the run 330 is 3 sixes and is associated with the Major progressive award; and (d) the run 340 is a sum of dice tiles that is 15 and is associated with 20 free plays. In this example, while the runs are individually associated with free games and different progressive awards, it should be appreciated that the runs can be associated with any suitable awards or award opportunities. In this example, all of the runs must be obtained for the gaming system to provide the player the wheel spin award that is associated with the hand 300. It should be appreciated that the hand 300 can be associated with any suitable award or award opportunity such as one or more plays of a secondary game.

In this example embodiment, when a run is completed the gaming system provides the player the award associated with the run that is completed. In various other embodiments, when a run is completed, the award associated with that completed run is unlocked for the player such that the player is now eligible to win that award from further plays of the primary wagering game.

FIG. 5A illustrates the reels 212, 214, 216, 218, and 220 stopped after the reels are spun, and the reels 212, 214, 216, 218, and 220 displaying randomly determined symbols (not labeled) at a plurality of symbol display positions (not labeled) for a play of the wagering game (after the player has made a wager for this play of the wagering game). The gaming system determines any awards based on those displayed symbols, and displays any determined awards. In this example, the gaming system determines the award of 1000 credits based on the occurrence of the four Q symbols. In this example, a tile generation event occurs for each play of the primary wagering game. As indicated above, the tile generation event can occur in various different manners in accordance with the present disclosure. In this example, for the tile generation event for this play of the primary wagering game, the gaming system determines and displays a dice tile 250 indicating the numeral 2, and asks the player whether the player wants to keep or discard this dice tile 250 (via the displayed Keep and Discard input buttons 202 and 204). In this example, since the dice accumulation area 270 is not full, the gaming system can automatically keep the dice tile and only provide such keep or discard decisions for the player when the tile accumulation area is full. In this example embodiment, the tile accumulation area 270 enables the player to accumulate four dice tiles. If there are four accumulated dice tiles in the tile accumulation area, the player must discard one of the four accumulated dice tiles to accumulate another dice tile in that tile accumulation area. Thus, the player is limited to having four accumulated dice tiles at any one point in time. As in the above described embodiments related to mahjong example embodiments, the gaming system enables the player to apply the dice tiles to the runs 310, 320, 330, and 340 to complete the hand.

FIG. 5B illustrates a part of a play of a primary game, wherein the dice tiles that can be determined and displayed are different dice tiles. The determined and displayed dice tiles can be accumulated by the player in accumulation sequences, and the accumulated dice tiles can be employed by the player in use sequences. In this example embodiment, the display device 200 of the gaming system displays plays of a primary wagering game including five reels 212, 214, 216, 218, and 220 and a plurality of different symbols (not labeled) on each reel 212, 214, 216, 218, and 220. It should also be appreciated that any suitable quantity of reels and any suitable symbols can be employed in accordance with the present disclosure. It should be appreciated that any suitable other primary games (such as but not limited to other reels games, card games, keno games, or bingo games) can be employed in accordance with the present disclosure.

As shown in FIG. 5B, the gaming system causes the display device 200 to display: (1) a determined hand 300 that includes a plurality of different determined runs including in this example different runs 310, 320, and 330 and indications of each such run; (2) tile application areas 312, 322, and 332, and respectively associated with and for each of the respective runs 310, 320, and 330, and 340; (3) indications of different determined awards (not labeled) respectively associated with the runs 310, 320, and 330; and (4) an indication of a determined award (not labeled) associated with the hand 300. In this example embodiment, the hand 300, the runs 310, 320, and 330, and the associated awards are all determined by the gaming system prior to beginning the sequences.

In this example: (a) the run 310 is dice tiles resulting a sum that is 12 where 1 die must be a 6 and is associated with a 500 credit award; (b) the run 320 is a sum of dice tiles that is 10 and is associated with a 1000 credit award; and (c) the run 330 that is a sum of 5 that is associated with a wheel spin. In this example embodiment, when a run is completed the gaming system provides the player the award associated with the run that is completed. In various other embodiments, when a run is completed, the award associated with that completed run is unlocked for the player such that the player is now eligible to win that award from further plays of the primary wagering game.

FIG. 5B illustrates the reels 212, 214, 216, 218, and 220 stopped after the reels are spun, and the reels 212, 214, 216, 218, and 220 displaying randomly determined symbols (not labeled) at a plurality of symbol display positions (not labeled) for a play of the wagering game (after the player has made a wager for this play of the wagering game). The gaming system determines any awards based on those displayed symbols, and displays any determined awards. In this example, the gaming system determines the award of 1000 credits based on the occurrence of the four Q symbols. In this example, a tile generation event occurs for each play of the primary wagering game. As indicated above, the tile generation event can occur in in various different manners in accordance with the present disclosure. In this example, for the tile generation event for this play of the primary wagering game, the gaming system determines and displays a dice tile 260 indicating the numeral 5, and asks the player whether the player wants to keep or discard this dice tile 260 (via the displayed Keep and Discard input buttons 202 and 204 (that are displayed by the display device 200 which is associated with a touch screen for receiving the player input). In this example, since the dice accumulation area 270 is not full, the gaming system can automatically keep the dice tile and only provide such keep or discard decisions for the player when the tile accumulation area is full. In this example embodiment, the tile accumulation area 270 enables the player to accumulate six dice tiles. If there are six accumulated dice tiles in the tile accumulation area, the player must discard one of the six accumulated dice to accumulate another dice tile in that tile accumulation area. Thus, the player is limited to having six accumulated dice tiles at any one point in time. As in the above described embodiments related to mahjong example embodiments, the gaming system enables the player to apply the dice tiles to the runs 310, 320, and 330 to complete the hand.

As indicated above, in various of these dice tile embodiments, responsive to certain dice tile change conditions, the gaming system can cause or can enable the player to cause one or more of the dice tiles to be changed (e.g., rotated, rolled, or spun) to change the dice tile in the tile accumulation area. This creates a different dynamic in terms of completing the runs because such changes can better enable the player to complete one or more of the runs or make it more difficult to complete one or more of the runs.

It should be appreciated from the above that the dice tile related embodiments provide different configurations for the hands, runs, and accumulation of such dice tiles. It should also be appreciated from the above, the gaming system enables a player to manage their accumulated dice tiles and when to apply their accumulated dice tiles after each tile generation event in view of the hand, the runs of the hand, and the various other applicable factors as described herein. It should be appreciated from the above that these player decisions can become much more complicated if the gaming system displays multiple different hands with different runs for each hand. In various such embodiments, if the player completes a hand, the completed hand can be replaced with a new hand.

It should be appreciated from the above that various embodiments of the present disclosure provide a gaming system configured to display: an indication of a hand; indications of different runs of the hand, and for each run, a tile application area associated with that run and an indication of dice tiles required to complete the run; a tile accumulation area; symbol display elements; activations of the symbol display elements; dice tiles associated with the activations of the symbol display elements, each dice tile have an indicated number of that dice tile; for each of the displayed dice tiles, of an indication of whether the dice tile is accumulated in the tile accumulation area or the dice tile is discarded; one the displayed dice tiles accumulated in the tile accumulation area, a change of the indicated number of that dice tile; for the displayed dice tiles in the tile accumulation area, of placements of the dice tiles into the tile application areas associated with the runs; for each of the runs, an indication of a completion of the run based on the dice tiles placed in the tile application area associated with the run and that are required to complete the run; and an indication of a completion of the hand after all of the indications of the completions of all of the runs. In various such embodiments, the gaming system is configured to display, for each run, of an indication of an award associated with that run. In various such embodiments, the gaming system is configured to display, for each run that is completed, of an indication that the award associated with that run is unlocked. In various such embodiments, the gaming system is configured to display, for each run that is completed, of an indication that the award associated with that run is provided to the player. In various such embodiments, the gaming system is configured to display an indication of an award associated with the hand. In various such embodiments, the gaming system is configured to display the indications of whether the dice tiles are accumulated and displayed in the tile accumulation area or the dice tiles are discarded based on received player inputs. In various such embodiments, the gaming system is configured to display the indications of the tiles in the tile accumulation area placed in the tile application areas associated with the runs based on received player inputs. In various such embodiments, one of the runs is based on an order of accumulation of the dice tiles. In various such embodiments, one of the runs can be completed using two different quantities of accumulated dice tiles.

It should be appreciated from the above that various embodiments of the present disclosure provide a gaming system configured to display: an indication of a hand comprising different runs, and for each run an indication of any dice tiles required to complete the run; symbol display elements; activations of the symbol display elements; sequentially dice tiles associated with the activations of the symbol display elements, each dice tile have an indicated number of that dice tile; for each of the displayed dice tiles, of an indication of whether the tile is accumulated or the tile is discarded; for the accumulated dice tiles, of placements of the tiles in association with the runs, where for one of the runs, the accumulated dice tiles can only be placed in association with that run if the order of accumulation of the dice tiles is the same as the order of the dice tiles for that run; for each of the runs, an indication of a completion of the run based on the dice tiles associated with the run and that are required to complete the run; and an indication of a completion of the hand after all of the indications of the completions of all of the runs. In various such embodiments, the gaming system is configured to display, for each run that is completed, of an indication of an award associated with that run is unlocked. In various such embodiments, the gaming system is configured to display, for each run that is completed, of an indication of an award associated with that run is provided to the player. In various such embodiments, the gaming system is configured to display the indications of whether the dice tiles are accumulated or the dice tiles are discarded based on received player inputs. In various such embodiments, the gaming system is configured to display the indications of the tiles associated with the runs based on received player inputs.

It should be appreciated from the above that various embodiments of the present disclosure provide a gaming system configured to display: an indication of a hand comprising different runs, and for each run an indication of any dice tiles required to complete the run, wherein for one of the runs, the run can be completed by different quantities of dice tiles; symbol display elements; sequentially each of a plurality of different dice tiles, each dice tile have an indicated number of that dice tile; for each of the displayed dice tiles, of an indication of whether the dice tile is accumulated or the dice tile is discarded, wherein a limited quantity of the dice tiles can be accumulated at any one time; for the accumulated dice tiles, of placements of the dice tiles in association with the runs, wherein for each placement of a dice tile in association with one of the runs, the quantity of accumulated dice tiles is reduced; for each of the runs, an indication of a completion of the run based on the dice tiles associated with the run and that are required to complete the run; and an indication of a completion of the hand after all of the indications of the completions of all of the runs. In various such embodiments, the gaming system is configured to display, for each run that is completed, of an indication of an award associated with that run is unlocked, and after all the runs are completed, of an of an award associated with the hand and provided to the player. In various such embodiments, the gaming system is configured to display, for each run that is completed, of an indication of an award associated with that run is provided to the player, and after all the runs are completed, of an award associated with the hand and provided to the player. In various such embodiments, the gaming system is configured to display indications of whether the dice tiles are accumulated or the dice tiles are discarded based on received player inputs. In various such embodiments, the gaming system is configured to display indications of the tiles associated with the runs based on received player inputs. In various such embodiments, two of the dice tiles have different quantities of the sides, and the different quantities of sides indicate different numbers.

### Various Additional and Alternative Example Embodiments

In various embodiments, the gaming system can determine to automatically complete one or more runs and/or a hand. In various such embodiments, the gaming system can make this determination randomly or in another suitable manner.

In various embodiments, the gaming system can determine to automatically partially complete one or more runs and/or a hand. In various such embodiments, the gaming system can make this determination randomly or in another suitable manner.

In various embodiments, the gaming system can determine to automatically partially complete one or more runs and/or a hand at the start of displaying the run or hand (such as partially pre-filling a run or hand). In various such embodiments, the gaming system can make this determination randomly or in another suitable manner.

In various embodiments, the gaming system enables the player to purchase one or more runs, and thus complete the run that functions toward completing the hand.

In various embodiments, the gaming system can determine to automatically change one or more runs and/or a hand. In various such embodiments, the gaming system can make this determination randomly or in another suitable manner. In various embodiments, the gaming system can suitably display these changes. In these various embodiments, these determination can be made before the sequences for a hand are started or after they are started, before a play of a game is started, after a designated award or type of award is won, after a certain award amount is provided, after a designated game event occurs, and/or after a designated period (such as a period of time or a period of plays).

In various embodiments, the gaming system can reset the hand, one or more of the runs of the hand, and/or one or more awards associated with the runs and/or the hand based on the occurrence of a reset condition. In various embodiments, the reset condition can be a quantity of plays, a period of time, or an event associated with the hand or a runs thereof (such as wining a highest award for a run). In various embodiments, the reset condition can be based on the accumulated tiles and whether any accumulated tiles can be applied to any runs. For example, if no accumulated titles can be applied to any of the runs or the remaining non-completed runs, the reset condition can occur. In various embodiments, responsive to the reset condition, the gaming system resets an award only after all of the other awards in the hand have been won. In various embodiments, the gaming system resets a single award when the award associated with that run is won by the player. In various embodiments, the award reset includes the gaming system shifting one or more of the awards associated with the runs. In various embodiments, the gaming system can shift the awards upwardly, downwardly, or in any suitable manner for one or more runs. In various embodiments, response to the reset condition, the gaming system changes one or more of the non-completed runs.

In various embodiments, the gaming system changes (such as eroding) over time one or more of the runs such that gaming system removes one or more runs or the awards associated with one or more runs.

In various embodiments, the gaming system can remove an award associated with a run and keep the run as part of the hand (that needs to be completed again to complete the hand).

In various embodiments, after a run of a hand is completed, if the hand is not yet completed within a certain period, the gaming system can reset the run and require the player to again complete the run to complete the hand.

In various embodiments where completing a run unlocks an award, the gaming system can require the player to complete the run more than one time to keep the award unlocked and available to be won in the plays of the game.

In various embodiments where completing a hand unlocks an award, the gaming system can require the player to complete the hand more than one time to keep the award unlocked and available to be won in the plays of the game.

In various embodiments, the gaming system accumulates the tiles in the tile accumulation area automatically following one or more rules. In various such embodiments, as tiles are generated from the game play or otherwise, the gaming system automatically enters the tiles in the tile accumulation area (such as from the left and any tiles are removed from the right). In various such embodiments, the gaming system can display the new tiles sliding in from the left and sliding out from the right. In various embodiments, the tiles slide in from the right and out of the left. In various embodiments, the way the tiles move is random, determined by the outcome of the game play, or in another suitable manner. In various embodiments, the tiles themselves or other game event outcome(s) determine(s) how the automatic tile accumulation occurs. For example, certain tiles might cause the left or right shift, and certain tiles can cause the generated tiles to be randomly placed into the tile accumulation area. In other embodiments, the tile accumulation area can be alternatively displayed and the incoming and outgoing tiles can be displayed in another suitable manner.

In various embodiments, the gaming system displays more than one generated tile at one time, and enables the player to pick one or more but not all of these generated tiles for the tile accumulation area. For example, the player can select one of the three displayed tiles. In various such embodiments, the gaming system can also select one or more of the generated and displayed tiles for the tile accumulation area.

In various embodiments, the gaming system displays more than one generated tile, and automatically places one or more of those tiles in the tile accumulation area based on the runs in the hand.

In the various embodiments described above, the gaming system enables the player to remove tiles from the tile accumulation area and/or to move tiles from the tile accumulation area to one of the tile application areas for one of the runs. In various embodiments, the gaming system removes one or more tiles from the tile accumulation area based on an occurrence of a removal event. The gaming system can select the tile(s) to remove in any suitable manner such as based on the runs of the hand or independent of the runs of the hand. In various embodiments, such removal is based on the tiles generated from a tile generation event. For example, the gaming system can select one tile, and if the tile accumulation area is full, the gaming system can randomly select one of the tiles in the tile accumulation area to remove and to be replaced by the new tile.

In various embodiments, the gaming system includes a same quantity of reels as spots for accumulated tiles in the tile accumulation area. In various such embodiments, the tiles generated from each respective reel can only go in the respective position of the tile accumulation area associated with that reel.

In various embodiments, the gaming system includes a different quantity of reels as spots for accumulated tiles in the tile accumulation area.

In various embodiments, one or more of the tiles in the tile accumulation area has a lifetime and thus an expiration if not applied to a run. In various embodiments, the gaming system displays the lifetime for each respective tile displayed in the accumulated tile area. The lifetime can be an amount of time, quantity of game plays, or another suitable condition. For example, a tile can have a lifetime of 20 game plays to be used, meaning the gaming system will remove the tile from the tile accumulation area after 20 game plays if that tile is not used. This configuration motivates the player to use the accumulated tiles in the tile accumulation area (even for a bypass of a run). In various embodiments, the lifetime of a tile can be increased by a suitable event (such as a certain win), by replacing the tile with the exact same tile, or a tile lifetime increasing event. In various embodiments, the lifetime of the tile can be or be based on one or more of: (1) a static amount; (2) a random amount; (3) an amount based on a wager; (4) an amount based on a denomination; (5) an amount based on a game outcome (such as a 3 cherries a tile with lifetime of 10 or 4 cherries wins a tile with a lifetime of 15).

In various embodiments, the gaming system can change the symbol(s) of one or more tiles in the tile accumulated tile area. This can be based on a tile change event such as a random event, game event, or other suitable event. The dice tile embodiments described above include a change to the number displayed on the dice tile. The other symbols of the tiles such as the mahjong tiles can be changed in various other embodiments. In various embodiments, the gaming system can lock or enable a player to lock a tile in the tile accumulation areas such that the gaming system cannot remove and/or change the tile and such that only the player can remove or apply the tile. This can be employed, for example, with a Joker tile. In various embodiments, the gaming system can lock or enable a player to lock a tile in the tile accumulation area such that it does not expire (such as in the embodiments where the tiles in the tile accumulation area have lifetimes).

In various embodiments, the gaming system can cause one or more tile removal events to occur that cause the gaming system to remove one or more of the accumulated tiles in the tile accumulation area.

In various embodiments, the gaming system provides a solitaire hand type configuration for the tiles. In various such embodiments, the gaming system stacks up a plurality of the tiles in one or more piles. In various embodiments, the gaming system, respective to a tile generation event occurring such as during game plays, enables the player to select one or more of the tiles in one or more of the piles. In various embodiments, the gaming system enables the player to pick the tiles in from each pile or in sets (such as pairs) from multiple plies and those tiles are removed from the piles and displayed, thus revealing tiles beneath that are subsequently selectable. In various such embodiments, the gaming system only enables the player to pick visible tiles (i.e., tiles on the top of a pile). After the player picks the tiles, the gaming system reveals the tiles and the player can then place the tiles in the tile accumulation area or can discard the tile. In various such embodiments, the gaming system places the picked tiles in the tile accumulation area such that the tile accumulation area is constantly changing. This causes the player to more immediately use the tiles in the tile accumulation area and thus to apply those tiles to the runs of the hand more rapidly (including possibly forcing the player to bypass one or more of the runs). In various embodiments, the gaming system can cause locking events to occur that cause certain of the tiles to be locked in the tile accumulation area wherein such tiles cannot be removed but can be applied to one of the runs. In various embodiments, the gaming system can cause tile use condition to occur that cause certain of the tiles in the tile accumulation area to be applied to one of the runs.

In various embodiments, the gaming system provides playing card configurations where the tiles are playing cards (such as standard deck of 52 playing cards). In various embodiments, the 3 mahjong suits are replaced with the 4 poker suits and the mahjong numbers (i.e., 1, 2, 3, . . . 9) are replaced with the playing card values (i.e., 2, 3 . . . . J, Q, K, and A). In various embodiments, the playing card tiles can include zero, one or more wild card tiles. In various embodiments, the playing card tiles can include one or more decks of playing card tiles such as but not limited to a 52 card deck, a 104 card deck, or a 156 card deck, etc.

In various embodiments, for the playing card tiles, the values of the card tiles do not affect the award amounts.

In various embodiments, for the playing card tiles, the values of the card tiles affect the award amounts. For example, higher values runs can have higher value award amounts associated with those runs. In various embodiments, the award amounts are based on the values of the card tiles that complete the runs. For example, for a run that require 3 consecutive numbers-any suit, higher individual card tiles values within that suit, result in higher awards award amounts (e.g., 9, 10, J results in higher run award than 2,3,4).

In various embodiments, the gaming system selectively provides tiles responsive to tile generation events based on one or more conditions such as whether such tiles are locked or unlocked on the reels. For example, one or more of the joker or wild tiles can be locked and need to be unlocked to be available to be generated and offered to the player. In various such embodiments, one or more of such tiles are unlocked based on a minimum wager amount level, whether a side wager amount is made, or one or more other factors.

In various embodiments, the gaming system selectively provides rare tiles responsive to tile generation events based on one or more conditions such. For example, a rare tile could be a complete run tile that automatically functions to complete a run, a rare tile could be a complete multiple run tile that automatically functions to complete multiple runs, and/or a rare tile could be a complete hand tile that automatically functions to complete a hand. These rare tiles in a sense function as enhanced joker or wild tiles. In various embodiments, such tiles can be suitably weighted such that they have a relatively low chance of occurring.

In various embodiments, the gaming system displays the symbols of one or more of the tiles before such tiles are generated and offered to the player so that the player can see what tiles will be generated based on the next one or more tile generation events.

In various embodiments, the gaming system can change one or more of the tiles in the tile accumulation area at one or more suitable points in time such as but not limited to: (1) when a tile change condition occurs; (2) randomly; (3) on a predetermined schedule-(such as but not limited every game play, every five game plays, every ten game plays); and/or (4) based on one or more other factors.

In various embodiments, the gaming system displays one or more of the runs of a hand that are extremely easy to obtain. For example, one or more of the runs of a hand can be completed by any one tile, any two tiles, or any three tiles. This enables the player to easily apply any tiles to complete such runs, win the awards associated with such runs, and make progress toward completing the hand.

In various embodiments, the gaming system requires the player to discard and/or use one or more of the accumulated tiles on a regular basis (such as after every play of the game, after every five plays of the game, after every tile generation event, after every second tile generation event).

In various embodiments, the gaming system causes discarded tiles to be available subsequently for the hand based on a subsequent tile generation event.

In various embodiments, the gaming system causes discarded tiles to not be available subsequently for the hand based on a subsequent tile generation event.

In various embodiments, the gaming system cause a tile trade event to occur, and responsive to the tile trade event, enables a player to trade one or more accumulated tiles in the tile accumulation area for one or more other tiles.

In various embodiments, the gaming system cause one or more of the generated tiles to be shown to the player face down (such that the player cannot see the symbols on such tiles) and enable the player to select to keep or discard such tile.

In various embodiments, the gaming system cause one or more of the generated tiles to be shown to the player partially face down (such that the player cannot see all of the symbols on such tiles) and enable the player to select to keep or discard such tile. In such cases, the gaming system can show one or more of the symbols on the tile, but hide one or more of the symbols on the tile. For example, the gaming system can display a suit of the tile but not a value of the tile, or can display a value of the tile but not a suit of the tile.

It should be appreciated from the above that the present disclosure employs the accumulated tiles in the first sequences to indicate future opportunities in the second sequences.

It should be appreciated from the above that the gaming system enables the player to obtain additional accumulated tiles to increase the chances of winning better awards.

It should be appreciated from the above that the gaming system can provide an initial quantity of accumulated tiles, but that in other embodiments, the gaming system can provide no initial accumulated tiles.

It should be appreciated from the above that the types, shapes, sizes, and other characteristics of the tiles can vary in accordance with the present disclosure.

It should be appreciated from the above, and as further provided below, that the quantity of available tiles can be accumulated and can be employed in different combinations for determining awards for the player.

It should further be appreciated that the present disclosure also contemplates that the tiles can be associated with different functions.

In various embodiments, one or more awards provided in association with the features disclosed herein include one or more of: a quantity of monetary credits, a quantity of non-monetary credits, a quantity of promotional credits, a quantity of player tracking points, a progressive award, a modifier, such as a multiplier, a quantity of free plays of one or more games, a quantity of plays of one or more secondary or bonus games, a multiplier of a quantity of free plays of a game, one or more lottery based awards, such as lottery or drawing tickets, a wager match for one or more plays of one or more games, an increase in the average expected payback percentage for one or more plays of one or more games, one or more comps, such as a free dinner, a free night's stay at a hotel, a high value product such as a free car, or a low value product, one or more bonus credits usable for online play, a lump sum of player tracking points or credits, a multiplier for player tracking points or credits, an increase in a membership or player tracking level, one or more coupons or promotions usable within and/or outside of the gaming establishment (e.g., a 20% off coupon for use at a convenience store), virtual goods associated with the gaming system, virtual goods not associated with the gaming system, an access code usable to unlock content on an internet.

In various embodiments, any suitable determination disclosed herein can be predetermined, randomly determined, randomly determined based on one or more weighted percentages, determined based on a generated symbol or symbol combination, determined independent of a generated symbol or symbol combination, determined based on a random determination by the central controller, determined independent of a random determination by the central controller, determined based on a random determination at the gaming system, determined independent of a random determination at the gaming system, determined based on at least one play of at least one game, determined independent of at least one play of at least one game, determined based on a player's selection, determined independent of a player's selection, determined based on one or more side wagers placed, determined independent of one or more side wagers placed, determined based on the player's primary game wager, determined independent of the player's primary game wager, determined based on time (such as the time of day), determined independent of time (such as the time of day), determined based on an amount of coin-in accumulated in one or more pools, determined independent of an amount of coin-in accumulated in one or more pools, determined based on a status of the player (i.e., a player tracking status), determined independent of a status of the player (i.e., a player tracking status), determined based on one or more other determinations disclosed herein, determined independent of any other determination disclosed herein or determined based on any other suitable method or criteria.

It should further be appreciated from the above that the present disclosure provides technological improvements in gaming environments that include but are not limited to: (1) improvements in the displays of gaming systems; (2) improvements to sequences and to the interaction between different sequences displayed by gaming systems; (3) improvements to tile accumulation sequences; (4) improvements to accumulated tile use sequences; (5) improvements to the integration and use of different tiles for gaming systems; (6) improvements to how tiles are employed by gaming systems; (7) improvements to how players select and use tiles in gaming systems; and (8) improvements to the use of various different tiles in gaming systems.

### Gaming Systems

The above-described embodiments of the present disclosure may be implemented in accordance with or in conjunction with one or more of a variety of different types of gaming systems, such as, but not limited to, those described below.

The present disclosure contemplates a variety of different gaming systems each having one or more of a plurality of different features, attributes, or characteristics. A “gaming system” as used herein refers to various configurations of: (a) one or more servers; (b) one or more electronic gaming machines such as those located on a casino floor; and/or (c) one or more personal gaming devices. Thus, in various embodiments, the gaming system of the present disclosure includes: (a) one or more electronic gaming machines in combination with one or more servers; (b) one or more personal gaming devices in combination with one or more servers; (c) one or more personal gaming devices in combination with one or more electronic gaming machines; (d) one or more personal gaming devices, one or more electronic gaming machines, and one or more servers in combination with one another; (e) a single electronic gaming machine; (f) a plurality of electronic gaming machines in combination with one another; (g) a single personal gaming device; (h) a plurality of personal gaming devices in combination with one another; (i) a single server; and/or (j) a plurality of servers in combination with one another. For brevity and clarity and unless specifically stated otherwise, “EGM” as used herein represents one EGM or a plurality of EGMs, “personal gaming device” as used herein represents one personal gaming device or a plurality of personal gaming devices, and “server” as used herein represents one server or a plurality of servers.

As noted above, in various embodiments, the gaming system includes an EGM (or personal gaming device) in combination with a server. In such embodiments, the EGM (or personal gaming device) is configured to communicate with the server through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a server through a data network.

In certain embodiments in which the gaming system includes an EGM (or personal gaming device) in combination with a server, the server is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the server. The at least one processor of that EGM (or personal gaming device) is configured to execute the events, messages, or commands represented by such data or signals in conjunction with the operation of the EGM (or personal gaming device). Moreover, the at least one processor of the server is configured to transmit and receive data or signals representing events, messages, commands, or any other suitable information between the server and the EGM (or personal gaming device). The at least one processor of the server is configured to execute the events, messages, or commands represented by such data or signals in conjunction with the operation of the server. One, more than one, or each of the functions of the server may be performed by the at least one processor of the EGM (or personal gaming device). Further, one, more than one, or each of the functions of the at least one processor of the EGM (or personal gaming device) may be performed by the at least one processor of the server.

In certain such embodiments, computerized instructions for controlling any games (such as any primary or base games and/or any secondary or bonus games) displayed by the EGM (or personal gaming device) are executed by the server. In such “thin client” embodiments, the server remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the server to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a server, computerized instructions for controlling any primary or base games displayed by the EGM (or personal gaming device) are communicated from the server to the EGM (or personal gaming device) in a thick client configuration, and computerized instructions for controlling any secondary or bonus games or other functions displayed by the EGM (or personal gaming device) are executed by the server in a thin client configuration.

In certain embodiments in which the gaming system includes: (a) an EGM (or personal gaming device) configured to communicate with a server through a data network; and/or (b) a plurality of EGMs (or personal gaming devices) configured to communicate with one another through a data network, the data network is a local area network (LAN) in which the EGMs (or personal gaming devices) are located substantially proximate to one another and/or the server. In one example, the EGMs (or personal gaming devices) and the server are located in a gaming establishment or a portion of a gaming establishment.

In other embodiments in which the gaming system includes: (a) an EGM (or personal gaming device) configured to communicate with a server through a data network; and/or (b) a plurality of EGMs (or personal gaming devices) configured to communicate with one another through a data network, the data network is a wide area network (WAN) in which one or more of the EGMs (or personal gaming devices) are not necessarily located substantially proximate to another one of the EGMs (or personal gaming devices) and/or the server. For example, one or more of the EGMs (or personal gaming devices) are located: (a) in an area of a gaming establishment different from an area of the gaming establishment in which the server is located; or (b) in a gaming establishment different from the gaming establishment in which the server is located. In another example, the server is not located within a gaming establishment in which the EGMs (or personal gaming devices) are located. In certain embodiments in which the data network is a WAN, the gaming system includes a server and an EGM (or personal gaming device) each located in a different gaming establishment in a same geographic area, such as a same city or a same state. Gaming systems in which the data network is a WAN are substantially identical to gaming systems in which the data network is a LAN, though the quantity of EGMs (or personal gaming devices) in such gaming systems may vary relative to one another.

In further embodiments in which the gaming system includes: (a) an EGM (or personal gaming device) configured to communicate with a server through a data network; and/or (b) a plurality of EGMs (or personal gaming devices) configured to communicate with one another through a data network, the data network is an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the server identifies a player before enabling that player to place any wagers on any plays of any wagering games. In one example, the server identifies the player by requiring a player account of the player to be logged into via an input of a unique username and password combination assigned to the player. The server may, however, identify the player in any other suitable manner, such as by validating a player tracking identification number associated with the player; by reading a player tracking card or other smart card inserted into a card reader (as described below); by validating a unique player identification number associated with the player by the server; or by identifying the EGM (or personal gaming device), such as by identifying the MAC address or the IP address of the Internet facilitator. In various embodiments, once the server identifies the player, the server enables placement of one or more wagers on one or more plays of one or more primary or base games and/or one or more secondary or bonus games, and displays those plays via the Internet browser of the EGM (or personal gaming device).

The server and the EGM (or personal gaming device) are configured to connect to the data network or remote communications link in any suitable manner. In various embodiments, such a connection is accomplished via a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

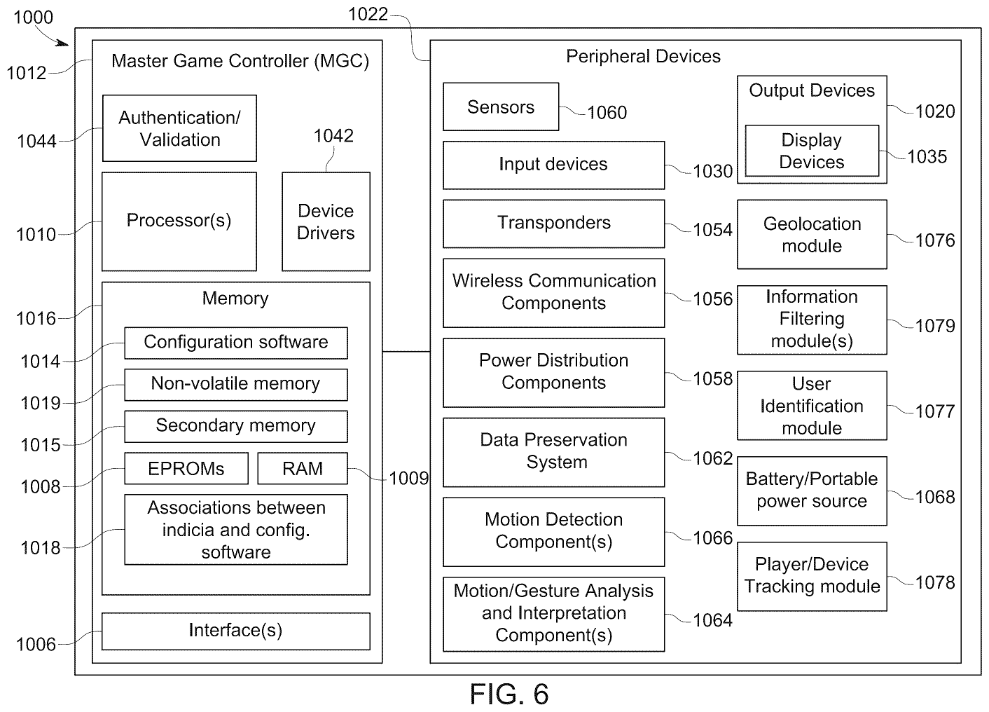

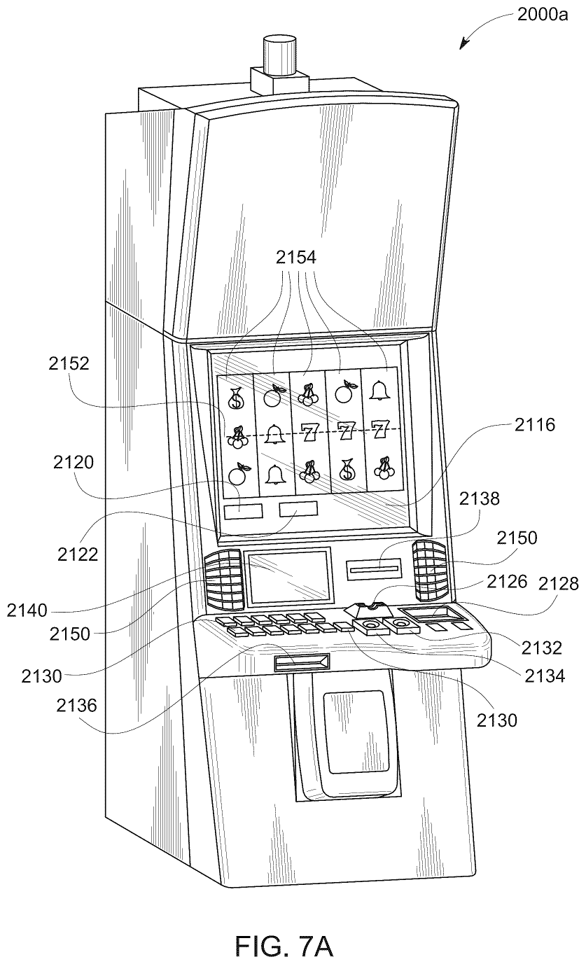

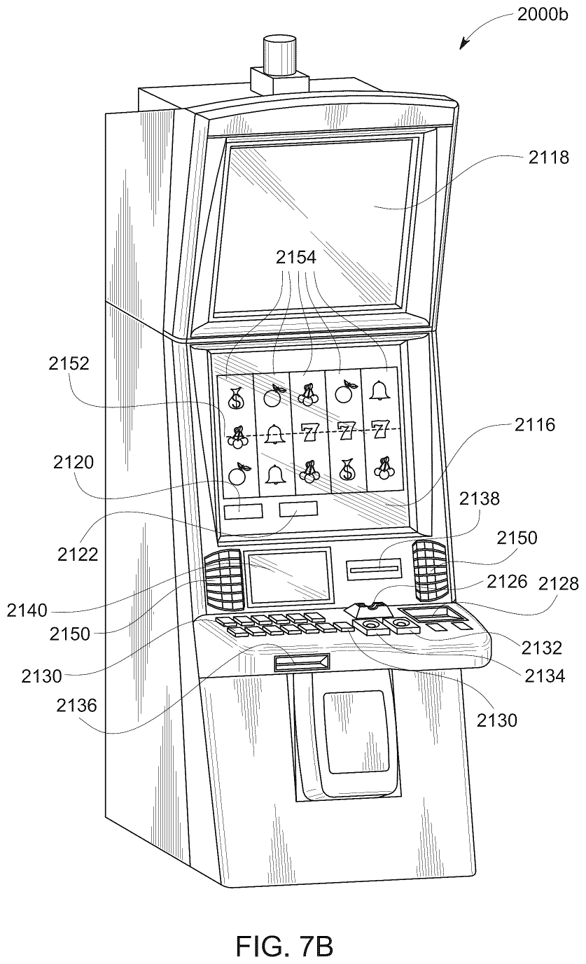

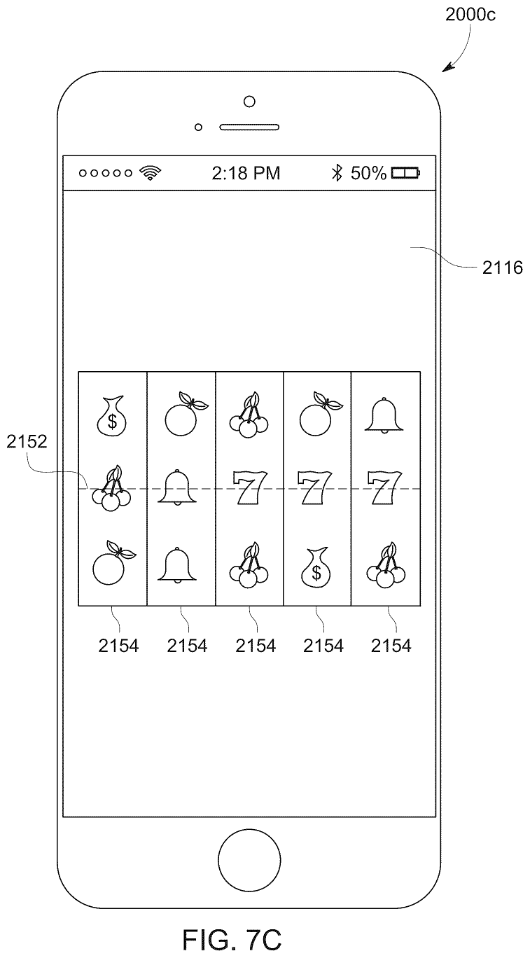

FIG. 6 is a block diagram of an example EGM 1000 and FIGS. 7A and 7B include two different example EGMs 2000a and 2000b. The EGMs 1000, 2000a, and 2000b are merely example EGMs, and different EGMs may be implemented using different combinations of the components shown in the EGMs 1000, 2000a, and 2000b. Although the below refers to EGMs, in various embodiments personal gaming devices (such as personal gaming device 2000c of FIG. 7C) can include some or all of the below components.

In these embodiments, the EGM 1000 includes a master gaming controller 1012 configured to communicate with and to operate with a plurality of peripheral devices 1022.

The master gaming controller 1012 includes at least one processor 1010. The at least one processor 1010 is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or game information) via a communication interface 1006 of the master gaming controller 1012; (2) converting signals read by an interface to a format corresponding to that used by software or memory of the EGM; (3) accessing memory to configure or reconfigure game parameters in the memory according to indicia read from the EGM; (4) communicating with interfaces and the peripheral devices 1022 (such as input/output devices); and/or (5) controlling the peripheral devices 1022. In certain embodiments, one or more components of the master gaming controller 1012 (such as the at least one processor 1010) reside within a housing of the EGM (described below), while in other embodiments at least one component of the master gaming controller 1012 resides outside of the housing of the EGM.

The master gaming controller 1012 also includes at least one memory device 1016, which includes: (1) volatile memory (e.g., RAM 1009, which can include non-volatile RAM, magnetic RAM, ferroelectric RAM, and any other suitable forms); (2) non-volatile memory 1019 (e.g., disk memory, FLASH memory, EPROMs, EEPROMs, memristor-based non-volatile solid-state memory, etc.); (3) unalterable memory (e.g., EPROMs 1008); (4) read-only memory; and/or (5) a secondary memory storage device 1015, such as a non-volatile memory device, configured to store gaming software related information (the gaming software related information and the memory may be used to store various audio files and games not currently being used and invoked in a configuration or reconfiguration). Any other suitable magnetic, optical, and/or semiconductor memory may operate in conjunction with the EGM of the present disclosure. In certain embodiments, the at least one memory device 1016 resides within the housing of the EGM (described below), while in other embodiments at least one component of the at least one memory device 1016 resides outside of the housing of the EGM. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device 1016 is configured to store, for example: (1) configuration software 1014, such as all the parameters and settings for a game playable on the EGM; (2) associations 1018 between configuration indicia read from an EGM with one or more parameters and settings; (3) communication protocols configured to enable the at least one processor 1010 to communicate with the peripheral devices 1022; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the EGM to communicate with local and non-local devices using such protocols. In one implementation, the master gaming controller 1012 communicates with other devices using a serial communication protocol. A few non-limiting examples of serial communication protocols that other devices, such as peripherals (e.g., a bill validator or a ticket printer), may use to communicate with the master game controller 1012 include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device 1016 is configured to store program code and instructions executable by the at least one processor of the EGM to control the EGM. The at least one memory device 1016 of the EGM also stores other operating data, such as image data, event data, input data, random number generators (RNGs) or pseudo-RNGs, paytable data or information, and/or applicable game rules that relate to the play of one or more games on the EGM. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an Internet or intranet).

The at least one memory device 1016 also stores a plurality of device drivers 1042. Examples of different types of device drivers include device drivers for EGM components and device drivers for the peripheral components 1022. Typically, the device drivers 1042 utilize various communication protocols that enable communication with a particular physical device. The device driver abstracts the hardware implementation of that device. For example, a device driver may be written for each type of card reader that could potentially be connected to the EGM. Non-limiting examples of communication protocols used to implement the device drivers include Netplex, USB, Serial, Ethernet 175, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the EGM loads the new device driver from the at least one memory device to enable communication with the new device. For instance, one type of card reader in the EGM can be replaced with a second different type of card reader when device drivers for both card readers are stored in the at least one memory device.

In certain embodiments, the software units stored in the at least one memory device 1016 can be upgraded as needed. For instance, when the at least one memory device 1016 is a hard drive, new games, new game options, new parameters, new settings for existing parameters, new settings for new parameters, new device drivers, and new communication protocols can be uploaded to the at least one memory device 1016 from the master game controller 1012 or from some other external device. As another example, when the at least one memory device 1016 includes a CD/DVD drive including a CD/DVD configured to store game options, parameters, and settings, the software stored in the at least one memory device 1016 can be upgraded by replacing a first CD/DVD with a second CD/DVD. In yet another example, when the at least one memory device 1016 uses flash memory 1019 or EPROM 1008 units configured to store games, game options, parameters, and settings, the software stored in the flash and/or EPROM memory units can be upgraded by replacing one or more memory units with new memory units that include the upgraded software. In another embodiment, one or more of the memory devices, such as the hard drive, may be employed in a game software download process from a remote software server.

In some embodiments, the at least one memory device 1016 also stores authentication and/or validation components 1044 configured to authenticate/validate specified EGM components and/or information, such as hardware components, software components, firmware components, peripheral device components, user input device components, information received from one or more user input devices, information stored in the at least one memory device 1016, etc.

In certain embodiments, the peripheral devices 1022 include several device interfaces, such as: (1) at least one output device 1020 including at least one display device 1035; (2) at least one input device 1030 (which may include contact and/or non-contact interfaces); (3) at least one transponder 1054; (4) at least one wireless communication component 1056; (5) at least one wired/wireless power distribution component 1058; (6) at least one sensor 1060; (7) at least one data preservation component 1062; (8) at least one motion/gesture analysis and interpretation component 1064; (9) at least one motion detection component 1066; (10) at least one portable power source 1068; (11) at least one geolocation module 1076; (12) at least one user identification module 1077; (13) at least one player/device tracking module 1078; and (14) at least one information filtering module 1079.

The at least one output device 1020 includes at least one display device 1035 configured to display any game(s) displayed by the EGM and any suitable information associated with such game(s). In certain embodiments, the display devices are connected to or mounted on a housing of the EGM (described below). In various embodiments, the display devices serve as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example EGM 2000a illustrated in FIG. 7A includes a central display device 2116, a player tracking display 2140, a credit display 2120, and a bet display 2122. The example EGM 2000b illustrated in FIG. 7B includes a central display device 2116, an upper display device 2118, a player tracking display 2140, a credit display 2120, and a bet display 2122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, the at least one output device 1020 includes a payout device. In these embodiments, after the EGM receives an actuation of a cashout device (described below), the EGM causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. The example EGMs 2000a and 2000b illustrated in FIGS. 7A and 7B each include a ticket printer and dispenser 2136.

In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player.

While any credit balances, any wagers, any values, and any awards are described herein as amounts of monetary credits or currency, one or more of such credit balances, such wagers, such values, and such awards may be for non-monetary credits, promotional credits, of player tracking points or credits.

In certain embodiments, the at least one output device 1020 is a sound generating device controlled by one or more sound cards. In one such embodiment, the sound generating device includes one or more speakers or other sound generating hardware and/or software configured to generate sounds, such as by playing music for any games or by playing music for other modes of the EGM, such as an attract mode. The example EGMs 2000a and 2000b illustrated in FIGS. 7A and 7B each include a plurality of speakers 2150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

The at least one input device 1030 may include any suitable device that enables an input signal to be produced and received by the at least one processor 1010 of the EGM.

In one embodiment, the at least one input device 1030 includes a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. The example EGMs 2000a and 2000b illustrated in FIGS. 7A and 7B each include a combined bill and ticket acceptor 2128 and a coin slot 2126.

In one embodiment, the at least one input device 1030 includes a payment device configured to enable the EGM to be funded via an electronic funds transfer, such as a transfer of funds from a bank account. In another embodiment, the EGM includes a payment device configured to communicate with a mobile device of a player, such as a mobile phone, a radio frequency identification tag, or any other suitable wired or wireless device, to retrieve relevant information associated with that player to fund the EGM. When the EGM is funded, the at least one processor determines the amount of funds entered and displays the corresponding amount on a credit display or any other suitable display as described below.

In certain embodiments, the at least one input device 1030 includes at least one wagering or betting device. In various embodiments, the one or more wagering or betting devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). One such wagering or betting device is as a maximum wager or bet device that, when actuated, causes the EGM to place a maximum wager on a play of a game. Another such wagering or betting device is a repeat bet device that, when actuated, causes the EGM to place a wager that is equal to the previously-placed wager on a play of a game. A further such wagering or betting device is a bet one device that, when actuated, causes the EGM to increase the wager by one credit. Generally, upon actuation of one of the wagering or betting devices, the quantity of credits displayed in a credit meter (described below) decreases by the amount of credits wagered, while the quantity of credits displayed in a bet display (described below) increases by the amount of credits wagered.

In various embodiments, the at least one input device 1030 includes at least one game play activation device. In various embodiments, the one or more game play initiation devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). After a player appropriately funds the EGM and places a wager, the EGM activates the game play activation device to enable the player to actuate the game play activation device to initiate a play of a game on the EGM (or another suitable sequence of events associated with the EGM). After the EGM receives an actuation of the game play activation device, the EGM initiates the play of the game. The example EGMs 2000a and 2000b illustrated in FIGS. 7A and 7B each include a game play activation device in the form of a game play initiation button 2132. In other embodiments, the EGM begins game play automatically upon appropriate funding rather than upon utilization of the game play activation device.

In other embodiments, the at least one input device 1030 includes a cashout device. In various embodiments, the cashout device is: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). When the EGM receives an actuation of the cashout device from a player and the player has a positive (i.e., greater-than-zero) credit balance, the EGM initiates a payout associated with the player's credit balance. The example EGMs 2000a and 2000b illustrated in FIGS. 7A and 7B each include a cashout device in the form of a cashout button 2134.

In various embodiments, the at least one input device 1030 includes a plurality of buttons that are programmable by the EGM operator to, when actuated, cause the EGM to perform particular functions. For instance, such buttons may be hard keys, programmable soft keys, or icons icon displayed on a display device of the EGM (described below) that are actuatable via a touch screen of the EGM (described below) or via use of a suitable input device of the EGM (such as a mouse or a joystick). The example EGMs 2000a and 2000b illustrated in FIGS. 7A and 7B each include a plurality of such buttons 2130.

In certain embodiments, the at least one input device 1030 includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the EGM by touching the touch screen at the appropriate locations.

In embodiments including a player tracking system, as further described below, the at least one input device 1030 includes a card reader in communication with the at least one processor of the EGM. The example EGMs 2000a and 2000b illustrated in FIGS. 7A and 7B each include a card reader 2138. The card reader is configured to read a player identification card inserted into the card reader.

The at least one wireless communication component 1056 includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component 1056 transmits electrical, electromagnetic, or optical signals that carry digital data streams or analog signals representing various types of information.

The at least one wired/wireless power distribution component 1058 includes components or devices that are configured to provide power to other devices. For example, in one embodiment, the at least one power distribution component 1058 includes a magnetic induction system that is configured to provide wireless power to one or more user input devices near the EGM. In one embodiment, a user input device docking region is provided, and includes a power distribution component that is configured to recharge a user input device without requiring metal-to-metal contact. In one embodiment, the at least one power distribution component 1058 is configured to distribute power to one or more internal components of the EGM, such as one or more rechargeable power sources (e.g., rechargeable batteries) located at the EGM.

In certain embodiments, the at least one sensor 1060 includes at least one of: optical sensors, pressure sensors, RF sensors, infrared sensors, image sensors, thermal sensors, and biometric sensors. The at least one sensor 1060 may be used for a variety of functions, such as: detecting movements and/or gestures of various objects within a predetermined proximity to the EGM; detecting the presence and/or identity of various persons (e.g., players, casino employees, etc.), devices (e.g., user input devices), and/or systems within a predetermined proximity to the EGM.

The at least one data preservation component 1062 is configured to detect or sense one or more events and/or conditions that, for example, may result in damage to the EGM and/or that may result in loss of information associated with the EGM. Additionally, the data preservation system 1062 may be operable to initiate one or more appropriate action(s) in response to the detection of such events/conditions.

The at least one motion/gesture analysis and interpretation component 1064 is configured to analyze and/or interpret information relating to detected player movements and/or gestures to determine appropriate player input information relating to the detected player movements and/or gestures. For example, in one embodiment, the at least one motion/gesture analysis and interpretation component 1064 is configured to perform one or more of the following functions: analyze the detected gross motion or gestures of a player; interpret the player's motion or gestures (e.g., in the context of a casino game being played) to identify instructions or input from the player; utilize the interpreted instructions/input to advance the game state; etc. In other embodiments, at least a portion of these additional functions may be implemented at a remote system or device.

The at least one portable power source 1068 enables the EGM to operate in a mobile environment. For example, in one embodiment, the EGM 300 includes one or more rechargeable batteries.

The at least one geolocation module 1076 is configured to acquire geolocation information from one or more remote sources and use the acquired geolocation information to determine information relating to a relative and/or absolute position of the EGM. For example, in one implementation, the at least one geolocation module 1076 is configured to receive GPS signal information for use in determining the position or location of the EGM. In another implementation, the at least one geolocation module 1076 is configured to receive multiple wireless signals from multiple remote devices (e.g., EGMs, servers, wireless access points, etc.) and use the signal information to compute position/location information relating to the position or location of the EGM.

The at least one user identification module 1077 is configured to determine the identity of the current user or current owner of the EGM. For example, in one embodiment, the current user is required to perform a login process at the EGM in order to access one or more features. Alternatively, the EGM is configured to automatically determine the identity of the current user based on one or more external signals, such as an RFID tag or badge worn by the current user and that provides a wireless signal to the EGM that is used to determine the identity of the current user. In at least one embodiment, various security features are incorporated into the EGM to prevent unauthorized users from accessing confidential or sensitive information.

The at least one information filtering module 1079 is configured to perform filtering (e.g., based on specified criteria) of selected information to be displayed at one or more displays 1035 of the EGM.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, such as the example EGMs 2000a and 2000b illustrated in FIGS. 7A and 7B, the EGM has a support structure, housing, or cabinet that provides support for a plurality of the input devices and the output devices of the EGM. Further, the EGM is configured such that a player may operate it while standing or sitting. In various embodiments, the EGM is positioned on a base or stand, or is configured as a pub-style tabletop game (not shown) that a player may operate typically while sitting. As illustrated by the different example EGMs 2000a and 2000b shown in FIGS. 7A and 7B, EGMs may have varying housing and display configurations.

In certain embodiments, the EGM is a device that has obtained approval from a regulatory gaming commission, and in other embodiments, the EGM is a device that has not obtained approval from a regulatory gaming commission.

The EGMs described above are merely three examples of different types of EGMs. Certain of these example EGMs may include one or more elements that may not be included in all gaming systems, and these example EGMs may not include one or more elements that are included in other gaming systems. For example, certain EGMs include a coin acceptor while others do not.

In various embodiments, an EGM may be implemented in one of a variety of different configurations. In various embodiments, the EGM may be implemented as one of: (a) a dedicated EGM in which computerized game programs executable by the EGM for controlling any primary or base games (referred to herein as “primary games”) and/or any secondary or bonus games or other functions (referred to herein as “secondary games”) displayed by the EGM are provided with the EGM before delivery to a gaming establishment or before being provided to a player; and (b) a changeable EGM in which computerized game programs executable by the EGM for controlling any primary games and/or secondary games displayed by the EGM are downloadable or otherwise transferred to the EGM through a data network or remote communication link; from a USB drive, flash memory card, or other suitable memory device; or in any other suitable manner after the EGM is physically located in a gaming establishment or after the EGM is provided to a player.

As generally explained above, in various embodiments in which the gaming system includes a server and a changeable EGM, the at least one memory device of the server stores different game programs and instructions executable by the at least one processor of the changeable EGM to control one or more primary games and/or secondary games displayed by the changeable EGM. More specifically, each such executable game program represents a different game or a different type of game that the at least one changeable EGM is configured to operate. In one example, certain of the game programs are executable by the changeable EGM to operate games having the same or substantially the same game play but different paytables. In different embodiments, each executable game program is associated with a primary game, a secondary game, or both. In certain embodiments, an executable game program is executable by the at least one processor of the at least one changeable EGM as a secondary game to be played simultaneously with a play of a primary game (which may be downloaded to or otherwise stored on the at least one changeable EGM), or vice versa.

In operation of such embodiments, the server is configured to communicate one or more of the stored executable game programs to the at least one processor of the changeable EGM. In different embodiments, a stored executable game program is communicated or delivered to the at least one processor of the changeable EGM by: (a) embedding the executable game program in a device or a component (such as a microchip to be inserted into the changeable EGM); (b) writing the executable game program onto a disc or other media; or (c) uploading or streaming the executable game program over a data network (such as a dedicated data network). After the executable game program is communicated from the server to the changeable EGM, the at least one processor of the changeable EGM executes the executable game program to enable the primary game and/or the secondary game associated with that executable game program to be played using the display device(s) and/or the input device(s) of the changeable EGM. That is, when an executable game program is communicated to the at least one processor of the changeable EGM, the at least one processor of the changeable EGM changes the game or the type of game that may be played using the changeable EGM.

In certain embodiments, the gaming system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the gaming system generates the game outcome(s) and/or the award(s) to be provided based on the associated probabilities. In these embodiments, since the gaming system generates game outcomes and/or awards randomly or based on one or more probability calculations, there is no certainty that the gaming system will ever provide any specific game outcome and/or award.

In certain embodiments, the gaming system maintains one or more predetermined pools or sets of predetermined game outcomes and/or awards. In certain such embodiments, upon generation or receipt of a game outcome and/or award request, the gaming system independently selects one of the predetermined game outcomes and/or awards from the one or more pools or sets. The gaming system flags or marks the selected game outcome and/or award as used. Once a game outcome or an award is flagged as used, it is prevented from further selection from its respective pool or set; that is, the gaming system does not select that game outcome or award upon another game outcome and/or award request. The gaming system provides the selected game outcome and/or award.

In certain embodiments, the gaming system determines a predetermined game outcome and/or award based on the results of a bingo, keno, or lottery game. In certain such embodiments, the gaming system utilizes one or more bingo, keno, or lottery games to determine the predetermined game outcome and/or award provided for a primary game and/or a secondary game. The gaming system is provided or associated with a bingo card. Each bingo card consists of a matrix or array of elements, wherein each element is designated with separate indicia. After a bingo card is provided, the gaming system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards.

In certain embodiments in which the gaming system includes a server and an EGM, the EGM is configured to communicate with the server for monitoring purposes only. In such embodiments, the EGM determines the game outcome(s) and/or award(s) to be provided in any of the manners described above, and the server monitors the activities and events occurring on the EGM. In one such embodiment, the gaming system includes a real-time or online accounting and gaming information system configured to communicate with the server. In this embodiment, the accounting and gaming information system includes: (a) a player database configured to store player profiles, (b) a player tracking module configured to track players (as described below), and (c) a credit system configured to provide automated transactions.

As noted above, in various embodiments, the gaming system includes one or more executable game programs executable by at least one processor of the gaming system to provide one or more primary games and one or more secondary games. The primary game(s) and the secondary game(s) may comprise any suitable games and/or wagering games, such as, but not limited to electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the gaming system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the gaming system. In certain such embodiments, the gaming system includes one or more paylines associated with the reels. The example EGM 2000b shown in FIG. 7B includes a payline 1152 and a plurality of reels 1154. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The gaming system enables a wager to be placed on one or more of such paylines to activate such paylines. In other embodiments in which one or more paylines are formed between at least two adjacent symbol display areas, the gaming system enables a wager to be placed on a plurality of symbol display areas, which activates those symbol display areas.

In various embodiments, the gaming system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement.

In certain embodiments, the gaming system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided.

In various embodiments, the gaming system includes a progressive award. Typically, a progressive award includes an initial amount and an additional amount funded through a portion of each wager placed to initiate a play of a primary game. When one or more triggering events occurs, the gaming system provides at least a portion of the progressive award. After the gaming system provides the progressive award, an amount of the progressive award is reset to the initial amount and a portion of each subsequent wager is allocated to the next progressive award.

As generally noted above, in addition to providing winning credits or other awards for one or more plays of the primary game(s), in various embodiments the gaming system provides credits or other awards for one or more plays of one or more secondary games. The secondary game typically enables an award to be obtained addition to any award obtained through play of the primary game(s). The secondary game(s) typically produces a higher level of player excitement than the primary game(s) because the secondary game(s) provides a greater expectation of winning than the primary game(s) and is accompanied with more attractive or unusual features than the primary game(s). The secondary game(s) may be any type of suitable game, either similar to or completely different from the primary game.

In various embodiments, the gaming system automatically provides or initiates the secondary game upon the occurrence of a triggering event or the satisfaction of a qualifying condition. In other embodiments, the gaming system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. Any suitable triggering event or qualifying condition or any suitable combination of a plurality of different triggering events or qualifying conditions may be employed.

In other embodiments, at least one processor of the gaming system randomly determines when to provide one or more plays of one or more secondary games. In one such embodiment, no apparent reason is provided for providing the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the gaming system determines qualification for a secondary game at least partially based on a game triggered or symbol triggered event, such as at least partially based on play of a primary game.

In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments' entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the gaming system includes a plurality of EGMs, the EGMs are configured to communicate with one another to provide a group gaming environment. In certain such embodiments, the EGMs enable players of those EGMs to work in conjunction with one another, such as by enabling the players to play together as a team or group, to win one or more awards. In other such embodiments, the EGMs enable players of those EGMs to compete against one another for one or more awards. In one such embodiment, the EGMs enable the players of those EGMs to participate in one or more gaming tournaments for one or more awards.

In various embodiments, the gaming system includes one or more player tracking systems. Such player tracking systems enable operators of the gaming system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the gaming system to begin a gaming session, the card reader reads the player identification number off the player tracking card to identify the player. The gaming system timely tracks any suitable information or data relating to the identified player's gaming session. The gaming system also timely tracks when the player tracking card is removed to conclude play for that gaming session. In another embodiment, rather than requiring insertion of a player tracking card into the card reader, the gaming system utilizes one or more portable devices, such as a mobile phone, a radio frequency identification tag, or any other suitable wireless device, to track when a gaming session begins and ends. In another embodiment, the gaming system utilizes any suitable biometric technology or ticket technology to track when a gaming session begins and ends.

In such embodiments, during one or more gaming sessions, the gaming system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device.

In various embodiments, the gaming system includes one or more servers configured to communicate with a personal gaming device—such as a smartphone, a tablet computer, a desktop computer, or a laptop computer—to enable web-based game play using the personal gaming device. In various embodiments, the player must first access a gaming website via an Internet browser of the personal gaming device or execute an application (commonly called an “app”) installed on the personal gaming device before the player can use the personal gaming device to participate in web-based game play. In certain embodiments, the one or more servers and the personal gaming device operate in a thin-client environment. In these embodiments, the personal gaming device receives inputs via one or more input devices (such as a touch screen and/or physical buttons), the personal gaming device sends the received inputs to the one or more servers, the one or more servers make various determinations based on the inputs and determine content to be displayed (such as a randomly determined game outcome and corresponding award), the one or more servers send the content to the personal gaming device, and the personal gaming device displays the content.

In certain such embodiments, the one or more servers must identify the player before enabling game play on the personal gaming device (or, in some embodiments, before enabling monetary wager-based game play on the personal gaming device). In these embodiments, the player must identify herself to the one or more servers, such as by inputting the player's unique username and password combination, providing an input to a biometric sensor (e.g., a fingerprint sensor, a retinal sensor, a voice sensor, or a facial-recognition sensor), or providing any other suitable information.

Once identified, the one or more servers enable the player to establish an account balance from which the player can draw credits usable to wager on plays of a game. In certain embodiments, the one or more servers enable the player to initiate an electronic funds transfer to transfer funds from a bank account to the player's account balance. In other embodiments, the one or more servers enable the player to make a payment using the player's credit card, debit card, or other suitable device to add money to the player's account balance. In other embodiments, the one or more servers enable the player to add money to the player's account balance via a peer-to-peer type application, such as PayPal or Venmo. The one or more servers also enable the player to cash out the player's account balance (or part of it) in any suitable manner, such as via an electronic funds transfer, by initiating creation of a paper check that is mailed to the player, or by initiating printing of a voucher at a kiosk in a gaming establishment.

In certain embodiments, the one or more servers include a payment server that handles establishing and cashing out players' account balances and a separate game server configured to determine the outcome and any associated award for a play of a game. In these embodiments, the game server is configured to communicate with the personal gaming device and the payment device, and the personal gaming device and the payment device are not configured to directly communicate with one another. In these embodiments, when the game server receives data representing a request to start a play of a game at a desired wager, the game server sends data representing the desired wager to the payment server. The payment server determines whether the player's account balance can cover the desired wager (i.e., includes a monetary balance at least equal to the desired wager).

If the payment server determines that the player's account balance cannot cover the desired wager, the payment server notifies the game server, which then instructs the personal gaming device to display a suitable notification to the player that the player's account balance is too low to place the desired wager. If the payment server determines that the player's account balance can cover the desired wager, the payment server deducts the desired wager from the account balance and notifies the game server. The game server then determines an outcome and any associated award for the play of the game. The game server notifies the payment server of any nonzero award, and the payment server increases the player's account balance by the nonzero award. The game server sends data representing the outcome and any award to the personal gaming device, which displays the outcome and any award.

In certain embodiments, the one or more servers enable web-based game play using a personal gaming device only if the personal gaming device satisfies one or more jurisdictional requirements. In one embodiment, the one or more servers enable web-based game play using the personal gaming device only if the personal gaming device is located within a designated geographic area (such as within certain state or county lines or within the boundaries of a gaming establishment). In this embodiment, the geolocation module of the personal gaming device determines the location of the personal gaming device and sends the location to the one or more servers, which determine whether the personal gaming device is located within the designated geographic area. In various embodiments, the one or more servers enable non-monetary wager-based game play if the personal gaming device is located outside of the designated geographic area.

In various embodiments, the gaming system includes an EGM configured to communicate with a personal gaming device—such as a smartphone, a tablet computer, a desktop computer, or a laptop computer—to enable tethered mobile game play using the personal gaming device. Generally, in these embodiments, the EGM establishes communication with the personal gaming device and enables the player to play games on the EGM remotely via the personal gaming device. In certain embodiments, the gaming system includes a geo-fence system that enables tethered game play within a particular geographic area but not outside of that geographic area.

In certain embodiments, the gaming system is configured to communicate with a social network server that hosts or partially hosts a social networking website via a data network (such as the Internet) to integrate a player's gaming experience with the player's social networking account. This enables the gaming system to send certain information to the social network server that the social network server can use to create content (such as text, an image, and/or a video) and post it to the player's wall, newsfeed, or similar area of the social networking website accessible by the player's connections (and in certain cases the public) such that the player's connections can view that information. This also enables the gaming system to receive certain information from the social network server, such as the player's likes or dislikes or the player's list of connections. In certain embodiments, the gaming system enables the player to link the player's player account to the player's social networking account(s). This enables the gaming system to, once it identifies the player and initiates a gaming session (such as via the player logging in to a website (or an application) on the player's personal gaming device or via the player inserting the player's player tracking card into an EGM), link that gaming session to the player's social networking account(s). In other embodiments, the gaming system enables the player to link the player's social networking account(s) to individual gaming sessions when desired by providing the required login information.

For instance, in one embodiment, if a player wins a particular award (e.g., a progressive award or a jackpot award) or an award that exceeds a certain threshold (e.g., an award exceeding $1,000), the gaming system sends information about the award to the social network server to enable the server to create associated content (such as a screenshot of the outcome and associated award) and to post that content to the player's wall (or other suitable area) of the social networking website for the player's connections to see (and to entice them to play). In another embodiment, if a player joins a multiplayer game and there is another seat available, the gaming system sends that information to the social network sever to enable the server to create associated content (such as text indicating a vacancy for that particular game) and to post that content to the player's wall (or other suitable area) of the social networking website for the player's connections to see (and to entice them to fill the vacancy). In another embodiment, if the player consents, the gaming system sends advertisement information or offer information to the social network server to enable the social network server to create associated content (such as text or an image reflecting an advertisement and/or an offer) and to post that content to the player's wall (or other suitable area) of the social networking website for the player's connections to see. In another embodiment, the gaming system enables the player to recommend a game to the player's connections by posting a recommendation to the player's wall (or other suitable area) of the social networking website.

Certain of the gaming systems described herein, such as EGMs located in a casino or another gaming establishment, include certain components and/or are configured to operate in certain manners that differentiate these systems from general purpose computing devices, i.e., certain personal gaming devices such as desktop computers and laptop computers.

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general purpose computing devices. For purposes of illustration, a description of EGMs relative to general purpose computing devices and some examples of these additional (or different) hardware and/or software architectures found in EGMs are described below.

At first glance, one might think that adapting general purpose computing device technologies to the gaming industry and EGMs would be a simple proposition because both general purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general purpose computing device.

A second difference between EGMs and general purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general purpose computing devices is authentication—EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general purpose computing devices is that EGMs have unique peripheral device requirements that differ from those of a general purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player's assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

It should be appreciated that the terminology used herein is for the purpose of describing particular aspects only and is not intended to be limiting of the disclosure. For example, the singular forms “a,” “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

1. A gaming system comprising:
a processor; and
a memory device that stores a plurality of instructions that, when executed by the processor, cause the processor to:
cause a display, by a display device, of an indication of a hand;
cause a display, by the display device, of indications of different runs of the hand, and for each run, a tile application area associated with that run and an indication of dice tiles required to complete the run;
cause a display, by the display device, of a tile accumulation area;
cause a display, by the display device, of symbol display elements;
cause a display, by the display device, of activations of the symbol display elements;
cause a display, by the display device, of dice tiles associated with the activations of the symbol display elements, each dice tile have an indicated number of that dice tile;
cause a display, by the display device, for each of the displayed dice tiles, of an indication of whether the dice tile is accumulated in the tile accumulation area or the dice tile is discarded;
cause a display, by the display device, of one the displayed dice tiles accumulated in the tile accumulation area, a change of the indicated number of that dice tile;
cause a display, by the display device, for the displayed dice tiles in the tile accumulation area, of placements of the dice tiles into the tile application areas associated with the runs;
cause a display, by the display device, for each of the runs, an indication of a completion of the run based on the dice tiles placed in the tile application area associated with the run and that are required to complete the run; and
cause a display, by the display device, of an indication of a completion of the hand after all of the indications of the completions of all of the runs.

2. The gaming system of claim 1, wherein the plurality of instructions, when executed by the processor, cause the processor to cause a display, by the display device, for each run, of an indication of an award associated with that run.

3. The gaming system of claim 2, wherein the plurality of instructions, when executed by the processor, cause the processor to cause a display, by the display device, for each run that is completed, of an indication that the award associated with that run is unlocked.

4. The gaming system of claim 2, wherein the plurality of instructions, when executed by the processor, cause the processor to cause a display, by the display device, for each run that is completed, of an indication that the award associated with that run is provided to the player.

5. The gaming system of claim 1, wherein the plurality of instructions, when executed by the processor, cause the processor to cause a display, by the display device, of an indication of an award associated with the hand.

6. The gaming system of claim 1, wherein the plurality of instructions, when executed by the processor, cause the processor to cause a display, by the display device, cause a display, by the display device, of the indications of whether the dice tiles are accumulated and displayed in the tile accumulation area or the dice tiles are discarded based on received player inputs.

7. The gaming system of claim 1, wherein the plurality of instructions, when executed by the processor, cause the processor to cause a display, by the display device, cause a display, by the display device, of the indications of the tiles in the tile accumulation area placed in the tile application areas associated with the runs based on received player inputs.

8. The gaming system of claim 1, wherein one of the runs is based on an order of accumulation of the dice tiles.

9. The gaming system of claim 1, wherein one of the runs can be completed using two different quantities of accumulated dice tiles.

10. A gaming system comprising:
a processor; and
a memory device that stores a plurality of instructions that, when executed by the processor, cause the processor to:
cause a display, by a display device, of an indication of a hand comprising different runs, and for each run an indication of any dice tiles required to complete the run;
cause a display, by the display device, of symbol display elements;
cause a display, by the display device, of activations of the symbol display elements;
cause a sequential display, by the display device, of dice tiles associated with the activations of the symbol display elements, each dice tile have an indicated number of that dice tile;
cause a display, by the display device, for each of the displayed dice tiles, of an indication of whether the tile is accumulated or the tile is discarded;
cause a display, by the display device, for the accumulated dice tiles, of placements of the tiles in association with the runs, where for one of the runs, the accumulated dice tiles can only be placed in association with that run if the order of accumulation of the dice tiles is the same as the order of the dice tiles for that run;
cause a display, by the display device, for each of the runs, an indication of a completion of the run based on the dice tiles associated with the run and that are required to complete the run; and
cause a display, by the display device, of an indication of a completion of the hand after all of the indications of the completions of all of the runs.

11. The gaming system of claim 10, wherein the plurality of instructions, when executed by the processor, cause the processor to cause a display, by the display device, for each run that is completed, of an indication of an award associated with that run is unlocked.

12. The gaming system of claim 10, wherein the plurality of instructions, when executed by the processor, cause the processor to cause a display, by the display device, for each run that is completed, of an indication of an award associated with that run is provided to the player.

13. The gaming system of claim 10, wherein the plurality of instructions, when executed by the processor, cause the processor to cause a display, by the display device, cause a display, by the display device, of the indications of whether the dice tiles are accumulated or the dice tiles are discarded based on received player inputs.

14. The gaming system of claim 10, wherein the plurality of instructions, when executed by the processor, cause the processor to cause a display, by the display device, cause a display, by the display device, of the indications of the tiles associated with the runs based on received player inputs.

15. A gaming system comprising:
a processor; and
a memory device that stores a plurality of instructions that, when executed by the processor, cause the processor to:
cause a display, by a display device, of an indication of a hand comprising different runs, and for each run an indication of any dice tiles required to complete the run, wherein for one of the runs, the run can be completed by different quantities of dice tiles;
cause a display, by the display device, of symbol display elements;
cause a sequential display, by the display device, of each of a plurality of different dice tiles, each dice tile have an indicated number of that dice tile;
cause a display, by the display device, for each of the displayed dice tiles, of an indication of whether the dice tile is accumulated or the dice tile is discarded, wherein a limited quantity of the dice tiles can be accumulated at any one time;
cause a display, by the display device, for the accumulated dice tiles, of placements of the dice tiles in association with the runs, wherein for each placement of a dice tile in association with one of the runs, the quantity of accumulated dice tiles is reduced;
cause a display, by the display device, for each of the runs, an indication of a completion of the run based on the dice tiles associated with the run and that are required to complete the run; and
cause a display, by the display device, of an indication of a completion of the hand after all of the indications of the completions of all of the runs.

16. The gaming system of claim 15, wherein the plurality of instructions, when executed by the processor, cause the processor to cause a display, by the display device, for each run that is completed, of an indication of an award associated with that run is unlocked, and after all the runs are completed, of an of an award associated with the hand and provided to the player.

17. The gaming system of claim 15, wherein the plurality of instructions, when executed by the processor, cause the processor to cause a display, by the display device, for each run that is completed, of an indication of an award associated with that run is provided to the player, and after all the runs are completed, of an award associated with the hand and provided to the player.

18. The gaming system of claim 15, wherein the plurality of instructions, when executed by the processor, cause the processor to cause a display, by the display device, cause a display, by the display device, of the indications of whether the dice tiles are accumulated or the dice tiles are discarded based on received player inputs.

19. The gaming system of claim 15, wherein the plurality of instructions, when executed by the processor, cause the processor to cause a display, by the display device, cause a display, by the display device, of the indications of the tiles associated with the runs based on received player inputs.

20. The gaming system of claim 15, wherein two of the dice tiles have different quantities of the sides, and the different quantities of sides indicate different numbers.
